(19) United States
(12) Patent Application Publication
(10) Pub. No.: US 2026/0321833 A1
(43) Pub. Date: Oct. 15, 2026

(54) SEAL MATERIALS AND METHODS OF USE FOR SOLID-STATE BATTERIES

(71) Applicant: QUANTUMSCAPE BATTERY, INC., San Jose, CA (US)

(72) Inventors: Jing FAN, San Jose, CA (US); Matthew Genovese, San Jose, CA (US); Justin Lin, San Jose, CA (US); Siyuan Ma, San Jose, CA (US); Zackery Madrigal-Moeller, San Jose, CA (US); Amal Mehrotra, San Jose, CA (US); Caleb Richardson, San Jose, CA (US); Jordi Sastre, San Jose, CA (US); Jonathan Scholl, San Jose, CA (US); Mohit Singh, San Jose, CA (US)

(21) Appl. No.: 19/689,913

(22) Filed: May 27, 2026

Related U.S. Application Data
(63) Continuation of application No. PCT/US2025/059396, filed on Dec. 12, 2025.
(60) Provisional application No. 63/733,594, filed on Dec. 13, 2024.

(51) Int. Cl. H01M 50/193; H01M 10/04

(52) U.S. Cl. CPC H01M 50/193; H01M 10/04

(57) ABSTRACT

The present disclosure concerns seals and processes of making seals for a cathode and a solid-state electrolyte separator.

### CROSS-REFERENCE TO RELATED APPLICATIONS

The present application is a continuation application of International Patent Application No. PCT/US2025/059396 that claims priority to, and the benefit of, U.S. Provisional Patent Application No. 63/733,594, filed Dec. 13, 2024, the entire contents of which are herein incorporated by reference in its entirety for all purposes.

### FIELD

The present disclosure concerns seals and processes of making seals for a cathode and a solid-state electrolyte separator.

### BACKGROUND

Solid-state lithium batteries have a number of advantages over conventional lithium batteries that rely solely on liquid-based electrolytes. However, solids by their very nature are less deformable than liquids, making packaging solid-state lithium batteries more challenging. Challenges include sealing the cathode to the solid-state separator and maintaining separation between the catholyte and the lithium metal in the anode.

There is therefore a need for improved cathode seals and processes to make cathode seals. The instant disclosure sets forth such seals and processes.

### SUMMARY

In an aspect, the present disclosure provides an electrochemical stack comprising a) a cathode comprising a catholyte; b) a solid-state electrolyte separator comprising two major surfaces and four minor surfaces; and c) a seal between a first major surface of the separator and the cathode and within 0.1 mm to 2 mm from a perimeter of the first major surface; wherein the seal does not contact the perimeter of the first major surface, the second major surface, or the minor surfaces of the separator; wherein the cathode geometric surface area is less than the separator geometric surface area; and wherein the seal comprises crosslinked PIB. In one embodiment, the seal comprises ultraviolet (UV)-cured crosslinked polyisobutylene (PIB). The process of UV-curing is advantageous and more environmentally friendly over other commonly used methods, such as heat or chemical curing. Unlike heat curing, which can take hours, UV-curing is quick (UV-curing can be done in less than one minute and typically seconds) and energy efficient. While chemical curing typically requires solvents or harsh reactants that could potentially negatively react with the electrolyte or other parts of the battery, UV-curing requires no solvents.

To maintain separation of the catholyte from the lithium metal in the anode, a seal should exhibit tight adhesion and be physically and chemically durable over the long-term. The seal should survive the harsh electrochemical conditions required for a battery to run. For example, the seal cannot crack under pressure nor can it exhibit any cross-reactivity with the electrolyte. It must meet these requirements while also being very small (between 0.6 mm and 1.4 mm in width and in the range of about 100 μm to 350 μm in height).

It can be a challenge to develop materials and curing conditions that meet these stringent conditions, but it was surprisingly discovered that the UV-cured crosslinked-PIB described herein affords a very small, but durable seal that maintains separation between the catholyte and the lithium metal in the anode and does not exhibit cross-reactivity with the electrolyte.

As described herein, the UV-cured seals exhibit adhesion (a peel strength of 28N/25 mm following a 180-degree peel as measured by the ASTM D3330 test at room temperature was observed for a select seal as described in Example 8), which prevents the liquid catholyte from reacting with the anode, leading to increased anode stability and longevity.

In certain embodiments, the seals described herein flow inward after application and UV-curing so that thickness and height of the cured seal prevent gaps between the seal and the cathode. In certain embodiments, these seals can improve liquid catholyte retention. These types of seals are advantageous compared to a solid cathode frame with no flexibility, which makes alignment challenging.

In another aspect, the present disclosure provides a process of sealing a cathode to a solid-state electrolyte separator comprising providing a seam between a cathode and a solid-state electrolyte separator wherein the seam comprises an acryloyl group-terminated monomer; and UV-curing, heat-curing, or UV-curing and heat-curing the seam to form a seal that comprises crosslinked polyisobutylene (PIB). In one embodiment, the seam is UV-cured.

In another aspect, the present disclosure provides a process of making an electrochemical stack comprising:
a. dispensing a UV-curable or heat-curable seam on a solid-state electrolyte separator wherein the seam comprises an acryloyl group-terminated monomer, a tackifier, and an anti-oxidant;
b. joining together a cathode comprising a catholyte and the solid-state electrolyte separator wherein the UV-curable or heat-curable seam is in contact with the cathode; and
c. UV-curing, heat-curing, or UV- and heat-curing the seam to form a UV- and/or heat-cured seal comprising photo-crosslinked polyisobutylene (PIB) and tackifier between the cathode and the separator.

The seam in the aforementioned aspect, in some embodiments, is a composition comprising an acryloyl group-terminated monomer, a tackifier, an anti-oxidant, and at least one photo initiator. In the presence of UV-light or heat, a seal comprising photo-crosslinked polyisobutylene (PIB) and tackifier is formed. In one embodiment, the seam is UV-curable.

### BRIEF DESCRIPTIONS OF THE DRAWINGS

FIG. 1 is a vertically stacked image of an electrochemical stack comprising a cathode and electrolyte separator attached via a seal.

FIG. 2A is an image of a cathode and electrolyte separator attached via a seal that comprises one inner seal and one outer seal. The solid line square represents the separator electrolyte and the inner black rectangle with rounded corners represents the cathode with catholyte. The dashed box is the inset represented in FIG. 2B.

FIG. 2B is the inset of the dashed box of FIG. 2A. The edge of the cathode is labelled as (1). The inside edge of the inner seal is labelled as (2) and the outside edge of the inner seal is labelled as (3). The inside edge of the outer seal is labelled as (4) and the outside edge of the outer seal is labelled as (5). The edge of the separator is labelled as (6).

FIG. 3 is a cross-sectional image of an electrochemical stack comprising a cathode and electrolyte separator attached via a seal that comprises one inner seal and one outer seal.

FIG. 4 is a cross-sectional image of an electrochemical stack comprising a cathode and electrolyte separator attached via a seal that comprises one seal.

FIG. 5A is a graph showing the results of the battery life test, showing Discharge Energy as a function of cycle number, of a cell assembled using a UV-cured perimeter seal described herein.

FIG. 5B is a graph showing the results of the battery power test, showing State of Charge as a function of time, of a cell assembled using a UV-cured perimeter seal described herein.

FIG. 5C is a graph showing the results of the temperature skew test, showing Voltage as a function of Discharge Capacity Percent, of a cell assembled using a UV-cured perimeter seal described herein.

### DETAILED DESCRIPTION

### I. Definitions

As used herein, the term “about,” when qualifying a number, e.g., 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C. For example, evaporating a solvent at about 80° C. includes evaporating a solvent at 79° C., 80° C., or 81° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrases “electrochemical cell” or “battery cell” shall mean a single cell including a positive electrode and a negative electrode, which have ionic communication between the two using an electrolyte. In some embodiments, the same battery cell includes multiple positive electrodes and/or multiple negative electrodes enclosed in one container.

As used herein, the term “thin film” refers to a film having the components, compositions, or materials described herein where the film has an average thickness dimension of about 10 nm to about 100 μm. In some examples, thin refers to a film that is greater than about 10 nm and less than about 1 μm, 10 μm, or 50 μm in thickness.

As used herein, the term “surface” refers to material that is near or at an interface between two different phases, chemicals, or states of matter. For example, a thin film solid-state electrolyte separator when exposed to air has a surface described by the periphery or outside portion of the separator that contacts the air. For rectangular-shaped film separators, there is a top and a bottom surface (i.e., major surfaces) which both individually have higher surface areas than each of the four side surfaces (i.e., minor surfaces) individually. In this rectangular separator example, there are also four side surfaces which have surface areas less than either or both of the top and bottom surfaces. For disc-shaped film separators, there is a top and a bottom surface which both individually have higher surface areas than the circumference-side of the disc. When used as an electrolyte separator in an electrochemical cell, the top or bottom surface is the side or part of the separator that contacts the negative electrode (i.e., Li metal), the positive electrode (i.e., cathode or catholyte in cathode), and/or which a layer or bonding agent disposed between the negative electrode and the positive electrode. A surface has larger x- and y-axis physical dimensions than it does z-axis physical dimensions, wherein the z-axis is the axis perpendicular to the surface. The depth or thickness of a surface can be of molecular order of magnitude or up to 1 micron. Film surfaces can include dangling bonds, excess hydroxyl groups, bridging oxides, or a variety of other species which result in the film surface having a chemical composition that may be stoichiometrically different from the bulk. As used herein, the term “bulk,” refers to a portion or part of the film that is extended in space in three-dimensions by at least 1 micron. The bulk refers to the portion or part of a material which is exclusive of its surface, as defined above. As used herein, the term “geometric surface area” can be used to refer to the area of a surface of a three-dimensional object such as, for instance, a surface area of a separator or a surface area of a cathode. If the object is a rectangular prism, for example, that consists of two major surfaces and four minor surfaces, the “geometric surface area” can refer to the area of one of the major surfaces of the object.

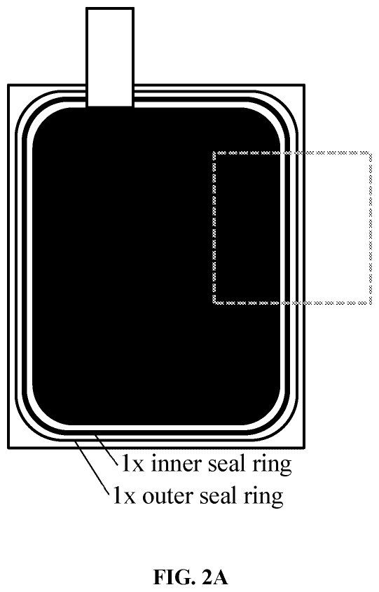

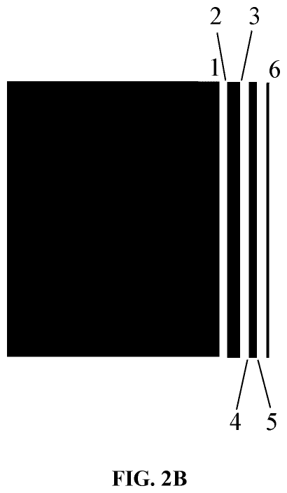

As used herein, the term “edge” refers to the line of an object or area furthest from the center of the object or area where the object or area begins or ends. As described herein, the edge of the cathode is the border of the cathode that is furthest from the center. Each seal and seam has an outside edge and an inside edge. The outside edge of the seal or seam is the edge that is furthest from the center of the separator (and in the case of the seal, the edge furthest from the center of the joined separator and cathode). The inside edge of the seal or seam is the edge that is closest to the center of the separator (and in the case of the seal, the edge closest to the center of the joined separator and cathode). The edge of the cathode, the edge of the separator, and the inside and outside edges of the inner and outer seals are labelled in FIG. 2B.

As used herein, the term “distance” refers to the space between the edge of the two objects.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode. The cathode active material is not particularly limited herein, and a publicly known, prior art cathode active material utilized in all-solid-state batteries can be used. In particular, if a metal oxide is used as the cathode active material, sintering of the secondary battery can be performed in an oxygen-containing atmosphere. Specific examples of such a cathode active material include the following: manganese oxide (MnO), iron oxides, copper oxides, nickel oxides, lithium-manganese complex oxides (e.g., LiₓMn₂O₄ or LiₓMnO₂), lithium-nickel complex oxides (e.g., LiₓNiO₂), lithium-cobalt complex oxides (e.g. LiₓCoO₂), lithium cobalt nickel oxides (LiNi_{1-y}Co_{y}O₂), lithium-manganese-cobalt complex oxides (e.g., LiMn_{y}Co_{1-y}O₂), spinel-phase lithium-manganese-nickel complex oxides (e.g., LiₓMm_{2-y}Ni_{y}O₄), lithium phosphates having an olivine structure (e.g., LiₓFePO₄, LiₓFe_{1-y}Mn_{y}PO₄, LiₓCoPO₄), lithium phosphates having a NASICON-type structure (e.g., Li₇V₂(PO₄)₃), iron (III) sulfate (Fe₂(SO₄)₃), and vanadium oxides (e.g., V₂O₅). One type thereof can be used alone, or two or more types thereof can be used in combination. Preferably, x and y in these chemical formulas lie within the ranges of 1<x<5, and 0<y<1. Among the above, LiCoO₂, LiₓV₂(PO₄)₃, LiNiPO₄, and LiFePO₄ are preferred. In one embodiment, the cathode is 57×72 mm.

As used herein, the phrase “double-sided cathode” or “double-sided solid-state cathode” refers to two cathode layers or two solid-state cathode layers separated by one or two cathode current collectors disposed in between the two layers.

As used herein, a “catholyte” or “cathode active material” refers to an ion conductor that is intimately mixed with, or that surrounds, or that contacts the positive electrode active material. Catholytes suitable with the embodiments described herein include, but are not limited to, catholytes having the common name LPS, LXPS, LXPSO, where X is Si, Ge, Sn, As, Al, LATS, or also Li-stuffed garnets, or combinations thereof, and the like. Catholytes may also be liquid, gel, semi-liquid, semi-solid, polymer, and/or solid polymer ion conductors known in the art. Catholytes include those catholytes set forth in US Patent Application Publication No. 2015-0171465, which published on Jun. 18, 2015, entitled SOLID STATE CATHOLYTE OR ELECTROLYTE FOR BATTERY USING Li_{A}MP_{B}S_{C} (M=Si, Ge, AND/OR Sn), filed May 15, 2014, the contents of which are incorporated by reference in their entirety. Catholytes include those catholytes set forth in US Patent Application Publication No. 2015/0099190, published on Apr. 9, 2015, entitled GARNET MATERIALS FOR LI SECONDARY BATTERIES AND METHODS OF MAKING AND USING GARNET MATERIALS, and filed Oct. 7, 2014, the contents of which are incorporated by reference in their entirety.

As used herein, the phrase “current collector” refers to a component or layer in a secondary battery through which electrons conduct, to or from an electrode in order to complete an external circuit, and which are in direct contact with the electrode to or from which the electrons conduct. In some examples, the current collector is a metal (e.g., Al, Cu, or Ni, steel, alloys thereof, or combinations thereof) layer which is laminated to a positive or negative electrode. During charging and discharging, electrons move in the opposite direction to the flow of Li ions and pass through the current collector when entering or exiting an electrode.

As used herein, the term “electrolyte,” refers to a material that allows ions, e.g., Li+, to migrate therethrough, but which does not allow electrons to conduct therethrough. Electrolytes are useful for electrically isolating the cathode and anodes of a secondary battery while allowing ions, e.g., Li⁺, to transmit through the electrolyte. Electrolytes are ionically conductive and electrically insulating material. Electrolytes are useful for electrically insulating the positive and negative electrodes of a secondary battery while allowing for the conduction of ions, e.g., Li⁺, through the electrolyte.

As used herein, a “thickness” by which is film is characterized refers to the distance, or median measured distance, between the top and bottom faces of a film. As used herein, the top and bottom faces refer to the sides of the film having the largest surface areas. As used herein, electrolyte separator or membrane thickness is measured by cross-sectional scanning electron microscopy.

As used herein the phrase “active electrode material,” or “active material,” refers to a material that is suitable for use as a Li rechargeable battery and which undergoes a chemical reaction during the charging and discharging cycles.

As used herein the phrase “active anode material” refers to an anode material that is suitable for use in a Li rechargeable battery that includes an active cathode material as defined above. In some examples, the active material is lithium metal. In some of the processes set forth herein, the sintering temperatures are high enough to melt the lithium metal used as the active anode material.

As used herein, the phrase “perimeter seal” refers to a seal located within 0.1 mm to 2 mm from the perimeter of a surface of an object, wherein the seal only contacts the surface unto which it is applied and not the perimeter of the surface of the object. If the object is a rectangular prism, for example, that consists of two major surfaces and four minor surfaces, the perimeter seal is located within 0.1 mm to 2 mm from the perimeter of one of the major surfaces of the object, wherein the seal does not contact any of the minor surfaces of the object or the second major surface of the object. In some embodiments, the object is a solid-state separator.

As used herein, the phrase “seal height” or “height” refers to the average distance that the seal extends in a direction normal (i.e., perpendicular) to the plane of a surface unto which the seal is applied.

As used herein, the phrase “seal width” or “width” refers to the average distance of uninterrupted sections of seal material that extend parallel to the surface unto which the seal is applied. In some embodiments, the seal is a dispensed ring along a surface, wherein the width of the seal refers to the size of the ring along the xy plane of the surface. In some embodiments, the seal is substantially as show in FIG. 2B, comprising an inner seal and an outer seal, wherein the width of the inner seal refers to the distance between inside edge (2) and the outside edge (3) of the inner seal, and the width of the outer seal refers to the distance between the inside edge (4) and the outside edge (5) of the outer seal.

As used herein the term “making,” refers to the process or process of forming or causing to form the object that is made. For example, making an energy storage electrode includes the process, process steps, or process of causing the electrode of an energy storage device to be formed. The end result of the steps constituting the making of the energy storage electrode is the production of a material that is functional as an electrode.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li+FeF₃↔3LiF+Fe.

As used herein, the phrase “providing” refers to the provision of, generation or, presentation of, or delivery of that which is provided.

As used herein, the terms “separator”, “solid-state separator”, “solid-state electrolyte separator” or “thin film solid-state electrolyte separator” refers to a solid electrolyte which conducts Li⁺ ions, is substantially insulating to electrons, and is suitable for use as a physical barrier or spacer between the positive and negative electrodes in an electrochemical cell or a rechargeable battery. A separator, as used herein, is substantially insulating to electrons when the separator's lithium ion conductivity is at least 10³ times, and typically 10⁶ times, greater than the separator's electron conductivity. Unless explicitly specified to the contrary, a separator as used herein is stable when in contact with lithium metal. In one embodiment, the separator is a thin film garnet separator, for example, a lithium-stuffed garnet thin film. In one embodiment, the separator is a bare film, a CSC (co-sintered current collector) film, or a film-on-foil film. In one embodiment, the electrolyte separator film is 60×75 mm.

As used herein, a “CSC film” is a thin film comprising a sintered metal oxide with a co-sintered layer of metal (the CSC or “cosintered” layer). A CSC film also includes a mixture of a metal oxide and a metal co-sintered together. In the mixture, the metal may be particles of metal mixed with the metal oxide. In certain embodiments, the CSC layer may comprise Ni in 0.0001-25% by weight, Fe in 1-25% by weight, or combinations thereof and the remainder is lithium-stuffed garnet. In some cases, the CSC layer comprises 1-20 weight % of Ni and 1-10 weight % of Fe and the remainder is lithium-stuffed garnet. In some cases, the CSC layer comprises 5-15 weight % of Ni and 1-5 weight % of Fe and the remainder is lithium-stuffed garnet. In some cases, the CSC layer comprises 10-15 weight % of Ni and 3-5 weight % of Fe and the remainder is lithium-stuffed garnet.

As used herein, the phrase “lithium stuffed garnet” refers to films that are characterized by a crystal structure related to a garnet crystal structure. Lithium-stuffed garnets include compounds having the formula Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<2, 10<F<13, and M′ and M″ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, Ta, V, W, Mo, or Sb and as described herein. Garnets, as used herein, also include those garnets described above that are doped with Al₂O₃. Garnets, as used herein, also include those garnets described above that are doped so that Al³⁺ substitutes for Li⁺. As used herein, lithium-stuffed garnets, and garnets, generally, include, but are not limited to, Li_{7.0}La₃(Zrₜ₁+Nbₜ₂+Taₜ₃)O₁₂+0.35Al₂O₃; wherein (t1+t2+t3=subscript 2) so that the La:(Zr/Nb/Ta) ratio is 3:2. Also, garnet used herein includes, but is not limited to, LiₓLa₃Zr₂O₁₂+yAl₂O₃, wherein x ranges from 5.5 to 9; and y ranges from 0 to 1. In some examples x is 7 and y is 1.0. In some examples x is 7 and y is 0.35. In some examples x is 7 and y is 0.7. In some examples x is 7 and y is 0.4. Also, garnets as used herein include, but are not limited to, LiₓLa₃Zr₂O₁₂+yAl₂O₃.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

A “bilayer” herein includes a ceramic layer deposited onto a metal layer. A sintered bilayer may have a ceramic layer thickness of 10 μm-50 μm and the metal layer thickness is 2 μm-20 μm thick. The bilayer may have a ceramic layer thickness of 20 μm-30 μm and the metal layer thickness is 3 μm-10 μm thick.

As used herein the phrase “alkyl” refers to a saturated straight or branched hydrocarbon. In certain embodiments, the alkyl group is a primary, secondary, or tertiary hydrocarbon. In certain embodiments, the alkyl group is selected from the group consisting of methyl, ethyl, propyl, isopropyl, butyl, isobutyl, sec-butyl, t-butyl, pentyl, isopentyl, neopentyl, hexyl, isohexyl, 3-methylpentyl, 2,2-dimethylbutyl, and 2,3-dimethylbutyl.

As used herein the phrase “cycloalkyl” refers to a saturated cyclic hydrocarbon. In certain embodiments, the cycloalkyl group includes three to ten atoms, i.e., C₃ to C₁₀ cycloalkyl, or three to six carbon atoms, i.e., C₃ to C₆ cycloalkyl. In certain embodiments, the cycloalkyl group is cyclopropyl, cyclobutyl, cyclopentyl, cyclohexyl, or cycloheptyl.

As used herein, the term “catholyte” refers to a liquid or gel electrolyte confined within the positive electrode space of an electrochemical cell. Catholyte also refers to a Li ion conductor that is intimately mixed with, or that surrounds and contacts, or that contacts the positive electrode active materials and provides an ionic pathway for Li⁺ to and from the active materials. Catholytes may also be liquid, gel, semi-liquid, semi-solid, polymer, and/or solid polymer ion conductors.

### II. Electrochemical Stack

In an aspect, the present disclosure provides an electrochemical stack comprising a) a cathode comprising a catholyte; b) a solid-state electrolyte separator comprising two major surfaces and four minor surfaces; and c) a seal between a first major surface of the separator and the cathode and within 0.1 mm to 2 mm from a perimeter of the first major surface; wherein the seal does not contact the perimeter of the first major surface, the second major surface, or the minor surfaces of the separator; wherein the cathode geometric surface area is less than the separator geometric surface area; and wherein the seal comprises crosslinked PIB.

In one embodiment, including any of the foregoing, the seal is dispensed from a liquid reservoir. In one embodiment, including any of the foregoing, the seal is UV-cured.

In one embodiment, including any of the foregoing, the UV-curing comprises radiating the seal with UVA wavelengths. In one embodiment, including any of the foregoing, the UV-curing comprises radiating the seal with UVB wavelengths. In one embodiment, including any of the foregoing, the UV-curing comprises radiating the seal with UVC wavelengths.

In one embodiment, including any of the foregoing, the UV-curing comprises radiating the seal with UVA wavelengths wherein the UVA intensity is between 950 and 900 mW/cm². In one embodiment, including any of the foregoing, the UV-curing comprises radiating the seal with UVB wavelengths wherein the UVB intensity is between 875 and 800 mW/cm². In one embodiment, including any of the foregoing, the UV-curing comprises radiating the seal with UVC wavelengths wherein the UVC intensity is between 450 and 375 mW/cm².

In one embodiment, including any of the foregoing, the UV-curing comprises radiating the seal with UVA wavelengths wherein the dosage of UVA is between 880 and 800 mJ/cm². In one embodiment, including any of the foregoing, the UV-curing comprises radiating the seal with UVB wavelengths wherein the dosage of UVB is between 800 and 750 mJ/cm². In one embodiment, including any of the foregoing, the UV-curing comprises radiating the seal with UVC wavelengths wherein the dosage of UVC is about 361 mJ/cm².

In one embodiment, including any of the foregoing, the UV-curing comprises radiating the seal with UVA and UVB wavelengths. In one embodiment, including any of the foregoing, the UV-curing comprises radiating the seal with UVA and UVC wavelengths. In one embodiment, including any of the foregoing, the UV-curing comprises radiating the seal with UVB and UVC wavelengths.

In one embodiment, including any of the foregoing, the UV-curing comprises radiating the seal with UVA and UVB wavelengths wherein the UVA intensity is between 950 and 900 mW/cm² and the UVB intensity is between 875 and 800 mW/cm². In one embodiment, including any of the foregoing, the UV-curing comprises radiating the seal with UVA and UVC wavelengths wherein the UVA intensity is between 950 and 900 mW/cm² and the UVC intensity is between 450 and 375 mW/cm². In one embodiment, including any of the foregoing, the UV-curing comprises radiating the seal with UVB and UVC wavelengths wherein the UVB intensity is between 875 and 800 mW/cm² and the UVC intensity is between 450 and 375 mW/cm².

In one embodiment, including any of the foregoing, the UV-curing comprises radiating the seal with UVA and UVB wavelengths wherein the dosage of UVA is between 880 and 800 mJ/cm² and the dosage of UVB is between 800 and 750 mJ/cm². In one embodiment, including any of the foregoing, the UV-curing comprises radiating the seal with UVA and UVC wavelengths wherein the dosage of UVA is between 880 and 800 mJ/cm² and the dosage of UVC is about 361 mJ/cm². In one embodiment, including any of the foregoing, the UV-curing comprises radiating the seal with UVB and UVC wavelengths wherein the dosage of UVB is between 800 and 750 mJ/cm² and the dosage of UVC is about 361 mJ/cm².

In one embodiment, including any of the foregoing, the UV-curing comprises radiating the seal with UVA, UVB, and UVC wavelengths. In one embodiment, including any of the foregoing, the UV-curing comprises radiating the seal with UVA, UVB, and UVC wavelengths and the UVA intensity is between 950 and 900 mW/cm²; the UVB intensity is between 875 and 800 mW/cm²; and, the UVC intensity is between 450 and 375 mW/cm². In one embodiment, including any of the foregoing, the UV-curing comprises radiating the seal with UVA, UVB, and UVC wavelengths and the UVA intensity is about 922 mW/cm²; the UVB intensity is about 864 mW/cm²; and, the UVC intensity is about 396 mW/cm².

In one embodiment, including any of the foregoing, the UV-curing comprises radiating the seal with UVA, UVB, and UVC wavelengths and the dosage of UVA is between 880 and 800 mJ/cm²; the dosage of UVB is between 800 and 750 mJ/cm²; and, the dosage of UVC is between 400 and 300 mJ/cm². In one embodiment, including any of the foregoing, the UV-curing comprises radiating the seal with UVA, UVB, and UVC wavelengths and the dosage of UVA is about 840 mJ/cm²; the dosage of UVB is about 773 mJ/cm²; and, the dosage of UVC is about 361 mJ/cm². In one embodiment, including any of the foregoing conditions, the seal is UV-cured for about ten seconds.

In one embodiment, including any of the foregoing, the seal is heat-cured. In one embodiment, including any of the foregoing, the seal is a perimeter seal.

Since the seal may be dispensed, the seal can be more precisely placed and can conform to the exact shape of the substrate unto which it is dispensed. In some embodiments, the seal is dispensed directly unto a solid-state electrolyte separator. In some embodiments, the solid-state electrolyte separator described herein has two major surfaces and four minor surfaces. The seal may be dispensed along the perimeter of one of the major surfaces of the separator, wherein the seal does not contact the minor surfaces of the separator. The seal isolates the catholyte and the electrolyte from the negative electrode and prevents the catholyte or electrolyte leakage from the electrochemical stack.

In one embodiment, including any of the foregoing, the seal further comprises a tackifier.

In one embodiment, including any of the foregoing, the seal comprises photo-crosslinked polyisobutylene (PIB) and a tackifier. In one embodiment, including any of the foregoing, the seal consists essentially of photo-crosslinked polyisobutylene (PIB) and a tackifier.

In one embodiment, including any of the foregoing, the photo-crosslinked PIB of the seal is photo-crosslinked from a monomer having a structure of Formula (I):

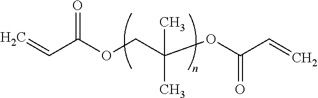

wherein n is an integer from 5 to 50.

In one embodiment, including any of the foregoing, the photo-crosslinked PIB of the seal is photo-crosslinked from a mixture of monomers having a structure of Formula (I):

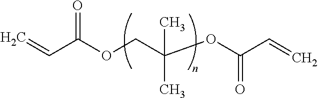

wherein n is an integer from 1 to 100.

In one embodiment of Formula (I), including any of the foregoing, n is an integer from 5 to 10. In one embodiment of Formula (I), including any of the foregoing, n is an integer from 10 to 15. In one embodiment of Formula (I), including any of the foregoing, n is an integer from 15 to 20. In one embodiment of Formula (I), including any of the foregoing, n is an integer from 20 to 25. In one embodiment of Formula (I), including any of the foregoing, n is an integer from 25 to 30. In one embodiment of Formula (I), including any of the foregoing, n is an integer from 30 to 35. In one embodiment of Formula (I), including any of the foregoing, n is an integer from 35 to 40. In one embodiment of Formula (I), including any of the foregoing, n is an integer from 40 to 45. In one embodiment of Formula (I), including any of the foregoing, n is an integer from 45 to 50.

In one embodiment of Formula (I), including any of the foregoing, n is a mixture of integers from 5 to 10. In one embodiment of Formula (I), including any of the foregoing, n is a mixture of integers from 10 to 15. In one embodiment of Formula (I), including any of the foregoing, n is a mixture of integers from 15 to 20. In one embodiment of Formula (I), including any of the foregoing, n is a mixture of integers from 20 to 25. In one embodiment of Formula (I), including any of the foregoing, n is a mixture of integers from 25 to 30. In one embodiment of Formula (I), including any of the foregoing, n is a mixture of integers from 30 to 35. In one embodiment of Formula (I), including any of the foregoing, n is a mixture of integers from 35 to 40. In one embodiment of Formula (I), including any of the foregoing, n is a mixture of integers from 40 to 45. In one embodiment of Formula (I), including any of the foregoing, n is a mixture of integers from 45 to 50. In one embodiment of Formula (I), including any of the foregoing, n is a mixture of integers from 50 to 60. In one embodiment of Formula (I), including any of the foregoing, n is a mixture of integers from 60 to 70. In one embodiment of Formula (I), including any of the foregoing, n is a mixture of integers from 70 to 80. In one embodiment of Formula (I), including any of the foregoing, n is a mixture of integers from 80 to 90. In one embodiment of Formula (I), including any of the foregoing, n is a mixture of integers from 90 to 100.

In one embodiment of Formula (I), including any of the foregoing, n is a mixture of integers from 1 to 40. In one embodiment of Formula (I), including any of the foregoing, n is a mixture of integers from 1 to 60. In one embodiment of Formula (I), including any of the foregoing, n is a mixture of integers 10 to 70. In one embodiment of Formula (I), including any of the foregoing, n is a mixture of integers from 20 to 80. In one embodiment of Formula (I), including any of the foregoing, n is a mixture of integers from 30 to 70. In one embodiment of Formula (I), including any of the foregoing, n is a mixture of integers from 40 to 90. In one embodiment of Formula (I), including any of the foregoing, n is a mixture of integers from 50 to 100.

In one embodiment, including any of the foregoing, the tackifier comprises a polymer selected from the group consisting of a polyisobutylene polymer, a polyethylene polymer, an acrylate polymer, an acrylamide polymer, and combinations thereof.

In one embodiment, including any of the foregoing, the tackifier comprises polyisobutylene.

In one embodiment, including any of the foregoing, the tackifier comprises a polymer with a molecular weight of about 10,000 g/mol to 10,000,000 g/mol. In one embodiment, including any of the foregoing, the tackifier comprises a polymer with a molecular weight of about 100 g/mol to 500 g/mol.

In one embodiment, including any of the foregoing, the seal comprises at least about 90% w/w of the photo-crosslinked PIB. In one embodiment, including any of the foregoing, the seal comprises at least about 95% w/w of the photo-crosslinked PIB. In one embodiment, including any of the foregoing, the seal comprises at least about 97% w/w of the photo-crosslinked PIB. In one embodiment, including any of the foregoing, the seal comprises at least 98% w/w of the photo-crosslinked PIB. In one embodiment, including any of the foregoing, the seal comprises at least about 99% w/w of the photo-crosslinked PIB. In one embodiment, including any of the foregoing, the seal comprises about 99% w/w of the photo-crosslinked PIB.

In one embodiment, including any of the foregoing, the seal comprises no more than about 5% w/w of the tackifier. In one embodiment, including any of the foregoing, the seal comprises no more than about 4% w/w of the tackifier. In one embodiment, including any of the foregoing, the seal comprises no more than about 3% w/w of the tackifier. In one embodiment, including any of the foregoing, the seal comprises no more than about 2% w/w of the tackifier. In one embodiment, including any of the foregoing, the seal comprises no more than about 1% w/w of the tackifier. In one embodiment, including any of the foregoing, the seal comprises no more than about 0.5% w/w of the tackifier.

In one embodiment, including any of the foregoing, the ratio by weight of photo-crosslinked PIB to tackifier in the seal is about 95:5, about 95.5:4.5, 96:4, 96.5:3.5, 97:3, 97.5:2.5, 98:2, 98.5:1.5, 99:1, and 99.5:0.5.

In one embodiment, including any of the foregoing, the distance between the edge of the cathode and the outside edge of the seal is about 0.1 mm to 1 mm. In one embodiment, including any of the foregoing, the distance between the edge of the cathode and the outside edge of the seal is about 0.1 mm to 0.8 mm. In one embodiment, including any of the foregoing, the distance between the edge of the cathode and the outside edge of the seal is about 0.1 mm to 0.6 mm. In one embodiment, including any of the foregoing, the distance between the edge of the cathode and the outside edge of the seal is about 0.4 mm to 0.8 mm. In one embodiment, including any of the foregoing, the distance between the edge of the cathode and the outside edge of the seal is about 0.5 mm.

In one embodiment, including any of the foregoing, the distance between the edge of the cathode and the outside edge of the seal is about 2 mm to 10 mm. The outside edge of seal refers to the edge that is furthest from the edge of the cathode. In one embodiment, including any of the foregoing, the distance between the edge of the cathode and the outside edge of the seal is about 2 mm to 9 mm. In one embodiment, including any of the foregoing, the distance between the edge of the cathode and the outside edge of the seal is about 2 mm to 8 mm. In one embodiment, including any of the foregoing, the distance between the edge of the cathode and the outside edge of the seal is about 2 mm to 7 mm. In one embodiment, including any of the foregoing, the distance between the edge of the cathode and the outside edge of the seal is about 2 mm to 6 mm. In one embodiment, including any of the foregoing, the distance between the edge of the cathode and the outside edge of the seal is equal to, or less than, 5 mm.

In one embodiment, including any of the foregoing, the distance between the edge of the cathode and the outside edge of the seal is about 2 mm to 5 mm. In one embodiment, including any of the foregoing, the distance between the edge of the cathode and the outside edge of the seal is about 2 mm to 4 mm. In one embodiment, including any of the foregoing, the distance between the edge of the cathode and the outside edge of the seal is equal to, or less than, 3 mm.

In one embodiment, including any of the foregoing, the distance between the edge of the cathode and the outside edge of the seal is about 2 mm to 3 mm. In one embodiment, including any of the foregoing, the distance between the edge of the cathode and the outside edge of the seal is about 2 mm to 2.5 mm. In one embodiment, including any of the foregoing, the distance between the edge of the cathode and the outside edge of the seal is about 2 mm to 2.3 mm. In one embodiment, including any of the foregoing, the distance between the edge of the cathode and the outside edge of the seal is about 2.5 mm. In one embodiment, including any of the foregoing, the distance between the edge of the cathode and the outside edge of the seal is about 2.3 mm.

In one embodiment, including any of the foregoing, the cathode in the electrochemical stack has the dimension of about 57 mm by 72 mm and the separator has the dimension of about 60×75 mm.

In one embodiment, including any of the foregoing, the seal has a width in the range of about 0.6 mm and 1.4 mm wherein the width is the distance of uninterrupted sections of seal material that extend parallel to the surface unto which the seal is applied. In one embodiment, including any of the foregoing, the seal has a width in the range of about 0.8 mm and 1.2 mm. In one embodiment, including any of the foregoing, the seal has a width in the range of about 0.8 mm and 1.0 mm. In one embodiment, including any of the foregoing, the seal is about 1 mm in width.

In one embodiment, including any of the foregoing, the seal has a height in the range of about 100 μm and 350 μm wherein the height is the distance that the seal extends in a direction normal (i.e., perpendicular) to the plane of a surface unto which the seal is applied. In one embodiment, including any of the foregoing, the seal has a height in the range of about 100 μm and 250 μm. In one embodiment, including any of the foregoing, the seal has a height in the range of about 100 μm and 200 μm. In one embodiment, including any of the foregoing, the seal is about 150 μm.

In one embodiment, including any of the foregoing, the seal has a height in the range of about 200 μm and 350 μm. In one embodiment, including any of the foregoing, the seal has a height in the range of about 220 μm and 320 μm. In one embodiment, including any of the foregoing, the seal has a height in the range of about 220 μm and 300 μm. In one embodiment, including any of the foregoing, the seal has a height in the range of about 230 μm and 300 μm. In one embodiment, including any of the foregoing, the seal has a height in the range of about 240 μm and 280 μm. In one embodiment, including any of the foregoing, the seal has a height in the range of about 250 μm and 270 μm. In one embodiment, including any of the foregoing, the seal is about 260 μm.

In one embodiment, including any of the foregoing, the seal has a width in the range of about 0.8 mm and 1.2 mm and a height in the range of about 100 μm and 200 μm. In one embodiment, including any of the foregoing, the seal is about 1.0 mm in width and about 150 μm in height.

In one embodiment, including any of the foregoing, the seal has a width in the range of about 0.8 mm and 1.2 mm; a height in the range of about 100 μm and 200 μm; and the distance between the edge of the cathode and the seal is about 2 mm to 5 mm. In one embodiment, including any of the foregoing, the seal is about 1.0 mm in width; about 150 μm in height; and the distance between the edge of the cathode and the outside edge of the seal is about 2 mm to 5 mm.

In one embodiment, including any of the foregoing, the seal has a width in the range of about 0.8 mm and 1.2 mm; a height in the range of about 100 μm and 200 μm; and the distance between the edge of the cathode and the outside edge of the seal is about 2 mm to 2.5 mm. In one embodiment, including any of the foregoing, the seal is about 1.0 mm in width; about 150 μm in height; and the distance between the edge of the cathode and the edge of the seal is about 2 mm to 2.5 mm.

In one embodiment, including any of the foregoing, the seal has a width in the range of about 0.8 mm and 1.2 mm and a height in the range of about 220 μm and 300 μm. In one embodiment, including any of the foregoing, the seal is about 1.0 mm in width and about 260 μm in height.

In one embodiment, including any of the foregoing, the seal has a width in the range of about 0.8 mm and 1.2 mm; a height in the range of about 220 μm and 300 μm; and the distance between the edge of the cathode and the seal is about 2 mm to 5 mm. In one embodiment, including any of the foregoing, the seal is about 1.0 mm in width; about 260 μm in height; and the distance between the edge of the cathode and the outside edge of the seal is about 2 mm to 5 mm.

In one embodiment, including any of the foregoing, the seal has a width in the range of about 0.8 mm and 1.2 mm; a height in the range of about 220 μm and 300 μm; and the distance between the edge of the cathode and the outside edge of the seal is about 2 mm to 2.5 mm. In one embodiment, including any of the foregoing, the seal is about 1.0 mm in width; about 260 μm in height; and the distance between the edge of the cathode and the edge of the seal is about 2 mm to 2.5 mm.

In one embodiment, including any of the foregoing, the seal is dispensed at a speed of about 1 mm/s to 100 mm/s, about 5 mm/s to 80 mm/s, about 10 mm/s to 60 mm/s, about 10 mm/s to 50 mm/s, about 15 mm/s to 40 mm/s, about 20 mm/s to 40 mm/s, or about 25 mm/s to 35 mm/s. In one embodiment, including any of the foregoing, the seal is dispensed at a speed of about 25 mm/s. In one embodiment, including any of the foregoing, the seal is dispensed at a speed of about 30 mm/s. In one embodiment, including any of the foregoing, the seal is dispensed at a speed of about 35 mm/s.

In one embodiment, including any of the foregoing, the seal is dispensed at a temperature of about 50° C. to 150° C., about 50° C. to 130° C., about 70° C. to 130° C., about 70° C. to 110° C., about 80° C. to 110° C., about 80° C. to 100° C., or about 85° C. to 95° C. In one embodiment, including any of the foregoing, the seal is dispensed at a temperature of about 85° C. In one embodiment, including any of the foregoing, the seal is dispensed at a temperature of about 90° C. In one embodiment, including any of the foregoing, the seal is dispensed at a temperature of about 95° C.

In one embodiment, including any of the foregoing, the seal is dispensed at a pressure of about 10 kPa to 300 kPa, about 50 kPa to 300 kPa, about 50 kPa to 250 kPa, about 100 kPa to 250 kPa, about 100 kPa to 200 kPa, about 125 kPa to 200 kPa, about 125 kPa to 175 kPa, about 130 kPa to 170 kPa, about 130 kPa to 160 kPa, about 140 kPa to 160 kPa, about 145 kPa to 160 kPa, or about 145 kPa to 155 kPa. In one embodiment, including any of the foregoing, the seal is dispensed at a pressure of about 145 kPa. In one embodiment, including any of the foregoing, the seal is dispensed at a pressure of about 150 kPa. In one embodiment, including any of the foregoing, the seal is dispensed at a pressure of about 155 kPa.

In one embodiment, including any of the foregoing, the seal exhibits a peel strength between 22N/25 mm and 50N/25 mm following a 180-degree peel at room temperature as measured by the ASTM D3330 test. In one embodiment, including any of the foregoing, the seal exhibits a peel strength between 22N/25 mm and 45N/25 mm following a 180-degree peel at room temperature. In one embodiment, including any of the foregoing, the seal exhibits a peel strength between 22N/25 mm and 40N/25 mm following a 180-degree peel at room temperature. In one embodiment, including any of the foregoing, the seal exhibits a peel strength between 22N/25 mm and 35N/25 mm following a 180-degree peel at room temperature. In one embodiment, including any of the foregoing, the seal exhibits a peel strength between 25N/25 mm and 35N/25 mm following a 180-degree peel at room temperature. In one embodiment, including any of the foregoing, the seal exhibits a peel strength of about 32N/25 mm, 31N/25 mm, 30N/25 mm, 29N/25 mm, 28N/25 mm, 27N/25 mm, or 26N/25 mm following a 180-degree peel at room temperature. In one embodiment, including any of the foregoing, the seal exhibits a peel strength of about 28N/25 mm following a 180-degree peel at room temperature.

In another aspect, the present disclosure provides an electrochemical stack comprising a) a cathode comprising a catholyte; b) a solid-state electrolyte separator comprising two major surfaces and four minor surfaces; and c) a seal between a first major surface of the separator and the cathode and within 0.1 mm to 2 mm from a perimeter of the first major surface; wherein the seal does not contact the perimeter of the first major surface, the second major surface, or the minor surfaces of the separator; wherein the cathode geometric surface area is less than the separator geometric surface area; and wherein the seal comprises an inner seal and an outer seal.

In one embodiment, including any of the foregoing, the inner seal is dispensed from a liquid reservoir. In one embodiment, the inner seal is a perimeter seal. In one embodiment, including any of the foregoing, the outer seal is a perimeter seal. In one embodiment, the inner seal and the outer seal are both perimeter seals.

In one embodiment, including any of the foregoing, the inner seal comprises a thermoplastic polymer. In one embodiment, including any of the foregoing, the inner seal consists essentially of a thermoplastic polymer.

In one embodiment, including any of the foregoing, the molecular weight of the thermoplastic polymer of the inner seal is about 300 g/mol to 2400 g/mol. In one embodiment, including any of the foregoing, the molecular weight of the thermoplastic polymer of the inner seal is about 1,000 g/mol to 100,000 g/mol. In one embodiment, including any of the foregoing, the molecular weight of the thermoplastic polymer of the inner seal is about 1,000 g/mol to 5,000 g/mol. In one embodiment, including any of the foregoing, the molecular weight of the thermoplastic polymer of the inner seal is about 5,000 g/mol to 10,000 g/mol. In one embodiment, including any of the foregoing, the molecular weight of the thermoplastic polymer of the inner seal is about 10,000 g/mol to 25,000 g/mol. In one embodiment, including any of the foregoing, the molecular weight of the thermoplastic polymer of the inner seal is about 25,000 g/mol to 50,000 g/mol. In one embodiment, including any of the foregoing, the molecular weight of the thermoplastic polymer of the inner seal is about 50,000 g/mol to 75,000 g/mol. In one embodiment, including any of the foregoing, the molecular weight of the thermoplastic polymer of the inner seal is about 75,000 g/mol to 100,000 g/mol.

In one embodiment, including any of the foregoing, the inner seal comprises polyisobutylene (PIB), polyisoprene, or a mixture thereof. In one embodiment, including any of the foregoing, the inner seal comprises PIB. In one embodiment, including any of the foregoing, the inner seal comprises polyisoprene. In one embodiment, including any of the foregoing, the inner seal comprises a mixture of PIB and polyisoprene. In one embodiment, including any of the foregoing, the inner seal further comprises a polyolefin, including, but not limited to, polypropylene (PP), polyethylene (PE), polymethylpentene (PMP), and polybutene-1 (PB-1).

In one embodiment, including any of the foregoing, the inner seal consists essentially of polyisobutylene (PIB), polyisoprene, or a mixture thereof. In one embodiment, including any of the foregoing, the inner seal consists essentially of PIB. In one embodiment, including any of the foregoing, the inner seal consists essentially of polyisoprene. In one embodiment, including any of the foregoing, the inner seal consists essentially of a mixture of PIB and polyisoprene.

In one embodiment, including any of the foregoing, the inner seal comprises one inner seal. In one embodiment, including any of the foregoing, the inner seal comprises two inner seals. In one embodiment, including any of the foregoing, the inner seal comprises three inner seals.

In one embodiment, including any of the foregoing, the inner seal is one inner seal. In one embodiment, including any of the foregoing, the inner seal is two inner seals. In one embodiment, including any of the foregoing, the inner seal is three inner seals.

In one embodiment, including any of the foregoing, the inner seal is one inner seal and comprises polyisobutylene (PIB), polyisoprene, or a mixture thereof. In one embodiment, including any of the foregoing, the inner seal is one inner seal and comprises PIB, polyisoprene, or a mixture thereof and further comprises a polyolefin.

In one embodiment, including any of the foregoing, the inner seal is one inner seal and comprises polyisobutylene (PIB) and a polyolefin. In one embodiment, including any of the foregoing, the inner seal is one inner seal and comprises PIB and polypropylene (PP). In one embodiment, including any of the foregoing, the inner seal is one inner seal and comprises PIB and polyethylene (PE). In one embodiment, including any of the foregoing, the inner seal is one inner seal and comprises PIB, polypropylene (PP), and polyethylene (PE).

In one embodiment, including any of the foregoing, the inner seal is one inner seal and comprises polyisobutylene (PIB), polyisoprene, and a polyolefin. In one embodiment, including any of the foregoing, the inner seal is one inner seal and comprises polyisobutylene (PIB), polyisoprene, and polypropylene (PP). In one embodiment, including any of the foregoing, the inner seal is one inner seal and comprises PIB, polyisoprene, and polyethylene (PE). In one embodiment, including any of the foregoing, the inner seal is one inner seal and comprises PIB, polyisoprene, polypropylene (PP), and polyethylene (PE).

In one embodiment, including any of the foregoing, the inner seal is one inner seal and comprises polyisoprene and a polyolefin. In one embodiment, including any of the foregoing, the inner seal is one inner seal and comprises polyisoprene and polypropylene (PP). In one embodiment, including any of the foregoing, the inner seal is one inner seal and comprises polyisoprene and polyethylene (PE). In one embodiment, including any of the foregoing, the inner seal is one inner seal and comprises polyisoprene, polypropylene (PP), and polyethylene (PE).

In one embodiment, including any of the foregoing, the inner seal is three inner seals and each comprises polyisobutylene (PIB), polyisoprene, or a mixture thereof. In one embodiment, including any of the foregoing, the inner seal is three inner seals and each comprises PIB, polyisoprene, or a mixture thereof and further comprises a polyolefin.

In one embodiment, including any of the foregoing, the inner seal is three inner seals and each comprises polyisobutylene (PIB) and a polyolefin. In one embodiment, including any of the foregoing, the inner seal is three inner seals and each comprises PIB, polypropylene (PP), and polyethylene (PE).

In one embodiment, including any of the foregoing, the inner seal is three inner seals and each comprises polyisoprene and a polyolefin. In one embodiment, including any of the foregoing, the inner seal is three inner seals and each comprises polyisoprene, polypropylene (PP), and polyethylene (PE).

In one embodiment, including any of the foregoing, the outer seal is dispensed from a liquid reservoir. In one embodiment, including any of the foregoing, the outer seal is UV-cured.

In one embodiment, including any of the foregoing, the UV-curing comprises radiating the outer seal with UVA wavelengths. In one embodiment, including any of the foregoing, the UV-curing comprises radiating the outer seal with UVB wavelengths. In one embodiment, including any of the foregoing, the UV-curing comprises radiating the outer seal with UVC wavelengths.

In one embodiment, including any of the foregoing, the UV-curing comprises radiating the outer seal with UVA wavelengths wherein the UVA intensity is between 950 and 900 mW/cm². In one embodiment, including any of the foregoing, the UV-curing comprises radiating the outer seal with UVB wavelengths wherein the UVB intensity is between 875 and 800 mW/cm². In one embodiment, including any of the foregoing, the UV-curing comprises radiating the outer seal with UVC wavelengths wherein the UVC intensity is between 450 and 375 mW/cm².

In one embodiment, including any of the foregoing, the UV-curing comprises radiating the outer seal with UVA wavelengths wherein the dosage of UVA is between 880 and 800 mJ/cm². In one embodiment, including any of the foregoing, the UV-curing comprises radiating the outer seal with UVB wavelengths wherein the dosage of UVB is between 800 and 750 mJ/cm². In one embodiment, including any of the foregoing, the UV-curing comprises radiating the outer seal with UVC wavelengths wherein the dosage of UVC is about 361 mJ/cm².

In one embodiment, including any of the foregoing, the UV-curing comprises radiating the outer seal with UVA and UVB wavelengths. In one embodiment, including any of the foregoing, the UV-curing comprises radiating the outer seal with UVA and UVC wavelengths. In one embodiment, including any of the foregoing, the UV-curing comprises radiating the outer seal with UVB and UVC wavelengths.

In one embodiment, including any of the foregoing, the UV-curing comprises radiating the outer seal with UVA and UVB wavelengths wherein the UVA intensity is between 950 and 900 mW/cm² and the UVB intensity is between 875 and 800 mW/cm². In one embodiment, including any of the foregoing, the UV-curing comprises radiating the outer seal with UVA and UVC wavelengths wherein the UVA intensity is between 950 and 900 mW/cm² and the UVC intensity is between 450 and 375 mW/cm². In one embodiment, including any of the foregoing, the UV-curing comprises radiating the outer seal with UVB and UVC wavelengths wherein the UVB intensity is between 875 and 800 mW/cm² and the UVC intensity is between 450 and 375 mW/cm².

In one embodiment, including any of the foregoing, the UV-curing comprises radiating the outer seal with UVA and UVB wavelengths wherein the dosage of UVA is between 880 and 800 mJ/cm² and the dosage of UVB is between 800 and 750 mJ/cm². In one embodiment, including any of the foregoing, the UV-curing comprises radiating the outer seal with UVA and UVC wavelengths wherein the dosage of UVA is between 880 and 800 mJ/cm² and the dosage of UVC is about 361 mJ/cm². In one embodiment, including any of the foregoing, the UV-curing comprises radiating the outer seal with UVB and UVC wavelengths wherein the dosage of UVB is between 800 and 750 mJ/cm² and the dosage of UVC is about 361 mJ/cm².

In one embodiment, including any of the foregoing, the UV-curing comprises radiating the outer seal with UVA, UVB, and UVC wavelengths. In one embodiment, including any of the foregoing, the UV-curing comprises radiating the outer seal with UVA, UVB, and UVC wavelengths and the UVA intensity is between 950 and 900 mW/cm²; the UVB intensity is between 875 and 800 mW/cm²; and, the UVC intensity is between 450 and 375 mW/cm². In one embodiment, including any of the foregoing, the UV-curing comprises radiating the outer seal with UVA, UVB, and UVC wavelengths and the UVA intensity is about 922 mW/cm²; the UVB intensity is about 864 mW/cm²; and, the UVC intensity is about 396 mW/cm².

In one embodiment, including any of the foregoing, the UV-curing comprises radiating the outer seal with UVA, UVB, and UVC wavelengths and the dosage of UVA is between 880 and 800 mJ/cm²; the dosage of UVB is between 800 and 750 mJ/cm²; and, the dosage of UVC is between 400 and 300 mJ/cm². In one embodiment, including any of the foregoing, the UV-curing comprises radiating the outer seal with UVA, UVB, and UVC wavelengths and the dosage of UVA is about 840 mJ/cm²; the dosage of UVB is about 773 mJ/cm²; and, the dosage of UVC is about 361 mJ/cm². In one embodiment, including any of the foregoing conditions, the outer seal is UV-cured for about ten seconds.

In one embodiment, including any of the foregoing, the outer seal is heat-cured.

In one embodiment, including any of the foregoing, the outer seal comprises photo-crosslinked polyisobutylene (PIB). In one embodiment, including any of the foregoing, the outer seal consists essentially of photo-crosslinked polyisobutylene (PIB).

In one embodiment, including any of the foregoing, the outer seal comprises photo-crosslinked PIB that is photo-crosslinked from a monomer having a structure of Formula (I):

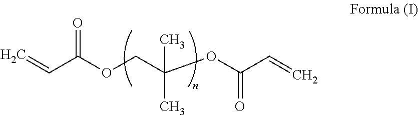

wherein n is an integer from 5 to 50.

In one embodiment, including any of the foregoing, the outer seal comprises photo-crosslinked PIB that is photo-crosslinked from a mixture of monomers having a structure of Formula (I):

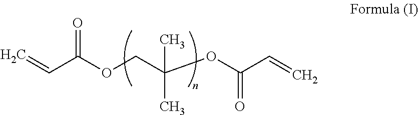

wherein n is an integer from 1 to 100.

In one embodiment of Formula (I), including any of the foregoing, n is an integer from 5 to 10. In one embodiment of Formula (I), including any of the foregoing, n is an integer from 10 to 15. In one embodiment of Formula (I), including any of the foregoing, n is an integer from 15 to 20. In one embodiment of Formula (I), including any of the foregoing, n is an integer from 20 to 25. In one embodiment of Formula (I), including any of the foregoing, n is an integer from 25 to 30. In one embodiment of Formula (I), including any of the foregoing, n is an integer from 30 to 35. In one embodiment of Formula (I), including any of the foregoing, n is an integer from 35 to 40. In one embodiment of Formula (I), including any of the foregoing, n is an integer from 40 to 45. In one embodiment of Formula (I), including any of the foregoing, n is an integer from 45 to 50.

In one embodiment of Formula (I), including any of the foregoing, n is 5 to 50. In certain embodiments, n is 5. In certain embodiments, n is 6. In certain embodiments, n is 7. In certain embodiments, n is 8. In certain embodiments, n is 9. In certain embodiments, n is 10. In certain embodiments, n is 11. In certain embodiments, n is 12. In certain embodiments, n is 13. In certain embodiments, n is 14. In certain embodiments, n is 15. In certain embodiments, n is 16. In certain embodiments, n is 17. In certain embodiments, n is 18. In certain embodiments, n is 19. In certain embodiments, n is 20. In certain embodiments, n is 21. In certain embodiments, n is 22. In certain embodiments, n is 23. In certain embodiments, n is 24. In certain embodiments, n is 25. In certain embodiments, n is 26. In certain embodiments, n is 27. In certain embodiments, n is 28. In certain embodiments, n is 29. In certain embodiments, n is 30. In certain embodiments, n is 31. In certain embodiments, n is 32. In certain embodiments, n is 33. In certain embodiments, n is 34. In certain embodiments, n is 35. In certain embodiments, n is 36. In certain embodiments, n is 37. In certain embodiments, n is 38. In certain embodiments, n is 39. In certain embodiments, n is 40. In certain embodiments, n is 41. In certain embodiments, n is 42. In certain embodiments, n is 43. In certain embodiments, n is 44. In certain embodiments, n is 45. In certain embodiments, n is 46. In certain embodiments, n is 47. In certain embodiments, n is 48. In certain embodiments, n is 49. In certain embodiments, n is 50.

In one embodiment of Formula (I), including any of the foregoing, n is a mixture of integers from 5 to 50. In one embodiment of Formula (I), including any of the foregoing, n is a mixture of integers from 5 to 10. In one embodiment of Formula (I), including any of the foregoing, n is a mixture of integers from 10 to 15. In one embodiment of Formula (I), including any of the foregoing, n is a mixture of integers from 15 to 20. In one embodiment of Formula (I), including any of the foregoing, n is a mixture of integers from 20 to 25. In one embodiment of Formula (I), including any of the foregoing, n is a mixture of integers from 25 to 30. In one embodiment of Formula (I), including any of the foregoing, n is a mixture of integers from 30 to 35. In one embodiment of Formula (I), including any of the foregoing, n is a mixture of integers from 35 to 40. In one embodiment of Formula (I), including any of the foregoing, n is a mixture of integers from 40 to 45. In one embodiment of Formula (I), including any of the foregoing, n is a mixture of integers from 45 to 50. In one embodiment of Formula (I), including any of the foregoing, n is a mixture of integers from 50 to 60. In one embodiment of Formula (I), including any of the foregoing, n is a mixture of integers from 60 to 70. In one embodiment of Formula (I), including any of the foregoing, n is a mixture of integers from 70 to 80. In one embodiment of Formula (I), including any of the foregoing, n is a mixture of integers from 80 to 90. In one embodiment of Formula (I), including any of the foregoing, n is a mixture of integers from 90 to 100.

In one embodiment of Formula (I), including any of the foregoing, n is a mixture of integers from 1 to 40. In one embodiment of Formula (I), including any of the foregoing, n is a mixture of integers from 1 to 60. In one embodiment of Formula (I), including any of the foregoing, n is a mixture of integers 10 to 70. In one embodiment of Formula (I), including any of the foregoing, n is a mixture of integers from 20 to 80. In one embodiment of Formula (I), including any of the foregoing, n is a mixture of integers from 30 to 70. In one embodiment of Formula (I), including any of the foregoing, n is a mixture of integers from 40 to 90. In one embodiment of Formula (I), including any of the foregoing, n is a mixture of integers from 50 to 100.

In one embodiment, including any of the foregoing, the outer seal comprises epoxy. In one embodiment, including any of the foregoing, the outer seal comprises polyurethane.

In one embodiment, including any of the foregoing, the inner seal comprises a thermoplastic polymer and the outer seal is UV-cured. In one embodiment, including any of the foregoing, the inner seal comprises a thermoplastic polymer and the outer seal is heat-cured.

In one embodiment, including any of the foregoing, the inner seal comprises a thermoplastic polymer and the outer seal comprises photo-crosslinked polyisobutylene (PIB). In one embodiment, including any of the foregoing, the inner seal comprises a thermoplastic polymer and the outer seal comprises photo-crosslinked polyisobutylene (PIB) that is photo-crosslinked from a monomer having a structure of Formula (I).

In one embodiment, including any of the foregoing, the inner seal consists essentially of a thermoplastic polymer and the outer seal consists essentially of photo-crosslinked polyisobutylene (PIB). In one embodiment, including any of the foregoing, the inner seal consists essentially of a thermoplastic polymer and the outer seal consists essentially of photo-crosslinked polyisobutylene (PIB) that is photo-crosslinked from a monomer having a structure of Formula (I).

In one embodiment, including any of the foregoing, the inner seal comprises polyisobutylene (PIB), polyisoprene, or a mixture thereof and the outer seal comprises photo-crosslinked polyisobutylene (PIB) that is photo-crosslinked from a monomer having a structure of Formula (I). In one embodiment, including any of the foregoing, the inner seal comprises PIB and the outer seal comprises photo-crosslinked polyisobutylene (PIB) that is photo-crosslinked from a monomer having a structure of Formula (I). In one embodiment, including any of the foregoing, the inner seal comprises polyisoprene and the outer seal comprises photo-crosslinked polyisobutylene (PIB) that is photo-crosslinked from a monomer having a structure of Formula (I). In one embodiment, including any of the foregoing, the inner seal comprises a mixture of PIB and polyisoprene and the outer seal comprises photo-crosslinked polyisobutylene (PIB) that is photo-crosslinked from a monomer having a structure of Formula (I).

In one embodiment, including any of the foregoing, the inner seal is one inner seal and comprises polyisobutylene (PIB), polyisoprene, or a mixture thereof and the outer seal comprises photo-crosslinked polyisobutylene (PIB) that is photo-crosslinked from a monomer having a structure of Formula (I). In one embodiment, including any of the foregoing, the inner seal is one inner seal and comprises PIB, polyisoprene, or a mixture thereof and further comprises a polyolefin and the outer seal comprises photo-crosslinked polyisobutylene (PIB) that is photo-crosslinked from a monomer having a structure of Formula (I).

In one embodiment, including any of the foregoing, the inner seal is three inner seals and each comprises polyisobutylene (PIB), polyisoprene, or a mixture thereof and the outer seal comprises photo-crosslinked polyisobutylene (PIB) that is photo-crosslinked from a monomer having a structure of Formula (I). In one embodiment, including any of the foregoing, the inner seal is three inner seals and each comprises PIB, polyisoprene, or a mixture thereof and further comprises a polyolefin and the outer seal comprises photo-crosslinked polyisobutylene (PIB) that is photo-crosslinked from a monomer having a structure of Formula (I).

In one embodiment, including any of the foregoing, the distance between the edge of the cathode and the outside edge of the outer seal is about 0.1 mm to 1 mm. In one embodiment, including any of the foregoing, the distance between the edge of the cathode and the outside edge of the outer seal is about 0.1 mm to 0.8 mm. In one embodiment, including any of the foregoing, the distance between the edge of the cathode and the outside edge of the outer seal is about 0.1 mm to 0.6 mm. In one embodiment, including any of the foregoing, the distance between the edge of the cathode and the outside edge of the outer seal is about 0.4 mm to 0.8 mm. In one embodiment, including any of the foregoing, the distance between the edge of the cathode and the outside edge of the outer seal is about 0.5 mm.

In one embodiment, including any of the foregoing, the distance between the edge of the cathode and the outside edge of the outer seal is about 2 mm to 10 mm. The outside edge of outer seal refers to the edge that is furthest from the edge of the cathode. In one embodiment, including any of the foregoing, the distance between the edge of the cathode and the outside edge of the outer seal is about 2 mm to 9 mm. In one embodiment, including any of the foregoing, the distance between the edge of the cathode and the outside edge of the outer seal is about 2 mm to 8 mm. In one embodiment, including any of the foregoing, the distance between the edge of the cathode and the outside edge of the outer seal is about 2 mm to 7 mm. In one embodiment, including any of the foregoing, the distance between the edge of the cathode and the outside edge of the outer seal is about 2 mm to 6 mm. In one embodiment, including any of the foregoing, the distance between the edge of the cathode and the outside edge of the outer seal is equal to, or less than, 5 mm.

In one embodiment, including any of the foregoing, the distance between the edge of the cathode and the outside edge of the outer seal is about 2 mm to 5 mm. In one embodiment, including any of the foregoing, the distance between the edge of the cathode and the outside edge of the outer seal is about 2 mm to 4 mm. In one embodiment, including any of the foregoing, the distance between the edge of the cathode and the outside edge of the outer seal is equal to, or less than, 3 mm.

In one embodiment, including any of the foregoing, the distance between the edge of the cathode and the outside edge of the outer seal is about 2 mm to 3 mm. In one embodiment, including any of the foregoing, the distance between the edge of the cathode and the outside edge of the outer seal is about 2 mm to 2.5 mm. In one embodiment, including any of the foregoing, the distance between the edge of the cathode and the outside edge of the outer seal is about 2 mm to 2.3 mm. In one embodiment, including any of the foregoing, the distance between the edge of the cathode and the outside edge of the outer seal is about 2.5 mm. In one embodiment, including any of the foregoing, the distance between the edge of the cathode and the outside edge of the outer seal is about 2.3 mm.

In one embodiment, including any of the foregoing, the distance between the outside edge of the inner seal and the inside edge of the outer seal is about 0.1 mm to 0.3 mm. The outside edge of inner seal refers to the edge that is furthest from the edge of the cathode. The inside edge of outer seal refers to the edge that is closest to the edge of the cathode. In one embodiment, including any of the foregoing, the distance between the outside edge of the inner seal and the inside edge of the outer seal is about 0.1 mm. In one embodiment, including any of the foregoing, the distance between the outside edge of the inner seal and the inside edge of the outer seal is about 0.2 mm. In one embodiment, including any of the foregoing, the distance between the outside edge of the inner seal and the inside edge of the outer seal is about 0.3 mm.

In one embodiment, including any of the foregoing, the distance between the inside edge of the inner seal and the edge of the cathode is about 1 mm to 0.2 mm. The inside edge of inner seal refers to the edge that is closest to the edge of the cathode. In one embodiment, including any of the foregoing, the distance between the inside edge of the inner seal and the edge of the cathode is about 0.9 mm to 0.1 mm. In one embodiment, including any of the foregoing, the distance between the inside edge of the inner seal and the edge of the cathode is about 0.8 mm to 0.3 mm. In one embodiment, including any of the foregoing, the distance between the inside edge of the inner seal and the edge of the cathode is about 0.75 mm to 0.35 mm. In one embodiment, including any of the foregoing, the distance between the inside edge of the inner seal and the edge of the cathode is about 0.7 mm to 0.4 mm. In one embodiment, including any of the foregoing, the distance between the inside edge of the inner seal and the edge of the cathode is about 0.8 mm to 0.5 mm. In one embodiment, including any of the foregoing, the distance between the inside edge of the inner seal and the edge of the cathode is about 0.8 mm to 0.4 mm. In one embodiment, including any of the foregoing, the distance between the inside edge of the inner seal and the edge of the cathode is about 0.75 mm.

In one embodiment, including any of the foregoing, the distance between the outside edge of the inner seal and the inside edge of the outer seal is about 0.1 mm to 0.3 mm and the distance between the inside edge of the inner seal and the edge of the cathode is about 0.8 mm to 0.3 mm. In one embodiment, including any of the foregoing, the distance between the outside edge of the inner seal and the inside edge of the outer seal is about 0.1 mm to 0.3 mm and the distance between the inside edge of the inner seal and the edge of the cathode is about 0.75 mm to 0.35 mm. In one embodiment, including any of the foregoing, the distance between the outside edge of the inner seal and inside the edge of the outer seal is about 0.1 mm to 0.3 mm and the distance between the inside edge of the inner seal and the edge of the cathode is about 0.8 mm to 0.5 mm. In one embodiment, including any of the foregoing, the distance between the outside edge of the inner seal and the inside edge of the outer seal is about 0.3 mm and the distance between the inside edge of the inner seal and the edge of the cathode is about 0.75 mm.

In one embodiment, including any of the foregoing, the cathode in the electrochemical stack has the dimension of about 57 mm by 72 mm and the separator has the dimension of about 60×75 mm.

In one embodiment, including any of the foregoing, the inner seal and the outer seal each independently have a width in the range of about 0.6 mm and 1.4 mm. In one embodiment, including any of the foregoing, the inner seal and the outer seal each independently have a width in the range of about 0.8 mm and 1.2 mm. In one embodiment, including any of the foregoing, the inner seal and the outer seal each independently have a width in the range of about 0.8 mm and 1.0 mm. In one embodiment, including any of the foregoing, the inner seal and the outer seal are each about 1 mm in width.

In one embodiment, including any of the foregoing, the inner seal is one inner seal and the one inner seal and the outer seal each independently have a width in the range of about 0.6 mm and 1.4 mm. In one embodiment, including any of the foregoing, the inner seal is one inner seal and the one inner seal and the outer seal each independently have a width in the range of about 0.8 mm and 1.2 mm. In one embodiment, including any of the foregoing, the inner seal is one inner seal and the one inner seal and the outer seal each independently have a width in the range of about 0.8 mm and 1.0 mm. In one embodiment, including any of the foregoing, the inner seal is one inner seal and the one inner seal and the outer seal are each about 1 mm in width.

In one embodiment, including any of the foregoing, the inner seal is three inner seals and each inner seal and the outer seal independently have a width in the range of about 0.6 mm and 1.4 mm. In one embodiment, including any of the foregoing, the inner seal is three inner seals and each inner seal and the outer seal independently have a width in the range of about 0.8 mm and 1.2 mm. In one embodiment, including any of the foregoing, the inner seal is three inner seals and each inner seal and the outer seal independently having a width in the range of about 0.8 mm and 1.0 mm. In one embodiment, including any of the foregoing, the inner seal is three inner seals and each inner seal and the outer seal are about 1 mm in width.

In one embodiment, including any of the foregoing, the inner seal and the outer seal each independently have a height in the range of about 100 μm and 350 μm. In one embodiment, including any of the foregoing, the inner seal and the outer seal each independently have a height in the range of about 100 μm and 250 μm. In one embodiment, including any of the foregoing, the inner seal and the outer seal each independently have a height in the range of about 100 μm and 200 μm. In one embodiment, including any of the foregoing, the inner seal and the outer seal are each about 150 μm.

In one embodiment, including any of the foregoing, the inner seal and the outer seal each independently have a height in the range of about 200 μm and 350 μm. In one embodiment, including any of the foregoing, the inner seal and the outer seal each independently have a height in the range of about 220 μm and 320 μm. In one embodiment, including any of the foregoing, the inner seal and the outer seal each independently have a height in the range of about 220 μm and 300 μm. In one embodiment, including any of the foregoing, the inner seal and the outer seal each independently have a height in the range of about 230 μm and 300 μm. In one embodiment, including any of the foregoing, the inner seal and the outer seal each independently have a height in the range of about 240 μm and 280 μm. In one embodiment, including any of the foregoing, the inner seal and the outer seal each independently have a height in the range of about 250 μm and 270 μm. In one embodiment, including any of the foregoing, the inner seal and the outer seal are each about 260 μm.

In one embodiment, including any of the foregoing, the inner seal and the outer seal each independently have a width in the range of about 0.8 mm and 1.2 mm and independently a height in the range of about 100 μm and 200 μm. In one embodiment, including any of the foregoing, the inner seal and the outer seal are each about 1.0 mm in width and about 150 μm in height.

In one embodiment, including any of the foregoing, the inner seal and the outer seal each independently have a width in the range of about 0.8 mm and 1.2 mm and independently a height in the range of about 100 μm and 200 μm and the distance between the edge of the cathode and the outside edge of the outer seal is about 2 mm to 5 mm. In one embodiment, including any of the foregoing, the inner seal and the outer seal are each about 1.0 mm in width and about 150 μm in height and the distance between the edge of the cathode and the outside edge of the outer seal is about 2 mm to 5 mm.

In one embodiment, including any of the foregoing, the inner seal and the outer seal each independently have a width in the range of about 0.8 mm and 1.2 mm and independently a height in the range of about 100 μm and 200 μm and the distance between the edge of the cathode and the outside edge of the outer seal is about 2 mm to 2.5 mm. In one embodiment, including any of the foregoing, the inner seal and the outer seal are each about 1.0 mm in width and about 150 μm in height and the distance between the edge of the cathode and the outside edge of the outer seal is about 2 mm to 2.5 mm.

In one embodiment, including any of the foregoing, the inner seal and the outer seal each independently have a width in the range of about 0.8 mm and 1.2 mm and independently a height in the range of about 220 μm and 300 μm. In one embodiment, including any of the foregoing, the inner seal and the outer seal are each about 1.0 mm in width and about 260 μm in height.

In one embodiment, including any of the foregoing, the inner seal and the outer seal each independently have a width in the range of about 0.8 mm and 1.2 mm and independently a height in the range of about 220 μm and 300 μm and the distance between the edge of the cathode and the outside edge of the outer seal is about 2 mm to 5 mm. In one embodiment, including any of the foregoing, the inner seal and the outer seal are each about 1.0 mm in width and about 260 μm in height and the distance between the edge of the cathode and the outside edge of the outer seal is about 2 mm to 5 mm.

In one embodiment, including any of the foregoing, the inner seal and the outer seal each independently have a width in the range of about 0.8 mm and 1.2 mm and independently a height in the range of about 220 μm and 300 μm and the distance between the edge of the cathode and the outside edge of the outer seal is about 2 mm to 2.5 mm. In one embodiment, including any of the foregoing, the inner seal and the outer seal are each about 1.0 mm in width and about 260 μm in height and the distance between the edge of the cathode and the outside edge of the outer seal is about 2 mm to 2.5 mm.

In one embodiment, including any of the foregoing, the inner seal comprises a thermoplastic polymer, the outer seal comprises photo-crosslinked polyisobutylene (PIB), and the distance between the edge of the cathode and the outside edge of the outer seal is about 2 mm to 2.5 mm. In one embodiment, including any of the foregoing, the inner seal consists essentially of a thermoplastic polymer, the outer seal consists essentially of photo-crosslinked PIB, and the distance between the edge of the cathode and the outside edge of the outer seal is about 2 mm to 2.5 mm.

In one embodiment, including any of the foregoing, the inner seal comprises polyisobutylene (PIB), polyisoprene, or a mixture thereof; the outer seal comprises photo-crosslinked polyisobutylene (PIB) that is photo-crosslinked from a monomer having a structure of Formula (I); and the distance between the edge of the cathode and the outside edge of the outer seal is about 2 mm to 2.5 mm. In one embodiment, including any of the foregoing, the inner seal comprises PIB; the outer seal comprises photo-crosslinked polyisobutylene (PIB) that is photo-crosslinked from a monomer having a structure of Formula (I); and the distance between the edge of the cathode and the outside edge of the outer seal is about 2 mm to 2.5 mm. In one embodiment, including any of the foregoing, the inner seal consists essentially of PIB; the outer seal comprises photo-crosslinked polyisobutylene (PIB) that is photo-crosslinked from a monomer having a structure of Formula (I); and the distance between the edge of the cathode and the outside edge of the outer seal is about 2 mm to 2.5 mm.

In one embodiment, including any of the foregoing, the inner seal is one inner seal and comprises PIB, polyisoprene, or a mixture thereof and further comprises a polyolefin; the outer seal comprises photo-crosslinked polyisobutylene (PIB) that is photo-crosslinked from a monomer having a structure of Formula (I); and, the distance between the edge of the cathode and the outside edge of the outer seal is about 2 mm to 2.5 mm. In one embodiment, including any of the foregoing, the inner seal is one inner seal and comprises PIB; the outer seal comprises photo-crosslinked polyisobutylene (PIB) that is photo-crosslinked from a monomer having a structure of Formula (I); and the distance between the edge of the cathode and the outside edge of the outer seal is about 2 mm to 2.5 mm. In one embodiment, including any of the foregoing, the inner seal is one inner seal and comprises PIB and a polyolefin; the outer seal comprises photo-crosslinked polyisobutylene (PIB) that is photo-crosslinked from a monomer having a structure of Formula (I); and the distance between the edge of the cathode and the outside edge of the outer seal is about 2 mm to 2.5 mm.

In one embodiment, including any of the foregoing, the inner seal is three inner seals and each comprise PIB, polyisoprene, or a mixture thereof and further comprise a polyolefin; the outer seal comprises photo-crosslinked polyisobutylene (PIB) that is photo-crosslinked from a monomer having a structure of Formula (I); and, the distance between the edge of the cathode and the outside edge of the outer seal is about 2 mm to 2.5 mm. In one embodiment, including any of the foregoing, the inner seal is three inner seals and each comprise PIB; the outer seal comprises photo-crosslinked polyisobutylene (PIB) that is photo-crosslinked from a monomer having a structure of Formula (I); and the distance between the edge of the cathode and the outside edge of the outer seal is about 2 mm to 2.5 mm. In one embodiment, including any of the foregoing, the inner seal is three inner seals and each comprise PIB and a polyolefin; the outer seal comprises photo-crosslinked polyisobutylene (PIB) that is photo-crosslinked from a monomer having a structure of Formula (I); and the distance between the edge of the cathode and the outside edge of the outer seal is about 2 mm to 2.5 mm.

In one embodiment, including any of the foregoing, the inner seal and the outer seal are each independently dispensed at a speed of about 1 mm/s to 100 mm/s, about 5 mm/s to 80 mm/s, about 10 mm/s to 60 mm/s, about 10 mm/s to 50 mm/s, about 15 mm/s to 40 mm/s, about 20 mm/s to 40 mm/s, or about 25 mm/s to 35 mm/s. In one embodiment, including any of the foregoing, the inner seal and the outer seal are each independently dispensed at a speed of about 25 mm/s. In one embodiment, including any of the foregoing, the inner seal and the outer seal are each independently dispensed at a speed of about 30 mm/s. In one embodiment, including any of the foregoing, the inner seal and the outer seal are each independently dispensed at a speed of about 35 mm/s.

In one embodiment, including any of the foregoing, the inner seal and the outer seal are each independently dispensed at a temperature of about 50° C. to 150° C., about 50° C. to 130° C., about 70° C. to 130° C., about 70° C. to 110° C., about 80° C. to 110° C., about 80° C. to 100° C., or about 85° C. to 95° C. In one embodiment, including any of the foregoing, the inner seal and the outer seal are each independently dispensed at a temperature of about 85° C. In one embodiment, including any of the foregoing, the inner seal and the outer seal are each independently dispensed at a temperature of about 90° C. In one embodiment, including any of the foregoing, the inner seal and the outer seal are each independently dispensed at a temperature of about 95° C.

In one embodiment, including any of the foregoing, the inner seal and the outer seal are each independently dispensed at a pressure of about 10 kPa to 300 kPa, about 50 kPa to 300 kPa, about 50 kPa to 250 kPa, about 100 kPa to 250 kPa, about 100 kPa to 200 kPa, about 125 kPa to 200 kPa, about 125 kPa to 175 kPa, about 130 kPa to 170 kPa, about 130 kPa to 160 kPa, about 140 kPa to 160 kPa, about 145 kPa to 160 kPa, or about 145 kPa to 155 kPa. In one embodiment, including any of the foregoing, the inner seal and the outer seal are each independently dispensed at a pressure of about 145 kPa. In one embodiment, including any of the foregoing, the inner seal and the outer seal are each independently dispensed at a pressure of about 150 kPa. In one embodiment, including any of the foregoing, the inner seal and the outer seal are each independently dispensed at a pressure of about 155 kPa.

In one embodiment, including any of the foregoing, the outer seal exhibits a peel strength between 22N/25 mm and 50N/25 mm following a 180-degree peel at room temperature as measured by the ASTM D3330 test. In one embodiment, including any of the foregoing, the outer seal exhibits a peel strength between 22N/25 mm and 45N/25 mm following a 180-degree peel at room temperature. In one embodiment, including any of the foregoing, the outer seal exhibits a peel strength between 22N/25 mm and 40N/25 mm following a 180-degree peel at room temperature. In one embodiment, including any of the foregoing, the outer seal exhibits a peel strength between 22N/25 mm and 35N/25 mm following a 180-degree peel at room temperature. In one embodiment, including any of the foregoing, the outer seal exhibits a peel strength between 25N/25 mm and 35N/25 mm following a 180-degree peel at room temperature. In one embodiment, including any of the foregoing, the outer seal exhibits a peel strength of about 32N/25 mm, 31N/25 mm, 30N/25 mm, 29N/25 mm, 28N/25 mm, 27N/25 mm, or 26N/25 mm following a 180-degree peel at room temperature. In one embodiment, including any of the foregoing, the outer seal exhibits a peel strength of about 28N/25 mm following a 180-degree peel at room temperature.

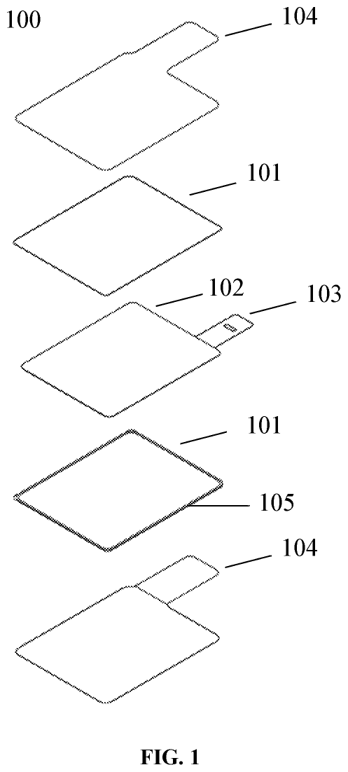

In some embodiments, the electrochemical stack is substantially as shown in FIG. 1. FIG. 1 is not drawn to scale. In FIG. 1, electrochemical stack 100 is illustrated in a vertically stacked view. Electrochemical stack 100 includes a double-sided cathode 102 with a cathode current collector 103 disposed between the two sides of the double-sided cathode. Electrochemical stack 100 also includes a solid-state electrolyte separator 101 on both sides of the stack, which is positioned on top of and contacts either side of the double-sided cathode 102. Electrochemical stack 100 also includes a seal 105 disposed between, and in some embodiments, in contact with, the separator 101 and the cathode current collector 103 on both sides of the stack. Additionally, the seal 105 is adjacent to the minor surfaces of the either side of the double-sided cathode 102 on both sides of the stack, and in some embodiments, does not contact any of the minor surfaces. In some embodiments, the seal 105 is located in proximity to the perimeter of the separator, and in some embodiments, not touching the perimeter of the separator. In some embodiments, the seal comprises one ring seal. In some embodiments, the seal comprises two ring seals, wherein one seal is an inner seal, and the other seal is an outer seal. Electrochemical stack 100 also includes an anode current collector 104, which is positioned on top of a solid-state electrolyte separator 101 on both sides of the stack. The solid-state electrolyte separator 101 may include, in some embodiments, any separators set forth herein. The cathode 102, may include, in some embodiments, any cathode active materials set forth herein. In the cathode, 102, is a catholyte, which may include, in some embodiments, any catholyte material set forth herein.

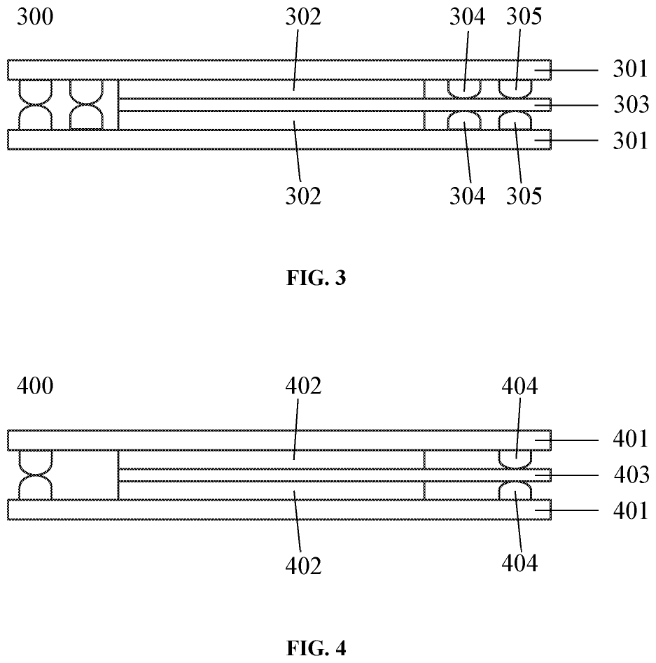

In some embodiments, the electrochemical stack is substantially as shown in FIG. 3. FIG. 3 is not drawn to scale. In FIG. 3, electrochemical stack 300 is illustrated in a vertically stacked view. Electrochemical stack 300 includes a double-sided cathode 302 with a cathode current collector 303 disposed between the two sides of the double-sided cathode. Electrochemical stack 300 also includes a solid-state electrolyte separator 301 on both sides of the stack, which is positioned on top of and contacts either side of the double-sided cathode 302. Electrochemical stack 300 also includes two ring seals 304, 305 between, and in some embodiments, contacting the solid-state electrolyte separator and the cathode current collector on both sides of the stack, wherein one seal is an inner seal 304, and the other seal is an outer seal 305. The inner seal 304 and outer seal are 305 located in proximity to the perimeter of the solid-state electrolyte separator 301 on both sides of the stack. The inner seal 304 is adjacent to, and in some embodiments, not contacting the minor surfaces of either side of the double-sided cathode. Electrochemical stack 300 also includes an anode current collector (not shown), which is positioned on top of a solid-state electrolyte separator 301 on both sides of the stack. The solid-state electrolyte separator 301 may include, in some embodiments, any separators set forth herein. The cathode 302, may include, in some embodiments, any cathode active materials set forth herein. In the cathode, 302, is a catholyte, which may include, in some embodiments, any catholyte material set forth herein.

In some embodiments, the electrochemical stack is substantially as shown in FIG. 4. FIG. 4 is not drawn to scale. In FIG. 4, electrochemical stack 400 is illustrated in a vertically stacked view. Electrochemical stack 400 includes a double-sided cathode 402 with a cathode current collector 403 disposed between the two sides of the double-sided cathode. Electrochemical stack 400 also includes a solid-state electrolyte separator 401 on both sides of the stack, which is positioned on top of and contacts either side of the double-sided cathode 402. Electrochemical stack 400 also includes one ring seal 404 between, and in some embodiments, contacting the solid-state electrolyte separator 401 and the cathode current collector 403 on both sides of the stack. Seal 404 is located in proximity to the perimeter of the solid-state electrolyte separator 401 on both sides of the stack. Furthermore, seal 404 is adjacent to, and in some embodiments, not contacting the minor surfaces of either side of the double-sided cathode. Electrochemical stack 400 also includes an anode current collector (not shown), which is positioned on top of a solid-state electrolyte separator 401 on both sides of the stack. The solid-state electrolyte separator 401 may include, in some embodiments, any separators set forth herein. The cathode 402, may include, in some embodiments, any cathode active materials set forth herein. In the cathode, 402, is a catholyte, which may include, in some embodiments, any catholyte material set forth herein.

### Electrolytes

In some embodiments, including any of the foregoing, the electrochemical stack further comprises an electrolyte (also referred to herein as a catholyte if the electrolyte is intimately mixed with and/or within the cathode) between the separator and the cathode wherein the electrolyte is selected from the group consisting of ethylene sulfite (ES), ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), γ-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy) propane (F-EPE), fluorinated cyclic carbonate (F-AEC), dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, methylene methanedisulfonate, dimethyl sulfate, dimethyl sulfoxide (DMSO), ethyl acetate, methyl butyrate, dimethyl ether (DME), diethyl ether, dioxolane, gamma butyl-lactone, methyl benzoate, 2-methyl-5-oxooxolane-2-carbonitrile, and combinations thereof. In some examples, the combinations of electrolytes are those combinations which are miscible.

In some embodiments, including any of the foregoing, the electrolyte comprises asolvent selected from the group consisting of ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), γ-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy) propane (F-EPE), and fluorinated cyclic carbonate (F-AEC).

In some embodiments, including any of the foregoing, the electrolyte comprises a solvent selected from the group consisting of dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, and methylene methanedisulfonate.

In some embodiments, including any of the foregoing, the electrolyte comprises a solvent selected from the group consisting of dimethyl sulfate, dimethyl sulfoxide (DMSO), ethyl acetate, methyl butyrate, dimethyl ether (DME), diethyl ether, dioxolane, gamma butyl-lactone, methyl benzoate, and 2-methyl-5-oxooxolane-2-carbonitrile.

In some embodiments, including any of the foregoing, the electrolyte comprises ethylene sulfite (ES). In some embodiments, including any of the foregoing, the electrolyte comprises sulfolane. In some embodiments, including any of the foregoing, the electrolyte comprises an electrolyte selected from the group consisting of ethylene sulfite (ES) and sulfolane. In some embodiments, including any of the foregoing, the ethylene sulfite (ES) to sulfolane is about 7:3 by volume (v/v) to about 5:5 by volume (v/v). In some embodiments, including any of the foregoing, the ethylene sulfite (ES) to sulfolane is about 9:3 by volume, about 8:3 by volume, about 7:3 by volume, about 6:3 by volume, or about 5:3 by volume. In some embodiments, including any of the foregoing, the ethylene sulfite (ES) to sulfolane is about 7:3 by volume. In some embodiments, including any of the foregoing, the ethylene sulfite (ES) to sulfolane is about 7:3 by volume. In some embodiments, including any of the foregoing, the ethylene sulfite (ES) to sulfolane is about 5:5 by volume.

In some embodiments, including any of the foregoing, the electrolyte further comprises a lithium salt. In some embodiments, including any of the foregoing, the concentration of the lithium salt is about 0.5 molar (M) to 5 (M). In some embodiments, including any of the foregoing, the concentration of the lithium salt is less than about 2 M. In some embodiments, including any of the foregoing, the electrolyte comprises ethylene sulfite (ES) and sulfolane and a lithium salt wherein the concentration of the lithium salt is about 0.5 M to 5 M. In some embodiments, including any of the foregoing, the electrolyte comprises ethylene sulfite (ES) and sulfolane and a lithium salt wherein the concentration of the lithium salt is less than about 2 M.

In some embodiments, including any of the foregoing, the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiI, LiBr, LiCl, and combinations thereof. In some embodiments, including any of the foregoing, the lithium salt is selected from LiPF₆ or LiBF₄. In some embodiments, including any of the foregoing, the lithium salt is LiBF₄. In some embodiments, including any of the foregoing, the lithium salt is selected from 1.4M LiPF₆; 1.4M LiBF₄; and 1.6M LiBF₄. In some embodiments, including any of the foregoing, the lithium salt is selected from 1.4M LiBF₄ and 1.6M LiBF₄.

In some embodiments, including any of the foregoing, the electrolyte does not contact the outer seal. In some embodiments, including any of the foregoing, the electrolyte is contained by the inner seal.

### Catholytes

In certain embodiments, including any of the foregoing, the cathode in the electrochemical stack comprises a catholyte as described in International Patent Publication No. WO2023121838A1, CATHOLYTES FOR A SOLID-STATE BATTERY, filed Nov. 11, 2022, as PCT/US22/51433, which is incorporated by reference herein in its entirety.

In certain embodiments, the catholyte further including a lithium salt. See, for example, WO 2023/121838 A1, the content of which is incorporated herein by reference in its entirety.

In certain embodiments, the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiI, LiBr, LiCl, and combinations thereof.

In some embodiments, including any of the foregoing, the lithium salt is present at a concentration of about 0.5 M to about 5.0 M. In some embodiments, including any of the foregoing, the lithium salt is present at a concentration of about 0.5 M to about 2.5 M. In some other embodiments, including any of the foregoing, the lithium salt is present at a concentration of about 0.5 M to about 2.0 M.

In certain embodiments, the catholyte further includes an organic carbonate solvent. In certain embodiments, the organic carbonate solvent is ethylene carbonate, propylene carbonate, diethyl carbonate, dimethyl carbonate, or a combination thereof. In one embodiment, the organic carbonate solvent is ethylene carbonate. In one embodiment, the organic carbonate solvent is propylene carbonate. In one embodiment, the organic carbonate solvent is diethyl carbonate. In certain embodiments, the at least one organic solvent is selected from the group consisting of ethylene sulfite; 4-methyl-1,3,2-dioxathiolane 2-oxide; 1,3-propane sultone; sulfolane; thiophene; thiazole; 1,2-oxathiolane; thiepine; 1,4-thiazepine; 6H-1,2,5-thiadiazine; 2H,6H-1,5,2-dithiazine; methylene methanedisulfonate; ethylene sulfate; thiopyran; thiepine; thiocine; derivatives thereof, and combinations thereof. In one embodiment, the at least one organic solvent is ethylene sulfite. In one embodiment, the at least one organic solvent is 4-methyl-1,3,2-dioxathiolane 2-oxide. In one embodiment, the at least one organic solvent is 1,3-propane sultone. In one embodiment, the at least one organic solvent is sulfolane. In one embodiment, the at least one organic solvent is thiophene. In one embodiment, the at least one organic solvent is thiazole. In one embodiment, the at least one organic solvent is 1,2-oxathiolane. In one embodiment, the at least one organic solvent is thiepine. In one embodiment, the at least one organic solvent is 1,4-thiazepine. In one embodiment, the at least one organic solvent is 6H-1,2,5-thiadiazine. In one embodiment, the at least one organic solvent is 2H,6H-1,5,2-dithiazine. In one embodiment, the at least one organic solvent is methylene methanedisulfonate. In one embodiment, the at least one organic solvent is ethylene sulfate. In one embodiment, the at least one organic solvent is thiopyran. In one embodiment, the at least one organic solvent is thiepine. In one embodiment, the at least one organic solvent is thiocine. In certain embodiments, the at least one solvent is a 70:30 v/v % mixture of ethylene sulfite:sulfolane.

In certain embodiments, the catholyte is in contact with a solid-state electrolyte including lithium-stuffed garnet, wherein the solid-state electrolyte is a thin film. In certain embodiments, the solid-state electrolyte is a lithium-stuffed garnet characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0≤C<2.5, 0≤D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta. In certain embodiments, the lithium-stuffed garnet is characterized by a formula selected from the group consisting of LiₐLa_{b}Zr_{c}Al_{d}Me″ₑO_{f} wherein 5<a<7.7; 2<b<4; 0<c<2.5; 0<d<2.5; 0≤e<2.5, 10<f<14, and wherein Me″ is a metal selected from the group consisting of Nb, Ta, V, W, Mo, and Sb. In certain embodiments, the lithium-stuffed garnet is characterized by a formula selected from the group consisting of LiₐLa_{b}Zr_{c}Al_{d}O_{f} wherein 5<a<7.7; 2<b<4; 0<c<2.5; 0<d<2.5; and 10<f<14.

In certain embodiments, the catholyte solution is disposed in an electrochemical cell which includes a positive electrode, a lithium-metal negative electrode, and a solid-state electrolyte including lithium-stuffed garnet.

In certain embodiments, the catholyte includes: a lithium salt; and at least two C₃₋₁₀ heterocyclic molecules, each independently, in each instance, including at least one sulfur (S) ring atom and optionally substituted with 1 to 6 substituents.

In some embodiments, including any of the foregoing, the C₃₋₁₀ heterocyclic molecules is a molecule of Formula (B-I)

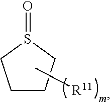

wherein R¹¹ is independently selected at each occurrence from the group consisting of polyethylene glycol (PEG), ═O, SO₂, —CF₃, —CH₂F, CHF₂, —NO₂, —NO₃, —NH₃, —CH₃, PO₄, PO₃, BO₃, and —CN; and subscript m is an integer from 0 to 8.

In some embodiments, including any of the foregoing, the C₃₋₁₀ heterocyclic molecules are a molecule of Formula (C):

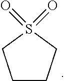

In some embodiments, including any of the foregoing, the C₃₋₁₀ heterocyclic molecule comprises at least one sulfur (S) ring atom.

In some embodiments, including any of the foregoing, the C₃₋₁₀ heterocyclic molecule comprises at least one sulfur (S) ring atom and one oxygen (O) ring atom.

In some embodiments, including any of the foregoing, at least one C₃₋₁₀heterocyclic molecule is selected from the group consisting of ethylene sulfite, sulfolane, and combinations thereof. In some embodiments, including any of the foregoing, at least one C₃₋₁₀heterocyclic molecule is selected from ethylene sulfite. In some embodiments, including any of the foregoing, at least one C₃₋₁₀ heterocyclic molecule is selected from sulfolane.

In some embodiments, including any of the foregoing, the catholyte consists of ethylene sulfite and sulfolane in a 70:30 volume ratio. In some embodiments, including any of the foregoing, the catholyte includes two C₃₋₁₀ heterocyclic molecules, wherein a ratio of one C₃₋₁₀ heterocyclic molecule to the other C₃₋₁₀ heterocyclic molecules is from 20:80 vol/vol (v/v) to 80:20 v/v. In some embodiments, including any of the foregoing, the ratio of one C₃₋₁₀heterocyclic molecule to the other C₃₋₁₀ heterocyclic molecules is from 15:85 vol/vol (v/v) to 85:15 v/v. In some embodiments, including any of the foregoing, the ratio of one C₃₋₁₀heterocyclic molecule to the other C₃₋₁₀ heterocyclic molecules is from 20:80 vol/vol (v/v) to 80:20 v/v. In some embodiments, including any of the foregoing, the ratio of one C₃₋₁₀heterocyclic molecule to the other C₃₋₁₀ heterocyclic molecules is from 25:75 vol/vol (v/v) to 75:25 v/v. In some embodiments, including any of the foregoing, the ratio of one C₃₋₁₀ heterocyclic molecule to the other C₃₋₁₀ heterocyclic molecules is from 30:70 vol/vol (v/v) to 70:30 v/v. In some embodiments, including any of the foregoing, the ratio of one C₃₋₁₀ heterocyclic molecule to the other C₃₋₁₀ heterocyclic molecules is from 35:65 vol/vol (v/v) to 65:35 v/v. In some embodiments, including any of the foregoing, the ratio of one C₃₋₁₀ heterocyclic molecule to the other C₃₋₁₀ heterocyclic molecules is from 40:60 vol/vol (v/v) to 60:40 v/v. In some embodiments, including any of the foregoing, the ratio of one C₃₋₁₀ heterocyclic molecule to the other C₃₋₁₀ heterocyclic molecules is from 45:55 vol/vol (v/v) to 55:45 v/v. In some embodiments, including any of the foregoing, the ratio of one C₃₋₁₀ heterocyclic molecule to the other C₃₋₁₀ heterocyclic molecules is 50:50 vol/vol (v/v). In some embodiments, including any of the foregoing, the ratio of sulfolane:(ethylene sulfite) is from 30:70 v/v to 50:50 v/v. In some embodiments, including any of the foregoing, the ratio of sulfolane:(ethylene sulfite) is 30:70 v/v. In some embodiments, including any of the foregoing, the ratio of sulfolane:(ethylene sulfite) is 50:50 v/v. In some embodiments, including any of the foregoing, the ratio of sulfolane:(ethylene sulfite) is from 10:90 v/v to 90:10 v/v.

In some embodiments, including any of the foregoing, the catholyte also includes an additive selected from the group consisting of tris(trimethysilyl) phosphite (TTSPi), tris(trimethysilyl) phosphate (TTSPa), trimethoxyboroxine (C₃H₉B₃O₆, TMOBX), vinylene carbonate (VC), vinyl ethylene carbonate (VEC), methylene methane disulfonate (MMDS), prop-1-ene-1,3 sultone (PES), fluoroethylene carbonate (FEC), LiTFSi, LiBOB, succinonitrile, trimethylene sulfate (TMS), triallyl phosphate (TAP), tris(trimethylsilyl)borate (TMSB), tris(pentafluorophenyl) borane (TPFPB), and combinations thereof.

In some embodiments, including any of the foregoing, the additive is TTSPi. In some embodiments, including any of the foregoing, the additive is TTSPa. In some embodiments, including any of the foregoing, the additive is a combination of TTSPi and TTSPa.

In some embodiments, the catholyte includes a gel set forth herein. In some embodiments, the gel electrolyte includes any electrolyte set forth herein, including a nitrile, dinitrile, organic sulfur-including solvent, or combination thereof set forth herein. In some embodiments, the catholyte incldues an “organic sulfur-including solvent” such as, but not limited to, ethyl methyl sulfone, dimethyl sulfone, sulfolane, allyl methyl sulfone, butadiene sulfone, butyl sulfone, methyl methanesulfonate, and dimethyl sulfate. In some embodiments, the catholyte incldues a mixture of ethylene carbonate and sulfolane. Herein, sulfolane refers to tetrahydrothiophene 1,1-dioxide, having the cyclic sulfone structure shown below:

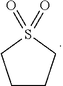

In some embodiments, the catholyte incldues a lithium salt; a first solvent selected from the group consisting of sulfolane, 1,3-propane sultone, sulfolene, thiophene, and combinations thereof; a second solvent; and a strong Lewis acid additive.

In some embodiments, the catholyte solution comprises ethylene sulfite, sulfolane or combinations thereof. In some embodiments, the catholyte solution comprises ethylene sulfite. In some embodiments, the catholyte solution comprises sulfolane. In some embodiments, the catholyte solution comprises ethylene sulfite and sulfolane.

In some embodiments, the catholyte solution further comprises a lithium salt. In some embodiments, the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiI, LiBr, LiCl, and combinations thereof. In one embodiment, the lithium salt is LiPF₆. In one embodiment, the lithium salt is lithium bis(oxalato)borate (LiBOB). In one embodiment, the lithium salt is lithium bis(perfluoroethanesulfonyl)imide (LIBETI). In one embodiment, the lithium salt is bis(trifluoromethane)sulfonimide (LiTFSI). In one embodiment, the lithium salt is LiBF₄. In one embodiment, the lithium salt is LiClO₄. In one embodiment, the lithium salt is LiAsF₆. In one embodiment, the lithium salt is lithium bis(fluorosulfonyl)imide (LiFSI). In one embodiment, the lithium salt is LiI. In one embodiment, the lithium salt is LiBr. In one embodiment, the lithium salt is LiCl.

### III. Process of Sealing a Cathode to a Solid-State Electrolyte Separator and Process of Making an Electrochemical Stack

In another aspect, the present disclosure provides a process of sealing a cathode to a solid-state electrolyte separator comprising providing a seam between a cathode and a solid-state electrolyte separator wherein the seam comprises an acryloyl group-terminated monomer; and UV-curing, heat-curing, or UV-curing and heat-curing the seam to form a seal that comprises photo-crosslinked polyisobutylene (PIB). In one embodiment, the seam is UV-cured.

In one embodiment, including any of the foregoing, the seam further comprises a tackifier. In one embodiment, including any of the foregoing, the seal further comprises a tackifier.

In another aspect, the present disclosure provides a process of sealing a cathode to a solid-state electrolyte separator comprising providing a seam between a cathode and a solid-state electrolyte separator wherein the seam comprises an inner seam and an outer seam; vacuum sealing the inner seam to form an inner seal; and UV-curing, heat-curing, or UV-curing and heat-curing the outer seam to form an outer seal.

In one embodiment, the outer seam is UV-cured. In one embodiment, the outer seam is heat-cured. In one embodiment, the outer seam is UV-cured and heat-cured.

In one embodiment, including any of the foregoing, the UV-curing is for less than about 2 minutes, less than about 90 seconds, less than about 1 minute, less than about 45 seconds, less than about 30 seconds, less than about 20 seconds, less than about 15 seconds, or less than about 10 seconds.

In one embodiment, including any of the foregoing, the UV-curing is for a minimum of about 1 second.

In one embodiment, including any of the foregoing, the UV-curing is for about 2 minutes, about 90 seconds, about 1 minute, about 45 seconds, about 30 seconds, about 20 seconds, about 15 seconds, or about 10 seconds. In one embodiment, including any of the foregoing, the UV-curing is for about 10 seconds. In one embodiment, including any of the foregoing, the UV-curing is with 365 nm UV wavelength.

In one embodiment, including any of the foregoing, the UV intensity is about 250 mw/cm² to 600 mw/cm² and the wavelength is 365 nm. In one embodiment, including any of the foregoing, the UV intensity is about 200 mw/cm² to 550 mw/cm² and the wavelength is 365 nm. In one embodiment, the UV intensity is about 300 mw/cm² to 500 mw/cm² and the wavelength is 365 nm. In one embodiment, including any of the foregoing, the UV intensity is about 400 mw/cm² to 600 mw/cm² and the wavelength is 365 nm. In one embodiment, including any of the foregoing, the UV intensity is about 450 mw/cm² to 550 mw/cm² and the wavelength is 365 nm. In one embodiment, the UV intensity is about 500 mw/cm² and the wavelength is 365 nm.

In one embodiment, including any of the foregoing, the UV-curing comprises radiating the outer seam with UVA wavelengths. In one embodiment, including any of the foregoing, the UV-curing comprises radiating the outer seam with UVB wavelengths. In one embodiment, including any of the foregoing, the UV-curing comprises radiating the outer seam with UVC wavelengths.

In one embodiment, including any of the foregoing, the UV-curing comprises radiating the outer seam with UVA wavelengths wherein the UVA intensity is between 950 and 900 mW/cm². In one embodiment, including any of the foregoing, the UV-curing comprises radiating the outer seam with UVB wavelengths wherein the UVB intensity is between 875 and 800 mW/cm². In one embodiment, including any of the foregoing, the UV-curing comprises radiating the outer seam with UVC wavelengths wherein the UVC intensity is between 450 and 375 mW/cm².

In one embodiment, including any of the foregoing, the UV-curing comprises radiating the outer seam with UVA wavelengths wherein the dosage of UVA is between 880 and 800 mJ/cm². In one embodiment, including any of the foregoing, the UV-curing comprises radiating the outer seam with UVB wavelengths wherein the dosage of UVB is between 800 and 750 mJ/cm². In one embodiment, including any of the foregoing, the UV-curing comprises radiating the outer seam with UVC wavelengths wherein the dosage of UVC is about 361 mJ/cm².

In one embodiment, including any of the foregoing, the UV-curing comprises radiating the outer seam with UVA and UVB wavelengths. In one embodiment, including any of the foregoing, the UV-curing comprises radiating the outer seam with UVA and UVC wavelengths. In one embodiment, including any of the foregoing, the UV-curing comprises radiating the outer seam with UVB and UVC wavelengths.

In one embodiment, including any of the foregoing, the UV-curing comprises radiating the outer seam with UVA and UVB wavelengths wherein the UVA intensity is between 950 and 900 mW/cm² and the UVB intensity is between 875 and 800 mW/cm². In one embodiment, including any of the foregoing, the UV-curing comprises radiating the outer seam with UVA and UVC wavelengths wherein the UVA intensity is between 950 and 900 mW/cm² and the UVC intensity is between 450 and 375 mW/cm². In one embodiment, including any of the foregoing, the UV-curing comprises radiating the outer seam with UVB and UVC wavelengths wherein the UVB intensity is between 875 and 800 mW/cm² and the UVC intensity is between 450 and 375 mW/cm².

In one embodiment, including any of the foregoing, the UV-curing comprises radiating the outer seam with UVA and UVB wavelengths wherein the dosage of UVA is between 880 and 800 mJ/cm² and the dosage of UVB is between 800 and 750 mJ/cm². In one embodiment, including any of the foregoing, the UV-curing comprises radiating the outer seam with UVA and UVC wavelengths wherein the dosage of UVA is between 880 and 800 mJ/cm² and the dosage of UVC is about 361 mJ/cm². In one embodiment, including any of the foregoing, the UV-curing comprises radiating the outer seam with UVB and UVC wavelengths wherein the dosage of UVB is between 800 and 750 mJ/cm² and the dosage of UVC is about 361 mJ/cm².

In one embodiment, including any of the foregoing, the UV-curing comprises radiating the outer seam with UVA, UVB, and UVC wavelengths. In one embodiment, including any of the foregoing, the UV-curing comprises radiating the outer seam with UVA, UVB, and UVC wavelengths and the UVA intensity is between 950 and 900 mW/cm²; the UVB intensity is between 875 and 800 mW/cm²; and, the UVC intensity is between 450 and 375 mW/cm². In one embodiment, including any of the foregoing, the UV-curing comprises radiating the outer seam with UVA, UVB, and UVC wavelengths and the UVA intensity is about 922 mW/cm²; the UVB intensity is about 864 mW/cm²; and, the UVC intensity is about 396 mW/cm².

In one embodiment, including any of the foregoing, the UV-curing comprises radiating the outer seam with UVA, UVB, and UVC wavelengths and the dosage of UVA is between 880 and 800 mJ/cm²; the dosage of UVB is between 800 and 750 mJ/cm²; and, the dosage of UVC is between 400 and 300 mJ/cm². In one embodiment, including any of the foregoing, the UV-curing comprises radiating the outer seam with UVA, UVB, and UVC wavelengths and the dosage of UVA is about 840 mJ/cm²; the dosage of UVB is about 773 mJ/cm²; and, the dosage of UVC is about 361 mJ/cm².

In one embodiment, including any of the foregoing, the UV-curing is for less than about 1 minute. In one embodiment, including any of the foregoing, the UV-curing is for less than about 30 seconds. In one embodiment, including any of the foregoing, the UV-curing is for between 10 and 15 seconds. In one embodiment, including any of the foregoing conditions, the UV-curing is for about ten seconds.

In one embodiment, including any of the foregoing, the UV-curing is for less than about 1 minute; the UV intensity is about 500 mw/cm²; and the wavelength is 365 nm. In one embodiment, including any of the foregoing, the UV-curing is for less than about 45 seconds; the UV intensity is about 500 mw/cm²; and the wavelength is 365 nm. In one embodiment, including any of the foregoing, the UV-curing is for less than about 30 seconds; the UV intensity is about 500 mw/cm²; and the wavelength is 365 nm. In one embodiment, including any of the foregoing, the UV-curing for less than about 15 seconds; the UV intensity is about 500 mw/cm²; and the wavelength is 365 nm. In one embodiment, including any of the foregoing, the UV-curing for about 10 seconds; the UV intensity is about 500 mw/cm²; and the wavelength is 365 nm.

In one embodiment, including any of the foregoing, the heat-curing is for less than about 10 hours, less than about 8 hours, less than about 6 hours, less than about 5 hours, less than about 4 hours, less than about 3 hours, less than about 2 hours, less than 1 hour, or less than 30 minutes.

In one embodiment, including any of the foregoing, the heat-curing is for less than about 2 minutes, less than about 90 seconds, less than about 1 minute, less than about 45 seconds, less than about 30 seconds, less than about 20 seconds, less than about 15 seconds, or less than about 10 seconds.

In one embodiment, including any of the foregoing, the heat-curing is for a minimum of about 1 second.

In one embodiment, including any of the foregoing, the heat-curing is for about 2 minutes, about 90 seconds, about 1 minute, about 45 seconds, about 30 seconds, about 20 seconds, about 15 seconds, or about 10 seconds. In one embodiment, including any of the foregoing, the heat-curing is for about 10 seconds.

In one embodiment, including any of the foregoing, the heat-curing is at a temperature less than about 65° C., less than about 60° C., less than about 55° C., less than about 50° C., less than about 45° C., less than about 45° C., less than about 30° C., or less than about 35° C. In one embodiment, including any of the foregoing, the heat-curing is at a temperature less than about 50° C. In one embodiment, including any of the foregoing, the heat-curing is at a temperature of about 40° C. In one embodiment, including any of the foregoing, the heat-curing is at a temperature of about 60° C.

In one embodiment, including any of the foregoing, the heat-curing is at a temperature between 30° C. and 60° C. In one embodiment, including any of the foregoing, the heat-curing is at a temperature between 30° C. and 50° C. In one embodiment, including any of the foregoing, the heat-curing is at a temperature between 35° C. and 45° C. In one embodiment, including any of the foregoing, the heat-curing is at a temperature between 30° C. and 35° C. In one embodiment, including any of the foregoing, the heat-curing is at a temperature between 40° C. and 45° C.

In another aspect, the present disclosure provides a process of making an electrochemical stack comprising the following:
a. dispensing a UV-curable or heat-curable seam on the solid-state electrolyte separator wherein the seam comprises an acryloyl group-terminated monomer, a tackifier, and an anti-oxidant;
b. joining together a cathode comprising a catholyte and the solid-state electrolyte separator wherein the UV-curable or heat-curable seam are in contact with the cathode; and
c. UV-curing, heat-curing, or UV-curing and heat-curing the seam to form a UV- and/or heat-cured seal comprising photo-crosslinked polyisobutylene (PIB) and tackifier between the cathode and the separator.

In one embodiment, the seam is UV-cured.

In some embodiments, the solid-state electrolyte separator has two major surfaces and four minor surfaces. In some embodiments, the cathode has two major surfaces and four minor surfaces.

In some embodiments, the seam in (a) is dispensed within 0.1 mm to 2 mm from a perimeter of the first major surface of the solid-state electrolyte separator. In some embodiments, the seam does not contact the perimeter of the first major surface, the second major surface, or the minor surfaces of the separator.

In some embodiments, the seal does not contact the perimeter of the first major surface, the second major surface, or the minor surfaces of the separator. In some embodiments, the seal does not contact the minor surfaces of the cathode.

In one embodiment, the seam in (a) is dispensed via a liquid reservoir. In one embodiment, including any of the foregoing, the seam in (a) is a perimeter seam. In one embodiment, including any of the foregoing, the seam in (a) is UV-curable. In one embodiment, including any of the foregoing, the seam in (a) is heat-curable.

In one embodiment, including any of the foregoing, the acryloyl group-terminated monomer is of Formula (I):

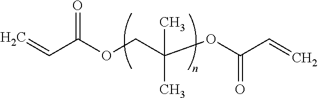

wherein n is an integer from 5 to 50.

In one embodiment, including any of the foregoing, the acryloyl group-terminated monomer is a mixture of monomers of Formula (I):

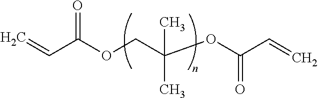

wherein n is an integer from 1 to 100.

In one embodiment of Formula (I), including any of the foregoing, n is an integer from 5 to 10. In one embodiment of Formula (I), including any of the foregoing, n is an integer from 10 to 15. In one embodiment of Formula (I), including any of the foregoing, n is an integer from 15 to 20. In one embodiment of Formula (I), including any of the foregoing, n is an integer from 20 to 25. In one embodiment of Formula (I), including any of the foregoing, n is an integer from 25 to 30. In one embodiment of Formula (I), including any of the foregoing, n is an integer from 30 to 35. In one embodiment of Formula (I), including any of the foregoing, n is an integer from 35 to 40. In one embodiment of Formula (I), including any of the foregoing, n is an integer from 40 to 45. In one embodiment of Formula (I), including any of the foregoing, n is an integer from 45 to 50.

In one embodiment of Formula (I), including any of the foregoing, n is a mixture of integers from 5 to 10. In one embodiment of Formula (I), including any of the foregoing, n is a mixture of integers from 10 to 15. In one embodiment of Formula (I), including any of the foregoing, n is a mixture of integers from 15 to 20. In one embodiment of Formula (I), including any of the foregoing, n is a mixture of integers from 20 to 25. In one embodiment of Formula (I), including any of the foregoing, n is a mixture of integers from 25 to 30. In one embodiment of Formula (I), including any of the foregoing, n is a mixture of integers from 30 to 35. In one embodiment of Formula (I), including any of the foregoing, n is a mixture of integers from 35 to 40. In one embodiment of Formula (I), including any of the foregoing, n is a mixture of integers from 40 to 45. In one embodiment of Formula (I), including any of the foregoing, n is a mixture of integers from 45 to 50. In one embodiment of Formula (I), including any of the foregoing, n is a mixture of integers from 50 to 60. In one embodiment of Formula (I), including any of the foregoing, n is a mixture of integers from 60 to 70. In one embodiment of Formula (I), including any of the foregoing, n is a mixture of integers from 70 to 80. In one embodiment of Formula (I), including any of the foregoing, n is a mixture of integers from 80 to 90. In one embodiment of Formula (I), including any of the foregoing, n is a mixture of integers from 90 to 100.

In one embodiment of Formula (I), including any of the foregoing, n is a mixture of integers from 1 to 40. In one embodiment of Formula (I), including any of the foregoing, n is a mixture of integers from 1 to 60. In one embodiment of Formula (I), including any of the foregoing, n is a mixture of integers 10 to 70. In one embodiment of Formula (I), including any of the foregoing, n is a mixture of integers from 20 to 80. In one embodiment of Formula (I), including any of the foregoing, n is a mixture of integers from 30 to 70. In one embodiment of Formula (I), including any of the foregoing, n is a mixture of integers from 40 to 90. In one embodiment of Formula (I), including any of the foregoing, n is a mixture of integers from 50 to 100.

In some embodiments, including any of the foregoing, the seam in (a) further comprises at least one photo initiator.

In one embodiment, including any of the foregoing, the seam in (a) comprises a monomer having a structure of Formula (I), a tackifier, an anti-oxidant, and one photo initiator. In one embodiment, including any of the foregoing, the seam in (a) comprises a monomer having a structure of Formula (I), a tackifier, an anti-oxidant, and two photo initiators.

In one embodiment, including any of the foregoing, the seam in (a) comprises a monomer having a structure of Formula (I), polyisobutylene (PIB) with a molecular weight of about 10,000 g/mol to 100,000 g/mol, an anti-oxidant, and at least one photo initiator. In one embodiment, including any of the foregoing, the seam in (a) comprises a monomer having a structure of Formula (I), polyisobutylene (PIB) with a molecular weight of about 10,000 g/mol to 40,000 g/mol, an anti-oxidant, and at least one photo initiator. In one embodiment, including any of the foregoing, the seam in (a) comprises a monomer having a structure of Formula (I), Oppanol® B10, an anti-oxidant, and at least one photo initiator. In one embodiment, including any of the foregoing, the molecular weight of the PIB is about 10,000 g/mol. In one embodiment, including any of the foregoing, the PIB is about 15,000 g/mol. In one embodiment, including any of the foregoing, the molecular weight of the PIB is about 20,000 g/mol. In one embodiment, including any of the foregoing, the molecular weight of the PIB is about 25,000 g/mol. In one embodiment, including any of the foregoing, the molecular weight of the PIB is about 30,000 g/mol. In one embodiment, including any of the foregoing, the PIB is about 35,000 g/mol. In one embodiment, including any of the foregoing, the molecular weight of the PIB is about 40,000 g/mol. In one embodiment, including any of the foregoing, the molecular weight of the PIB is about 45,000 g/mol. In one embodiment, including any of the foregoing, the molecular weight of the PIB is about 50,000 g/mol. In one embodiment, including any of the foregoing, the molecular weight of the PIB is about 55,000 g/mol.

In one embodiment, including any of the foregoing, the seam in (a) comprises a monomer having a structure of Formula (I), polyisobutylene (PIB) with a molecular weight of about 10,000 g/mol to 100,000 g/mol, an anti-oxidant, and two one photo initiators. In one embodiment, including any of the foregoing, the seam in (a) comprises a monomer having a structure Formula (I), polyisobutylene (PIB) with a molecular weight of about 10,000 g/mol to 40,000 g/mol, an anti-oxidant, and two one photo initiators. In one embodiment, including any of the foregoing, the seam in (a) comprises a monomer having a structure of Formula (I), Oppanol® B10, an anti-oxidant, and two photo initiators. In one embodiment, including any of the foregoing, the molecular weight of the PIB is about 10,000 g/mol. In one embodiment, including any of the foregoing, the molecular weight of the PIB is about 15,000 g/mol. In one embodiment, including any of the foregoing, the molecular weight of the PIB is about 20,000 g/mol. In one embodiment, including any of the foregoing, the molecular weight of the PIB is about 25,000 g/mol. In one embodiment, including any of the foregoing, the molecular weight of the PIB is about 30,000 g/mol. In one embodiment, including any of the foregoing, the molecular weight of the PIB is about 35,000 g/mol. In one embodiment, including any of the foregoing, the molecular weight of the PIB is about 40,000 g/mol. In one embodiment, including any of the foregoing, the molecular weight of the PIB is about 45,000 g/mol. In one embodiment, including any of the foregoing, the molecular weight of the PIB is about 50,000 g/mol. In one embodiment, including any of the foregoing, the molecular weight of the PIB is about 55,000 g/mol.

In one embodiment, including any of the foregoing, the seam in (a) comprises a monomer having a structure of Formula (I), polyisobutylene (PIB) with a molecular weight of about 10,000 g/mol to 100,000 g/mol, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide. In one embodiment, including any of the foregoing, the seam in (a) comprises a monomer having a structure of Formula (I), polyisobutylene (PIB) with a molecular weight of about 10,000 g/mol to 40,000 g/mol, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide. In one embodiment, including any of the foregoing, the seam in (a) comprises a monomer having a structure of Formula (I), Oppanol® B10, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide.

In one embodiment, including any of the foregoing, the seam in (a) comprises at least about 90% w/w acryloyl group-terminated monomer, at least about 95% w/w acryloyl group-terminated monomer, at least about 97% w/w acryloyl group-terminated monomer, at least about 90% w/w acryloyl group-terminated monomer, at least about 98% w/w acryloyl group-terminated monomer, or at least about 99% w/w acryloyl group-terminated monomer. In one embodiment, including any of the foregoing, the seam in (a) comprises about 99% w/w acryloyl group-terminated monomer.

In one embodiment, including any of the foregoing, the seam in (a) comprises no more than about 5% w/w of the tackifier. In one embodiment, including any of the foregoing, the seam in (a) comprises no more than about 4% w/w of the tackifier. In one embodiment, including any of the foregoing, the seam in (a) comprises no more than about 3% w/w of the tackifier. In one embodiment, including any of the foregoing, the seam in (a) comprises no more than about 2% w/w of the tackifier. In one embodiment, including any of the foregoing, the seam in (a) comprises no more than about 1% w/w of the tackifier. In one embodiment, including any of the foregoing, the seam in (a) comprises no more than about 0.5% w/w of the tackifier.

In one embodiment, including any of the foregoing, the ratio by weight of photo-crosslinked PIB to tackifier in the seam in (a) is about 95:5, about 95.5:4.5, 96:4, 96.5:3.5, 97:3, 97.5:2.5, 98:2, 98.5:1.5, 99:1, and 99.5:0.5.

In one embodiment, including any of the foregoing, the seam in (a) comprises no more than about 2% w/w of the anti-oxidant, no more than about 1.5% w/w of the anti-oxidant, no more than about 1% w/w of the anti-oxidant, no more than about 0.9% w/w of the anti-oxidant, no more than about 0.7% w/w of the anti-oxidant, no more than about 0.5% w/w of the anti-oxidant, or no more than about 0.3% w/w of the anti-oxidant. In one embodiment, including any of the foregoing, the seam in (a) comprises about 1.0% w/w of the anti-oxidant.

In one embodiment, including any of the foregoing, the seam in (a) comprises no more than about 0.5% w/w of the at least one photo initiator, no more than about 0.4% w/w of the at least one photo initiator, no more than about 0.3% w/w of the at least one photo initiator, no more than about 0.2% w/w of the at least one photo initiator, or no more than about 0.1% w/w of the at least one photo initiator. In one embodiment, including any of the foregoing, the seam in (a) comprises no more than about 0.3% w/w of the at least one photo initiator.

In one embodiment, including any of the foregoing, the distance between the edge of the cathode and the outside edge of the seam in (a) is about 2 mm to 10 mm. In one embodiment, including any of the foregoing, the distance between the edge of the cathode and the outside edge of the seam in (a) is about 2 mm to 9 mm. In one embodiment, including any of the foregoing, the distance between the edge of the cathode and the outside edge of the seam in (a) is about 2 mm to 8 mm. In one embodiment, including any of the foregoing, the distance between the edge of the cathode and the outside edge of the seal is about 2 mm to 7 mm. In one embodiment, including any of the foregoing, the distance between the edge of the cathode and the outside edge of the seam in (a) is about 2 mm to 6 mm. In one embodiment, including any of the foregoing, the distance between the edge of the cathode and the outside edge of the seam in (a) is about 2 mm to 5 mm. In one embodiment, including any of the foregoing, the distance between the edge of the cathode and the outside edge of the seam in (a) about 2 mm to 4 mm. In one embodiment, including any of the foregoing, the distance between the edge of the cathode and the outside edge of the seam in (a) is about 2 mm to 3 mm. In one embodiment, including any of the foregoing, the distance between the edge of the cathode and the outside edge of the seam in (a) is about 2 mm to 2.5 mm. In one embodiment, including any of the foregoing, the distance between the edge of the cathode and the outside edge of the seam in (a) is about 2 mm to 2.3 mm. In one embodiment, including any of the foregoing, the distance between the edge of the cathode and the outside edge of the seam in (a) is about 2.3 mm. In one embodiment, including any of the foregoing, the distance between the edge of the cathode and the outside edge of the seam in (a) is about 2.5 mm.

In one embodiment, including any of the foregoing, the seam in (a) has a width in the range of about 0.6 mm and 1.4 mm. In one embodiment, including any of the foregoing, the seam in (a) has a width in the range of about 0.8 mm and 1.2 mm. In one embodiment, including any of the foregoing, the seam in (a) has a width in the range of about 0.8 mm and 1.0 mm. In one embodiment, including any of the foregoing, the seam in (a) is about 1 mm in width.

In one embodiment, including any of the foregoing, the seam in (a) has a height in the range of about 100 μm and 350 μm. In one embodiment, including any of the foregoing, the seam in (a) has a height in the range of about 100 μm and 250 μm. In one embodiment, including any of the foregoing, the seam in (a) has a height in the range of about 100 μm and 200 μm. In one embodiment, including any of the foregoing, the seam in (a) is 150 μm.

In one embodiment, including any of the foregoing, the seam in (a) has a height in the range of about 200 μm and 350 μm. In one embodiment, including any of the foregoing, the seam in (a) has a height in the range of about 220 μm and 320 μm. In one embodiment, including any of the foregoing, the seam in (a) has a height in the range of about 220 μm and 300 μm. In one embodiment, including any of the foregoing, the seam in (a) has a height in the range of about 230 μm and 300 μm. In one embodiment, including any of the foregoing, the seam in (a) has a height in the range of about 240 μm and 280 μm. In one embodiment, including any of the foregoing, the seam in (a) has a height in the range of about 250 μm and 270 μm. In one embodiment, including any of the foregoing, the seam in (a) is about 260 μm.

In one embodiment, including any of the foregoing, the seam in (a) has a width in the range of about 0.8 mm and 1.2 mm and a height in the range of about 100 μm and 200 μm. In one embodiment, including any of the foregoing, the seam in (a) is about 1.0 mm in width and about 150 μm in height.

In one embodiment, including any of the foregoing, the seam in (a) has a width in the range of about 0.8 mm and 1.2 mm and a height in the range of about 100 μm and 200 μm and the distance between the edge of the cathode and the outside edge of the seam is equal to, or less than, 5 mm. In one embodiment, including any of the foregoing, the seam in (a) is about 1.0 mm in width and about 150 μm in height and the distance between the edge of the cathode and the outside edge of the seam is equal to, or less than, 5 mm.

In one embodiment, including any of the foregoing, the seam in (a) has a width in the range of about 0.8 mm and 1.2 mm and a height in the range of about 100 μm and 200 μm and the distance between the edge of the cathode and the outside edge of the seam is about 2 mm to 2.5 mm. In one embodiment, including any of the foregoing, the seam in (a) is about 1.0 mm in width and about 150 μm in height and the distance between the edge of the cathode and the outside edge of the seam is about 2 mm to 2.5 mm.

In one embodiment, including any of the foregoing, the seam in (a) has a width in the range of about 0.8 mm and 1.2 mm and a height in the range of about 220 μm and 300 μm. In one embodiment, including any of the foregoing, the seam in (a) is about 1.0 mm in width and about 260 μm in height.

In one embodiment, including any of the foregoing, the seam in (a) has a width in the range of about 0.8 mm and 1.2 mm and a height in the range of about 220 μm and 300 μm and the distance between the edge of the cathode and the outside edge of the seam is equal to, or less than, 5 mm. In one embodiment, including any of the foregoing, the seam in (a) is about 1.0 mm in width and about 260 μm in height and the distance between the edge of the cathode and the outside edge of the seam is equal to, or less than, 5 mm.

In one embodiment, including any of the foregoing, the seam in (a) has a width in the range of about 0.8 mm and 1.2 mm and a height in the range of about 220 μm and 300 μm and the distance between the edge of the cathode and the outside edge of the seam is about 2 mm to 2.5 mm. In one embodiment, including any of the foregoing, the seam in (a) is about 1.0 mm in width and about 260 μm in height and the distance between the edge of the cathode and the outside edge of the seam is about 2 mm to 2.5 mm.

In one embodiment, including any of the foregoing, the seam in (a) comprises an acryloyl group-terminated monomer, polyisobutylene (PIB) with a molecular weight of about 10,000 g/mol to 100,000 g/mol, and at least one photo initiator; and the distance between the edge of the cathode and the outside edge of the seam in (a) is about 2 mm to 2.5 mm. In one embodiment, including any of the foregoing, the seam in (a) comprises an acryloyl group-terminated monomer, polyisobutylene (PIB) with a molecular weight of about 10,000 g/mol to 40,000 g/mol, and at least one photo initiator; and the distance between the edge of the cathode and the outside edge of the seam in (a) is about 2 mm to 2.5 mm. In one embodiment, including any of the foregoing, the seam in (a) comprises an acryloyl group-terminated monomer, Oppanol® B10, and at least one photo initiator; and the distance between the edge of the cathode and the outside edge of the seam in (a) is about 2 mm to 2.5 mm.

In one embodiment, including any of the foregoing, the seam is dispensed at a speed of about 1 mm/s to 100 mm/s, about 5 mm/s to 80 mm/s, about 10 mm/s to 60 mm/s, about 10 mm/s to 50 mm/s, about 15 mm/s to 40 mm/s, about 20 mm/s to 40 mm/s, or about 25 mm/s to 35 mm/s. In one embodiment, including any of the foregoing, the seam is dispensed at a speed of about 25 mm/s. In one embodiment, including any of the foregoing, the seam is dispensed at a speed of about 30 mm/s. In one embodiment, including any of the foregoing, the seam is dispensed at a speed of about 35 mm/s.

In one embodiment, including any of the foregoing, the seam is dispensed at a temperature of about 50° C. to 150° C., about 50° C. to 130° C., about 70° C. to 130° C., about 70° C. to 110° C., about 80° C. to 110° C., about 80° C. to 100° C., or about 85° C. to 95° C. In one embodiment, including any of the foregoing, the seam is dispensed at a temperature of about 85° C. In one embodiment, including any of the foregoing, the seam is dispensed at a temperature of about 90° C. In one embodiment, including any of the foregoing, the seam is dispensed at a temperature of about 95° C.

In one embodiment, including any of the foregoing, the seam is dispensed at a pressure of about 10 kPa to 300 kPa, about 50 kPa to 300 kPa, about 50 kPa to 250 kPa, about 100 kPa to 250 kPa, about 100 kPa to 200 kPa, about 125 kPa to 200 kPa, about 125 kPa to 175 kPa, about 130 kPa to 170 kPa, about 130 kPa to 160 kPa, about 140 kPa to 160 kPa, about 145 kPa to 160 kPa, or about 145 kPa to 155 kPa. In one embodiment, including any of the foregoing, the seam is dispensed at a pressure of about 145 kPa. In one embodiment, including any of the foregoing, the seam is dispensed at a pressure of about 150 kPa. In one embodiment, including any of the foregoing, the seam is dispensed at a pressure of about 155 kPa.

In one embodiment, including any of the foregoing, the seal exhibits a peel strength between 22N/25 mm and 50N/25 mm following a 180-degree peel at room temperature as measured by the ASTM D3330 test. In one embodiment, including any of the foregoing, the seal exhibits a peel strength between 22N/25 mm and 45N/25 mm following a 180-degree peel at room temperature. In one embodiment, including any of the foregoing, the seal exhibits a peel strength between 22N/25 mm and 40N/25 mm following a 180-degree peel at room temperature. In one embodiment, including any of the foregoing, the seal exhibits a peel strength between 22N/25 mm and 35N/25 mm following a 180-degree peel at room temperature. In one embodiment, including any of the foregoing, the seal exhibits a peel strength between 25N/25 mm and 35N/25 mm following a 180-degree peel at room temperature. In one embodiment, including any of the foregoing, the seal exhibits a peel strength of about 32N/25 mm, 31N/25 mm, 30N/25 mm, 29N/25 mm, 28N/25 mm, 27N/25 mm, or 26N/25 mm following a 180-degree peel at room temperature. In one embodiment, including any of the foregoing, the seal exhibits a peel strength of about 28N/25 mm following a 180-degree peel at room temperature.

In one embodiment, including any of the foregoing, after (c), electrolyte is added to the surface of the film with the inner seam and the outer UV-curable or heat-curable seam and the electrolyte is contained by the inner seal and does not contact the outer seal.

In one embodiment, including any of the foregoing, after (b), electrolyte is added to the surface of the film with the seam.

In another aspect, the present disclosure provides a process of making an electrochemical stack comprising:
a. dispensing at least one inner seam comprising a thermoplastic polymer onto a thin film solid-state electrolyte separator;
b. dispensing an outer UV-curable or heat-curable seam on the solid-state electrolyte separator wherein the seam comprises an acryloyl group-terminated monomer, a (meth)acrylic monomer, and an anti-oxidant;
c. joining together a cathode comprising a catholyte and the solid-state electrolyte separator wherein the at least one inner thermoplastic polymer seam and the outer UV-curable or heat-curable seam are in contact with the cathode and wherein the at least one inner seam forms a seal comprising the thermoplastic polymer with the cathode; and
d. UV-curing, heat-curing, or UV-curing and heat-curing the outer seam to form an outer UV-cured and/or heat-cured seal comprising photo-crosslinked polyisobutylene (PIB) between the cathode and the separator.

In one embodiment, the seam is UV-cured.

In some embodiments, the solid-state electrolyte separator has two major surfaces and four minor surfaces. In some embodiments, the cathode has two major surfaces and four minor surfaces.

In some embodiments, the inner seam in (a), the outer seam in (b), or both, are dispensed within 0.1 mm to 2 mm from a perimeter of the first major surface of the solid-state electrolyte separator. In some embodiments, the inner seam in (a), the outer seam in (b), or both, do not contact the perimeter of the first major surface, the second major surface, or the minor surfaces of the separator.

In some embodiments, the inner seal, the outer seal, or both, do not contact the perimeter of the first major surface, the second major surface, or the minor surfaces of the separator. In some embodiments, the inner seal, the outer seal, or both, do not contact the minor surfaces of the cathode.

In one embodiment, the at least one inner seam in (a) is dispensed via a liquid reservoir. In one embodiment, the at least one inner seam in (a) is a perimeter seam. In one embodiment, the outer seam in (a) is a perimeter seam.

In one embodiment, including any of the foregoing, the inner seam in (a) consists essentially of a thermoplastic polymer.

In one embodiment, including any of the foregoing, the molecular weight of the thermoplastic polymer of the inner seam in (a) is about 300 g/mol to 2400 g/mol.

In one embodiment, including any of the foregoing, the inner seam in (a) comprises polyisobutylene (PIB), polyisoprene, or a mixture thereof. In one embodiment, including any of the foregoing, the inner seam in (a) comprises PIB. In one embodiment, including any of the foregoing, the inner seam in (a) comprises polyisoprene. In one embodiment, including any of the foregoing, the inner seam in (a) comprises a mixture of PIB and polyisoprene. In one embodiment, including any of the foregoing, the inner seam in (a) further comprises a polyolefin, including, but not limited to, polypropylene (PP), polyethylene (PE), polymethylpentene (PMP), and polybutene-1 (PB-1).

In one embodiment, including any of the foregoing, the inner seam in (a) consists essentially of polyisobutylene (PIB), polyisoprene, or a mixture thereof. In one embodiment, including any of the foregoing, the inner seam in (a) consists essentially of PIB. In one embodiment, including any of the foregoing, the inner seam in (a) consists essentially of polyisoprene.

In one embodiment, including any of the foregoing, the at least one inner seam in (a) consists essentially of polyisobutylene (PIB). In one embodiment, including any of the foregoing, the at least one inner seam in (a) comprises a mixture of polyisobutylene (PIB) and polyisoprene. In one embodiment, including any of the foregoing, the at least one inner seal consists essentially of a mixture of polyisobutylene (PIB) and polyisoprene. In one embodiment, including any of the foregoing, the at least one inner seam in (a) further comprises a polyolefin, including, but not limited to, polypropylene (PP), polyethylene (PE), polymethylpentene (PMP), and polybutene-1 (PB-1).

In one embodiment, including any of the foregoing, at least two inner seams are dispensed in (a). In one embodiment, including any of the foregoing, at least three inner seams are dispensed in (a). In one embodiment, including any of the foregoing, one inner seam is dispensed in (a). In one embodiment, including any of the foregoing, two inner seams are dispensed in (a). In one embodiment, including any of the foregoing, three inner seams are dispensed in (a).

In one embodiment, including any of the foregoing, one inner seam comprising polyisobutylene (PIB) is dispensed in (a). In one embodiment, including any of the foregoing, one inner seam comprising polyisobutylene (PIB) and polyisoprene is dispensed in (a). In one embodiment, including any of the foregoing, one inner seam comprising polyisobutylene (PIB) and a polyolefin is dispensed in (a).

In one embodiment, including any of the foregoing, one inner seam comprising polyisobutylene (PIB) and polypropylene (PP) is dispensed in (a). In one embodiment, including any of the foregoing, one inner seam comprising polyisobutylene (PIB) and polyethylene (PE) is dispensed in (a). In one embodiment, including any of the foregoing, one inner seam comprising polyisobutylene (PIB), polypropylene (PP) and polyethylene (PE) is dispensed in (a).

In one embodiment, including any of the foregoing, one inner seam comprising polyisobutylene (PIB), polyisoprene, and a polyolefin is dispensed in (a). In one embodiment, including any of the foregoing, one inner seam comprising polyisobutylene (PIB), polyisoprene, and polypropylene (PP) is dispensed in (a). In one embodiment, including any of the foregoing, one inner seam comprising polyisobutylene (PIB), polyisoprene, and polyethylene (PE) is dispensed in (a). In one embodiment, including any of the foregoing, one inner seam comprising polyisobutylene (PIB), polyisoprene, polypropylene (PP) and polyethylene (PE) is dispensed in (a).

In one embodiment, including any of the foregoing, one inner seam comprising polyisoprene and a polyolefin is dispensed in (a). In one embodiment, including any of the foregoing, one inner seam comprising polyisoprene and polypropylene (PP) is dispensed in (a). In one embodiment, including any of the foregoing, one inner seam comprising polyisoprene and polyethylene (PE) is dispensed in (a). In one embodiment, including any of the foregoing, one inner seam comprising polyisoprene, polypropylene (PP), and polyethylene (PE) is dispensed in (a).

In one embodiment, including any of the foregoing, three inner seams comprising polyisobutylene (PIB) are dispensed in (a). In one embodiment, including any of the foregoing, three inner seams comprising polyisobutylene (PIB) and polyisoprene are dispensed in (a). In one embodiment, including any of the foregoing, three inner seams comprising polyisobutylene (PIB) and a polyolefin are dispensed in (a).

In one embodiment, including any of the foregoing, three inner seams comprising polyisobutylene (PIB) and polypropylene (PP) are dispensed in (a). In one embodiment, including any of the foregoing, three inner seams comprising polyisobutylene (PIB) and polyethylene (PE) are dispensed in (a). In one embodiment, including any of the foregoing, three inner seams comprising polyisobutylene (PIB), polypropylene (PP) and polyethylene (PE) are dispensed in (a).

In one embodiment, including any of the foregoing, three inner seams comprising polyisobutylene (PIB), polyisoprene, and a polyolefin are dispensed in (a). In one embodiment, including any of the foregoing, three inner seams comprising polyisobutylene (PIB), polyisoprene, and polypropylene (PP) are dispensed in (a). In one embodiment, including any of the foregoing, three inner seams comprising polyisobutylene (PIB), polyisoprene, and polyethylene (PE) are dispensed in (a). In one embodiment, including any of the foregoing, three inner seams comprising polyisobutylene (PIB), polyisoprene, polypropylene (PP) and polyethylene (PE) are dispensed in (a).

In one embodiment, including any of the foregoing, three inner seams comprising polyisoprene and a polyolefin are dispensed in (a). In one embodiment, including any of the foregoing, three inner seams comprising polyisoprene and polypropylene (PP) are dispensed in (a). In one embodiment, including any of the foregoing, three inner seams comprising polyisoprene and polyethylene (PE) are dispensed in (a). In one embodiment, including any of the foregoing, three inner seams comprising polyisoprene, polypropylene (PP), and polyethylene (PE) are dispensed in (a).

In one embodiment, including any of the foregoing, the outer seam in (b) is dispensed via a liquid reservoir. In one embodiment, including any of the foregoing, the outer seam in (b) is a perimeter seam. In one embodiment, including any of the foregoing, the outer seam in (b) is UV-curable. In one embodiment, including any of the foregoing, the outer seam in (b) is heat-curable.

In one embodiment, including any of the foregoing, the acryloyl group-terminated monomer is a mixture of monomers having a structure of Formula (I):

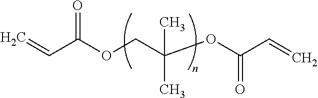

wherein n is an integer from 1 to 100.

In one embodiment, including any of the foregoing, the acryloyl group-terminated monomer having a structure of Formula (I):

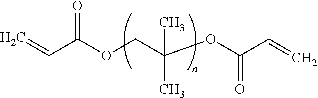

wherein n is an integer from 5 to 50.

In one embodiment, including any of the foregoing, the (meth)acrylic monomer is of Formula (II):

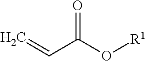

wherein R¹ is C₁₋₃₀alkyl or C₃₋₁₀cycloalkyl.

In one embodiment of Formula (I), including any of the foregoing, n is an integer from 5 to 10. In one embodiment of Formula (I), including any of the foregoing, n is an integer from 10 to 15. In one embodiment of Formula (I), including any of the foregoing, n is an integer from 15 to 20. In one embodiment of Formula (I), including any of the foregoing, n is an integer from 20 to 25. In one embodiment of Formula (I), including any of the foregoing, n is an integer from 25 to 30. In one embodiment of Formula (I), including any of the foregoing, n is an integer from 30 to 35. In one embodiment of Formula (I), including any of the foregoing, n is an integer from 35 to 40. In one embodiment of Formula (I), including any of the foregoing, n is an integer from 40 to 45. In one embodiment of Formula (I), including any of the foregoing, n is an integer from 45 to 50.

In one embodiment of Formula (I), including any of the foregoing, n is a mixture of integers from 5 to 10. In one embodiment of Formula (I), including any of the foregoing, n is a mixture of integers from 10 to 15. In one embodiment of Formula (I), including any of the foregoing, n is a mixture of integers from 15 to 20. In one embodiment of Formula (I), including any of the foregoing, n is a mixture of integers from 20 to 25. In one embodiment of Formula (I), including any of the foregoing, n is a mixture of integers from 25 to 30. In one embodiment of Formula (I), including any of the foregoing, n is a mixture of integers from 30 to 35. In one embodiment of Formula (I), including any of the foregoing, n is a mixture of integers from 35 to 40. In one embodiment of Formula (I), including any of the foregoing, n is a mixture of integers from 40 to 45. In one embodiment of Formula (I), including any of the foregoing, n is a mixture of integers from 45 to 50. In one embodiment of Formula (I), including any of the foregoing, n is a mixture of integers from 50 to 60. In one embodiment of Formula (I), including any of the foregoing, n is a mixture of integers from 60 to 70. In one embodiment of Formula (I), including any of the foregoing, n is a mixture of integers from 70 to 80. In one embodiment of Formula (I), including any of the foregoing, n is a mixture of integers from 80 to 90. In one embodiment of Formula (I), including any of the foregoing, n is a mixture of integers from 90 to 100.

In one embodiment of Formula (I), including any of the foregoing, n is a mixture of integers from 1 to 40. In one embodiment of Formula (I), including any of the foregoing, n is a mixture of integers from 1 to 60. In one embodiment of Formula (I), including any of the foregoing, n is a mixture of integers 10 to 70. In one embodiment of Formula (I), including any of the foregoing, n is a mixture of integers from 20 to 80. In one embodiment of Formula (I), including any of the foregoing, n is a mixture of integers from 30 to 70. In one embodiment of Formula (I), including any of the foregoing, n is a mixture of integers from 40 to 90. In one embodiment of Formula (I), including any of the foregoing, n is a mixture of integers from 50 to 100.

In one embodiment of Formula (II), including any of the foregoing, R¹ is a straight C₁₋₃₀alkyl chain. In one embodiment of Formula (II), including any of the foregoing, R¹ is a branched C₁₋₃₀alkyl chain.

In some embodiments, including any of the foregoing, the outer seam in (b) further comprises at least one photo initiator.

In one embodiment, including any of the foregoing, the outer seam in (b) comprises a monomer having a structure of Formula (I), lauryl acrylate, an anti-oxidant, and at least one photo initiator. In one embodiment, including any of the foregoing, the outer seam in (b) comprises a monomer having a structure of Formula (I), lauryl acrylate, an anti-oxidant, and two photo initiators. In one embodiment, including any of the foregoing, the outer seam in (b) comprises a monomer having a structure of Formula (I), lauryl acrylate, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide.

In one embodiment, including any of the foregoing, the outer seam in (b) comprises at least about 85% w/w acryloyl group-terminated monomer, at least about 88% w/w acryloyl group-terminated monomer, at least about 89% w/w acryloyl group-terminated monomer, at least about 90% w/w acryloyl group-terminated monomer, or at least about 95% w/w acryloyl group-terminated monomer. In one embodiment, including any of the foregoing, the outer seam in (b) comprises about 90% w/w acryloyl group-terminated monomer.

In one embodiment, including any of the foregoing, the outer seam in (b) comprises no more than about 5% w/w (meth)acrylic monomer, no more than about 6% w/w (meth)acrylic monomer, no more than about 7% w/w (meth)acrylic monomer, no more than about 8% w/w (meth)acrylic monomer, no more than about 9% w/w (meth)acrylic monomer, or no more than about 10% w/w (meth)acrylic monomer. In one embodiment, including any of the foregoing, the outer seam in (b) comprises about 9% w/w (meth)acrylic monomer.

In one embodiment, including any of the foregoing, the ratio by weight of the acryloyl group-terminated monomer and the (meth)acrylic monomer is about 85:9, about 87:9, about 88:9, about 89:9, about 89.5:9, about 90:9, or about 95:9. In one embodiment, including any of the foregoing, the ratio by weight of the acryloyl group-terminated monomer and the (meth)acrylic monomer is about 85:9 to 95:9. In one embodiment, including any of the foregoing, the ratio by weight of the acryloyl group-terminated monomer and the (meth)acrylic monomer is about 88:9 to 90:9. In one embodiment, including any of the foregoing, the ratio by weight of the acryloyl group-terminated monomer and the (meth)acrylic monomer is about 89.5:9 to 90:9. In one embodiment, including any of the foregoing, the ratio by weight of the acryloyl group-terminated monomer and the (meth)acrylic monomer is about 89.8:9 to 90:9. In one embodiment, including any of the foregoing, the ratio by weight of the acryloyl group-terminated monomer and the (meth)acrylic monomer is about 89.8:9.

In one embodiment, including any of the foregoing, the outer seam in (b) comprises no more than about 2% w/w of the anti-oxidant, no more than about 1.5% w/w of the anti-oxidant, no more than about 1% w/w of the anti-oxidant, no more than about 0.9% w/w of the anti-oxidant, no more than about 0.7% w/w of the anti-oxidant, no more than about 0.5% w/w of the anti-oxidant, or no more than about 0.3% w/w of the anti-oxidant. In one embodiment, including any of the foregoing, the outer seam in (b) comprises about 0.9% w/w of the anti-oxidant.

In one embodiment, including any of the foregoing, the outer seam in (b) comprises no more than about 0.5% w/w of the at least one photo initiator, no more than about 0.4% w/w of the at least one photo initiator, no more than about 0.3% w/w of the at least one photo initiator, no more than about 0.2% w/w of the at least one photo initiator, or no more than about 0.1% w/w of the at least one photo initiator. In one embodiment, including any of the foregoing, the outer seam in (b) comprises no more than about 0.3% w/w of the at least one photo initiator.

In one embodiment, including any of the foregoing, the outer seam in (b) comprises epoxy. In one embodiment, including any of the foregoing, the outer seam in (b) comprises polyurethane.

In one embodiment, including any of the foregoing, the at least one inner seam in (a) is a perimeter seam and the outer seam in (b) is a perimeter seam. In one embodiment, including any of the foregoing, the at least one inner seam in (a) and the outer seam in (b) are dispensed via liquid reservoirs.

In one embodiment, including any of the foregoing, one inner seam is dispensed in (a). In one embodiment, including any of the foregoing, three inner seams are dispensed in (a).

In one embodiment, including any of the foregoing, the at least one inner seam in (a) comprises polyisobutylene (PIB) and the outer seam in (b) is UV-curable. In one embodiment, including any of the foregoing, the at least one inner seam in (a) comprises polyisobutylene (PIB) and the outer seam in (b) is heat-curable.

In one embodiment, including any of the foregoing, the at least one inner seam in (a) consists essentially of polyisobutylene (PIB) and the outer seam in (b) is UV-curable. In one embodiment, including any of the foregoing, the at least one inner seam in (a) consists essentially of polyisobutylene (PIB) and the outer seam in (b) is heat-curable.

In one embodiment, including any of the foregoing, the at least one inner seam in (a) comprises a mixture of polyisobutylene (PIB) and polyisoprene and the outer seam in (b) is UV-curable. In one embodiment, including any of the foregoing, the at least one inner seam in (a) comprises a mixture of polyisobutylene (PIB) and polyisoprene and the outer seam in (b) is heat-curable.

In one embodiment, including any of the foregoing, the at least one inner seam in (a) consists essentially of polyisobutylene (PIB) and the outer seam in (b) comprises a monomer having a structure of Formula (I), (meth)acrylic monomer of Formula (II), an anti-oxidant, and at least one photo initiator. In one embodiment, including any of the foregoing, the at least one inner seam in (a) consists essentially of polyisobutylene (PIB) and the outer seam in (b) comprises a monomer having a structure of Formula (I), lauryl acrylate, an anti-oxidant, and at least one photo initiator. In one embodiment, including any of the foregoing, the at least one inner seam in (a) consists essentially of polyisobutylene (PIB) and the outer seam in (b) comprises a monomer having a structure of Formula (I), lauryl acrylate, an anti-oxidant, and two photo initiators. In one embodiment, including any of the foregoing, the at least one inner seam in (a) consists essentially of polyisobutylene (PIB) and the outer seam in (b) comprises a monomer having a structure of Formula (I), lauryl acrylate, an anti-oxidant, and one photo initiator. In one embodiment, including any of the foregoing, the at least one inner seam in (a) consists essentially of polyisobutylene (PIB) and the outer seam in (b) comprises a monomer having a structure of Formula (II), lauryl acrylate, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide.

In one embodiment, including any of the foregoing, the at least one inner seam in (a) comprises a mixture of polyisobutylene (PIB) and polyisoprene and the outer seam in (b) comprises a monomer having a structure of Formula (I), (meth)acrylic monomer of Formula (II), an anti-oxidant, and at least one photo initiator. In one embodiment, including any of the foregoing, the at least one inner seam in (a) comprises a mixture of polyisobutylene (PIB) and polyisoprene and the outer seam in (b) comprises a monomer having a structure of Formula (I), lauryl acrylate, an anti-oxidant, and at least one photo initiator. In one embodiment, including any of the foregoing, the at least one inner seam in (a) comprises a mixture of polyisobutylene (PIB) and polyisoprene and the outer seam in (b) comprises a monomer having a structure of Formula (I), lauryl acrylate, an anti-oxidant, and two photo initiators. In one embodiment, including any of the foregoing, the at least one inner seam in (a) comprises a mixture of polyisobutylene (PIB) and polyisoprene and the outer seam in (b) comprises a monomer having a structure of Formula (I), lauryl acrylate, an anti-oxidant, and one photo initiator. In one embodiment, including any of the foregoing, the at least one inner seam in (a) comprises a mixture of polyisobutylene (PIB) and polyisoprene and the outer seam in (b) comprises acryloyl a monomer having a structure of Formula (I), lauryl acrylate, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide.

In one embodiment, including any of the foregoing, one inner seam consisting essentially of polyisobutylene (PIB) is dispensed in (a) and an outer seam comprising a monomer having a structure of Formula (I), (meth)acrylic monomer of Formula (II), an anti-oxidant, and at least one photo initiator is dispensed in (b). In one embodiment, including any of the foregoing, one inner seam consisting essentially of polyisobutylene (PIB) is dispensed in (a) and an outer seam comprising a monomer having a structure of Formula (I), lauryl acrylate, an anti-oxidant, and two photo initiators is dispensed in (b). In one embodiment, including any of the foregoing, one inner seam consisting essentially of polyisobutylene (PIB) is dispensed in (a) and an outer seam comprising a monomer having a structure of Formula (I), lauryl acrylate, an anti-oxidant, and one photo initiator is dispensed in (b). In one embodiment, including any of the foregoing, one inner seam consisting essentially of polyisobutylene (PIB) is dispensed in (a) and an outer seam comprising a monomer having a structure of Formula (II), lauryl acrylate, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide is dispensed in (b).

In one embodiment, including any of the foregoing, one inner seam comprising a mixture of polyisobutylene (PIB) and polyisoprene is dispensed in (a) and an outer seam comprising a monomer having a structure of Formula (I), (meth)acrylic monomer of Formula (III), an anti-oxidant, and at least one photo initiator is dispensed in (b). In one embodiment, including any of the foregoing, one inner seam comprising a mixture of polyisobutylene (PIB) and polyisoprene is dispensed in (a) and an outer seam comprising a monomer having a structure of Formula (I), lauryl acrylate, an anti-oxidant, and two photo initiators is dispensed in (b). In one embodiment, including any of the foregoing, one inner seam comprising a mixture of polyisobutylene (PIB) and polyisoprene is dispensed in (a) and an outer seam comprising a monomer having a structure of Formula (I), lauryl acrylate, an anti-oxidant, and one photo initiator is dispensed in (b). In one embodiment, including any of the foregoing, one inner seam comprising a mixture of polyisobutylene (PIB) and polyisoprene is dispensed in (a) and an outer seam comprising a monomer having a structure of Formula (I), lauryl acrylate, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide is dispensed in (b).

In one embodiment, including any of the foregoing, three inner seams each consisting essentially of polyisobutylene (PIB) are dispensed in (a) and an outer seam comprising a monomer having a structure of Formula (I), (meth)acrylic monomer of Formula (III), an anti-oxidant, and at least one photo initiator is dispensed in (b). In one embodiment, including any of the foregoing, three inner seams each consisting essentially of polyisobutylene (PIB) are dispensed in (a) and an outer seam comprising a monomer having a structure of Formula (I), lauryl acrylate, an anti-oxidant, and two photo initiators is dispensed in (b). In one embodiment, including any of the foregoing, three inner seams each consisting essentially of polyisobutylene (PIB) are dispensed in (a) and an outer seam comprising a monomer having a structure of Formula (I), lauryl acrylate, an anti-oxidant, and at least one photo initiator is dispensed in (b). In one embodiment, including any of the foregoing, three inner seams each consisting essentially of polyisobutylene (PIB) are dispensed in (a) and an outer seam comprising a monomer having a structure of Formula (I), lauryl acrylate, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide is dispensed in (b).

In one embodiment, including any of the foregoing, three inner seams comprising a mixture of polyisobutylene (PIB) and polyisoprene are dispensed in (a) and an outer seam comprising a monomer having a structure of Formula (I), (meth)acrylic monomer of Formula (II), an anti-oxidant, and at least one photo initiator is dispensed in (b). In one embodiment, including any of the foregoing, three inner seams comprising a mixture of polyisobutylene (PIB) and polyisoprene are dispensed in (a) and an outer seam comprising a monomer having a structure of Formula (I), lauryl acrylate, an anti-oxidant, and two photo initiators is dispensed in (b). In one embodiment, including any of the foregoing, three inner seams comprising a mixture of polyisobutylene (PIB) and polyisoprene are dispensed in (a) and an outer seam comprising a monomer having a structure of Formula (I), lauryl acrylate, an anti-oxidant, and at least one photo initiator is dispensed in (b). In one embodiment, including any of the foregoing, three inner seams comprising a mixture of polyisobutylene (PIB) and polyisoprene are dispensed in (a) and an outer seam comprising PIB, lauryl acrylate, octadecyl 3-(3,5-di-tert-butyl-4-hydroxyphenyl)propionate, 2-hydroxy-2-methylpropiophenone, and phenylbis(2,4,6-trimethylbenzoyl)phosphine oxide is dispensed in (b).

In one embodiment, including any of the foregoing, the distance between the edge of the cathode and the outside edge of the outer seam in (b) is about 2 mm to 10 mm. The outside edge of outer seal refers to the edge that is furthest from the edge of the cathode. In one embodiment, including any of the foregoing, the distance between the edge of the cathode and the outside edge of the outer seam in (b) is about 2 mm to 9 mm. In one embodiment, including any of the foregoing, the distance between the edge of the cathode and the outside edge of the outer seam in (b) is about 2 mm to 8 mm. In one embodiment, including any of the foregoing, the distance between the edge of the cathode and the outside edge of the outer seam in (b) is about 2 mm to 7 mm. In one embodiment, including any of the foregoing, the distance between the edge of the cathode and the outside edge of the outer seam in (b) is about 2 mm to 6 mm. In one embodiment, including any of the foregoing, the distance between the edge of the cathode and the outside edge of the outer seam in (b) is about 2 mm to 5 mm. In one embodiment, including any of the foregoing, the distance between the edge of the cathode and the outside edge of the outer seam in (b) about 2 mm to 4 mm. In one embodiment, including any of the foregoing, the distance between the edge of the cathode and the outside edge of the outer seam in (b) is about 2 mm to 3 mm. In one embodiment, including any of the foregoing, the distance between the edge of the cathode and the outside edge of the outer seam in (b) is about 2 mm to 2.5 mm. In one embodiment, including any of the foregoing, the distance between the edge of the cathode and the outside edge of the outer seam in (b) is about 2 mm to 2.3 mm. In one embodiment, including any of the foregoing, the distance between the edge of the cathode and the outside edge of the outer seam in (b) is about 2.3 mm. In one embodiment, including any of the foregoing, the distance between the edge of the cathode and the outside edge of the outer seam in (b) is about 2.5 mm.

In one embodiment, including any of the foregoing, the distance between the outside edge of the inner seam of (a) and the inside edge of the outer seam of (b) is about 0.1 mm to 0.3 mm. The outside edge of inner seal refers to the edge that is furthest from the edge of the cathode. The inside edge of outer seal refers to the edge that is closest to the edge of the cathode. In one embodiment, including any of the foregoing, the distance between the outside edge of the inner seam of (a) and the inside edge of the outer seam of (b) is about 0.1 mm. In one embodiment, including any of the foregoing, the distance between the outside edge of the inner seam of (a) and the inside edge of the outer seam of (b) is about 0.2 mm. In one embodiment, including any of the foregoing, the distance between the outside edge of the inner seam of (a) and the inside edge of the outer seam of (b) is about 0.3 mm.

In one embodiment, including any of the foregoing, the distance between the inside edge of the inner seam of (a) and the edge of the cathode is about 1 mm to 0.2 mm. The inside edge of inner seal refers to the edge that is closest to the edge of the cathode. In one embodiment, including any of the foregoing, the distance between the inside edge of the inner seam of (a) and the edge of the cathode is about 0.9 mm to 0.1 mm. In one embodiment, including any of the foregoing, the distance between the inside edge of the inner seam of (a) and the edge of the cathode is about 0.8 mm to 0.3 mm. In one embodiment, including any of the foregoing, the distance between the inside edge of the inner seam of (a) and the edge of the cathode is about 0.75 mm to 0.35 mm. In one embodiment, including any of the foregoing, the distance between the inside edge of the inner seam of (a) and the edge of the cathode is about 0.7 mm to 0.4 mm. In one embodiment, including any of the foregoing, the distance between the inside edge of the inner seam of (a) and the edge of the cathode is about 0.8 mm to 0.5 mm. In one embodiment, including any of the foregoing, the distance between the inside edge of the inner seam of (a) and the edge of the cathode is about 0.8 mm to 0.4 mm. In one embodiment, including any of the foregoing, the distance between the inside edge of the inner seam of (a) and the edge of the cathode is about 0.75 mm.

In one embodiment, including any of the foregoing, the distance between the outside edge of the inner seam of (a) and the inside edge of the outer seam of (b) is about 0.1 mm to 0.3 mm and the distance between the inside edge of the inner seam of (a) and the edge of the cathode is about 0.8 mm to 0.3 mm. In one embodiment, including any of the foregoing, the distance between the inside edge of the inner seam of (a) and the outside edge of the outer seam of (b) is about 0.1 mm to 0.3 mm and the distance between the inside edge of the inner seam of (a) and the edge of the cathode is about 0.75 mm to 0.35 mm. In one embodiment, including any of the foregoing, the distance between the inside edge of the inner seam of (a) and the outside edge of the outer seam of (b) is about 0.1 mm to 0.3 mm and the distance between the inside edge of the inner seam of (a) and the edge of the cathode is about 0.8 mm to 0.5 mm. In one embodiment, including any of the foregoing, the distance between the inside edge of the inner seam of (a) and the outside edge of the outer seam of (b) is about 0.3 mm and the distance between the inside edge of the inner seam of (a) and the edge of the cathode is about 0.75 mm.

In one embodiment, including any of the foregoing, the at least one inner seam in (a) and the outer seam in (c) each independently have a width in the range of about 0.6 mm and 1.4 mm. In one embodiment, including any of the foregoing, the at least one inner seam in (a) and the outer seam in (c) each independently have a width in the range of about 0.8 mm and 1.2 mm. In one embodiment, including any of the foregoing, the at least one inner seam in (a) and the outer seam in (b) each independently have a width in the range of about 0.8 mm and 1.0 mm. In one embodiment, including any of the foregoing, the at least one inner seam in (a) and the outer seam in (b) are each about 1 mm in width.

In one embodiment, including any of the foregoing, the at least one inner seam in (a) and the outer seam in (b) each independently have a width in the range of about 0.6 mm and 1.4 mm. In one embodiment, including any of the foregoing, the at least one inner seam in (a) and the outer seam in (b) each independently have a width in the range of about 0.8 mm and 1.2 mm. In one embodiment, including any of the foregoing, the at least one inner seam in (a) and the outer seam in (b) each independently have a width in the range of about 0.8 mm and 1.0 mm. In one embodiment, including any of the foregoing, the at least one inner seam in (a) and the outer seam in (b) are each about 1 mm in width.

In one embodiment, including any of the foregoing, the inner seam in (a) is one inner seam and the one inner seam and the outer seam in (b) each independently have a width in the range of about 0.6 mm and 1.4 mm. In one embodiment, including any of the foregoing, the inner seam in (a) is one inner seam and the one inner seam and the outer seam in (b) each independently have a width in the range of about 0.8 mm and 1.2 mm. In one embodiment, including any of the foregoing, the inner seam in (a) is one inner seam and the one inner seam and the outer seam in (b) each independently have a width in the range of about 0.8 mm and 1.0 mm. In one embodiment, including any of the foregoing, the inner seam in (a) is one inner seam and the one inner seam and the outer seam in (b) are each about 1 mm in width.

In one embodiment, including any of the foregoing, the inner seam in (a) is three inner seams and each inner seam and the outer seam in (b) independently have a width in the range of about 0.6 mm and 1.4 mm. In one embodiment, including any of the foregoing, the inner seam in (a) is three inner seams and each inner seam and the outer seam in (b) independently have a width in the range of about 0.8 mm and 1.2 mm. In one embodiment, including any of the foregoing, the inner seam in (a) is three inner seams and each inner seam and the outer seam in (b) independently have a width in the range of about 0.8 mm and 1.0 mm. In one embodiment, including any of the foregoing, the inner seam in (a) is three inner seams and each inner seam and the outer seam in (b) are about 1 mm in width.

In one embodiment, including any of the foregoing, the inner seam in (a) and the outer seam in (b) each independently have a height in the range of about 100 μm and 350 μm. In one embodiment, including any of the foregoing, the inner seam in (a) and the outer seam in (b) each independently have a height in the range of about 100 μm and 250 μm. In one embodiment, including any of the foregoing, the inner seam in (a) and the outer seam in (b) each independently have a height in the range of about 100 μm and 200 μm. In one embodiment, including any of the foregoing, the inner seam in (a) and the outer seam in (b) are each about 150 μm.

In one embodiment, including any of the foregoing, the inner seam in (a) and the outer seam in (b) each independently have a height in the range of about 200 μm and 350 μm. In one embodiment, including any of the foregoing, the inner seam in (a) and the outer seam in (b) each independently have a height in the range of about 220 μm and 320 μm. In one embodiment, including any of the foregoing, the inner seam in (a) and the outer seam in (b) each independently have a height in the range of about 220 μm and 300 μm. In one embodiment, including any of the foregoing, the inner seam in (a) and the outer seam in (b) each independently have a height in the range of about 230 μm and 300 μm. In one embodiment, including any of the foregoing, the inner seam in (a) and the outer seam in (b) each independently have a height in the range of about 240 μm and 280 μm. In one embodiment, including any of the foregoing, the inner seam in (a) and the outer seam in (b) each independently have a height in the range of about 250 μm and 270 μm. In one embodiment, including any of the foregoing, the inner seam in (a) and the outer seam in (b) are each about 260 μm.

In one embodiment, including any of the foregoing, the inner seam in (a) and the outer seam in (b) each independently have a width in the range of about 0.8 mm and 1.2 mm and independently a height in the range of about 100 μm and 200 μm. In one embodiment, including any of the foregoing, the inner seam in (a) and the outer seam in (b) are each about 1.0 mm in width and about 150 μm in height.

In one embodiment, including any of the foregoing, the inner seam in (a) and the outer seam in (b) each independently have a width in the range of about 0.8 mm and 1.2 mm and independently a height in the range of about 100 μm and 200 μm and the distance between the edge of the cathode and the outside edge of the outer seam in (b) is equal to, or less than, 5 mm. In one embodiment, including any of the foregoing, the inner seam in (a) and the outer seam in (b) are each about 1.0 mm in width and about 150 μm in height and the distance between the edge of the cathode and the outside edge of the outer seam in (b) is equal to, or less than, 5 mm.

In one embodiment, including any of the foregoing, the inner seam in (a) and the outer seam in (b) each independently have a width in the range of about 0.8 mm and 1.2 mm and independently a height in the range of about 100 μm and 200 μm and the distance between the edge of the cathode and the outside edge of the outer seam in (b) is about 2 mm to 2.5 mm. In one embodiment, including any of the foregoing, the inner seam in (a) and the outer seam in (b) are each about 1.0 mm in width and about 150 μm in height and the distance between the edge of the cathode and the outside edge of the outer seam in (b) is about 2 mm to 2.5 mm.

In one embodiment, including any of the foregoing, the inner seam in (a) and the outer seam in (b) each independently have a width in the range of about 0.8 mm and 1.2 mm and independently a height in the range of about 220 μm and 300 μm. In one embodiment, including any of the foregoing, the inner seam in (a) and the outer seam in (b) are each about 1.0 mm in width and about 260 μm in height.

In one embodiment, including any of the foregoing, the inner seam in (a) and the outer seam in (b) each independently have a width in the range of about 0.8 mm and 1.2 mm and independently a height in the range of about 220 μm and 300 μm and the distance between the edge of the cathode and the outside edge of the outer seam in (b) is equal to, or less than, 5 mm. In one embodiment, including any of the foregoing, the inner seam in (a) and the outer seam in (b) are each about 1.0 mm in width and about 260 μm in height and the distance between the edge of the cathode and the outside edge of the outer seam in (b) is equal to, or less than, 5 mm.

In one embodiment, including any of the foregoing, the inner seam in (a) and the outer seam in (b) each independently have a width in the range of about 0.8 mm and 1.2 mm and independently a height in the range of about 220 μm and 300 μm and the distance between the edge of the cathode and the outside edge of the outer seam in (b) is about 2 mm to 2.5 mm. In one embodiment, including any of the foregoing, the inner seam in (a) and the outer seam in (b) are each about 1.0 mm in width and about 260 μm in height and the distance between the edge of the cathode and the outside edge of the outer seam in (b) is about 2 mm to 2.5 mm.

In one embodiment, including any of the foregoing, the inner seam in (a) comprises a mixture of polyisobutylene (PIB) and polyisoprene; the outer seam in (b) comprises a monomer having a structure of Formula (I), lauryl acrylate, and at least one photo initiator; and the distance between the edge of the cathode and the outside edge of the outer seam in (b) is about 2 mm to 2.5 mm. In one embodiment, including any of the foregoing, the inner seam in (a) consists essentially of polyisobutylene (PIB); the outer seam in (b) comprises a monomer having a structure of Formula (I), lauryl acrylate, and at least one photo initiator; and the distance between the edge of the cathode and the outside edge of the outer seam in (b) is about 2 mm to 2.5 mm.

In one embodiment, including any of the foregoing, the inner seam in (a) is one inner seam comprising a mixture of polyisobutylene (PIB) and polyisoprene; the outer seam in (b) comprises a monomer having a structure of Formula (I), lauryl acrylate, and at least one photo initiator; and the distance between the edge of the cathode and the outside edge of the outer seam in (b) is about 2 mm to 2.5 mm. In one embodiment, including any of the foregoing, the inner seam in (a) is three inner seams and each comprises a mixture of polyisobutylene (PIB) and polyisoprene; the outer seam in (b) comprises a monomer having a structure of Formula (I), lauryl acrylate, and at least one photo initiator; and the distance between the edge of the cathode and the outside edge of the outer seam in (b) is about 2 mm to 2.5 mm.

In one embodiment, including any of the foregoing, the inner seam in (a) is one seam consisting essentially of polyisobutylene (PIB); the outer seam in (b) comprises a monomer having a structure of Formula (I), (meth)acrylic monomer of Formula (II), an anti-oxidant, and at least one photo initiator; and the distance between the edge of the cathode and the outside edge of the outer seam in (b) is about 2 mm to 2.5 mm. In one embodiment, including any of the foregoing, the inner seam in (a) is three inner seams and each consists essentially of polyisobutylene (PIB); the outer seam in (b) comprises a monomer having a structure of Formula (I), (meth)acrylic monomer of Formula (II), an anti-oxidant, and at least one photo initiator; and the distance between the edge of the cathode and the outside edge of the outer seam in (b) is about 2 mm to 2.5 mm.

In one embodiment, including any of the foregoing, the inner seam in (a) is one seam consisting essentially of polyisobutylene (PIB); the outer seam in (b) comprises a monomer having a structure of Formula (I), lauryl acrylate, an anti-oxidant, and at least one photo initiator; and the distance between the edge of the cathode and the outside edge of the outer seam in (b) is about 2 mm to 2.5 mm. In one embodiment, including any of the foregoing, the inner seam in (a) is three inner seams and each consists essentially of polyisobutylene (PIB); the outer seam in (b) comprises a monomer having a structure of Formula (II), lauryl acrylate, an anti-oxidant, and at least one photo initiator; and the distance between the edge of the cathode and the outside edge of the outer seam in (b) is about 2 mm to 2.5 mm.

In one embodiment, including any of the foregoing, the inner seam and the outer seam are each independently dispensed at a speed of about 1 mm/s to 100 mm/s, about 5 mm/s to 80 mm/s, about 10 mm/s to 60 mm/s, about 10 mm/s to 50 mm/s, about 15 mm/s to 40 mm/s, about 20 mm/s to 40 mm/s, or about 25 mm/s to 35 mm/s. In one embodiment, including any of the foregoing, the inner seam and the outer seam are each independently dispensed at a speed of about 25 mm/s. In one embodiment, including any of the foregoing, the inner seam and the outer seam are each independently dispensed at a speed of about 30 mm/s. In one embodiment, including any of the foregoing, the inner seam and the outer seam are each independently dispensed at a speed of about 35 mm/s.

In one embodiment, including any of the foregoing, the inner seam and the outer seam are each independently dispensed at a temperature of about 50° C. to 150° C., about 50° C. to 130° C., about 70° C. to 130° C., about 70° C. to 110° C., about 80° C. to 110° C., about 80° C. to 100° C., or about 85° C. to 95° C. In one embodiment, including any of the foregoing, the inner seam and the outer seam are each independently dispensed at a temperature of about 85° C. In one embodiment, including any of the foregoing, the inner seam and the outer seam are each independently dispensed at a temperature of about 90° C. In one embodiment, including any of the foregoing, the inner seam and the outer seam are each independently dispensed at a temperature of about 95° C.

In one embodiment, including any of the foregoing, the inner seam and the outer seam are each independently dispensed at a pressure of about 10 kPa to 300 kPa, about 50 kPa to 300 kPa, about 50 kPa to 250 kPa, about 100 kPa to 250 kPa, about 100 kPa to 200 kPa, about 125 kPa to 200 kPa, about 125 kPa to 175 kPa, about 130 kPa to 170 kPa, about 130 kPa to 160 kPa, about 140 kPa to 160 kPa, about 145 kPa to 160 kPa, or about 145 kPa to 155 kPa. In one embodiment, including any of the foregoing, the inner seam and the outer seam are each independently dispensed at a pressure of about 145 kPa. In one embodiment, including any of the foregoing, the inner seam and the outer seam are each independently dispensed at a pressure of about 150 kPa. In one embodiment, including any of the foregoing, the inner seam and the outer seam are each independently dispensed at a pressure of about 155 kPa.

In some embodiments, including any of the foregoing, the electrolyte or catholyte is selected from the group consisting of ethylene sulfite (ES), ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), γ-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy) propane (F-EPE), fluorinated cyclic carbonate (F-AEC), dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, methylene methanedisulfonate, dimethyl sulfate, dimethyl sulfoxide (DMSO), ethyl acetate, methyl butyrate, dimethyl ether (DME), diethyl ether, dioxolane, gamma butyl-lactone, methyl benzoate, 2-methyl-5-oxooxolane-2-carbonitrile, and combinations thereof. In some examples, the combinations of electrolytes are those combinations which are miscible.

In some embodiments, including any of the foregoing, the electrolyte or catholyte is selected from the group consisting of ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), Y-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy) propane (F-EPE), and fluorinated cyclic carbonate (F-AEC).

In some embodiments, including any of the foregoing, the electrolyte or catholyte is selected from the group consisting of dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, and methylene methanedisulfonate.

In some embodiments, including any of the foregoing, the electrolyte or catholyte is selected from the group consisting of dimethyl sulfate, dimethyl sulfoxide (DMSO), ethyl acetate, methyl butyrate, dimethyl ether (DME), diethyl ether, dioxolane, gamma butyl-lactone, methyl benzoate, and 2-methyl-5-oxooxolane-2-carbonitrile.

In some embodiments, including any of the foregoing, the electrolyte or catholyte comprises ethylene sulfite (ES). In some embodiments, including any of the foregoing, the electrolyte comprises sulfolane. In some embodiments, including any of the foregoing, the electrolyte comprises ethylene sulfite (ES) and sulfolane. In some embodiments, including any of the foregoing, the ethylene sulfite (ES) to sulfolane is about 7:3 by volume (v/v) to about 5:5 by volume (v/v). In some embodiments, including any of the foregoing, the ethylene sulfite (ES) to sulfolane is about 9:3 by volume, about 8:3 by volume, about 7:3 by volume, about 6:3 by volume, or about 5:3 by volume. In some embodiments, including any of the foregoing, the ethylene sulfite (ES) to sulfolane is about 7:3 by volume. In some embodiments, including any of the foregoing, the ethylene sulfite (ES) to sulfolane is about 7:3 by volume. In some embodiments, including any of the foregoing, the ethylene sulfite (ES) to sulfolane is about 5:5 by volume.

In some embodiments, including any of the foregoing, the electrolyte or catholyte further comprises a lithium salt. In some embodiments, including any of the foregoing, the concentration of the lithium salt is about 0.5 molar (M) to 5 (M). In some embodiments, including any of the foregoing, the concentration of the lithium salt is less than about 2 M. In some embodiments, including any of the foregoing, the electrolyte comprises ethylene sulfite (ES) and sulfolane and a lithium salt wherein the concentration of the lithium salt is about 0.5 M to 5 M. In some embodiments, including any of the foregoing, the electrolyte comprises ethylene sulfite (ES) and sulfolane and a lithium salt wherein the concentration of the lithium salt is less than about 2 M.

In some embodiments, including any of the foregoing, the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiI, LiBr, LiCl, and combinations thereof. In some embodiments, including any of the foregoing, the lithium salt is selected from LiPF₆ or LiBF₄. In some embodiments, including any of the foregoing, the lithium salt is LiBF₄. In some embodiments, including any of the foregoing, the lithium salt is selected from 1.4M LiPF₆; 1.4M LiBF₄; and 1.6M LiBF₄. In some embodiments, including any of the foregoing, the lithium salt is selected from 1.4M LiBF₄ and 1.6M LiBF₄.

In one embodiment, including any of the foregoing, the inner seam forms a seal with the cathode in (c) under vacuum. In one embodiment, including any of the foregoing, forms a seal with the cathode in (c) under about 1-2 Torr vacuum.

In one embodiment, including any of the foregoing, the outer seam in (d) is UV-cured. In one embodiment, including any of the foregoing, the seam in (c) is UV-cured. In one embodiment, the UV-curing is for less than about 2 minutes, less than about 90 seconds, less than about 1 minute, less than about 45 seconds, less than about 30 seconds, less than about 20 seconds, less than about 15 seconds, or less than about 10 seconds.

In one embodiment, including any of the foregoing, the UV-curing is for a minimum of about 1 second.

In one embodiment, the UV-curing is for about 2 minutes, about 90 seconds, about 1 minute, about 45 seconds, about 30 seconds, about 20 seconds, about 15 seconds, or about 10 seconds. In one embodiment, the UV-curing is for about 10 seconds. In one embodiment, the UV-curing is conducted using 365 nm UV wavelength.

In one embodiment, the UV intensity is about 250 mw/cm² to 600 mw/cm² and the wavelength is 365 nm. In one embodiment, the UV intensity is about 200 mw/cm² to 550 mw/cm² and the wavelength is 365 nm. In one embodiment, the UV intensity is about 300 mw/cm² to 500 mw/cm² and the wavelength is 365 nm. In one embodiment, the UV intensity is about 400 mw/cm² to 600 mw/cm² and the wavelength is 365 nm. In one embodiment, the UV intensity is about 450 mw/cm² to 550 mw/cm² and the wavelength is 365 nm. In one embodiment, the UV intensity is about 500 mw/cm² and the wavelength is 365 nm.

In one embodiment, the UV-curing is for less than about 1 minute, the UV intensity is about 500 mw/cm², and the wavelength is 365 nm. In one embodiment, the UV-curing is for less than about 45 seconds, the UV intensity is about 500 mw/cm², and the wavelength is 365 nm. In one embodiment, the UV-curing is for less than about 30 seconds, the UV intensity is about 500 mw/cm², and the wavelength is 365 nm. In one embodiment, the UV-curing is for less than about 15 seconds, the UV intensity is about 500 mw/cm², and the wavelength is 365 nm. In one embodiment, the UV-curing is for about 10 seconds, the UV intensity is about 500 mw/cm², and the wavelength is 365 nm.

In one embodiment, including any of the foregoing, the UV-curing comprises radiating the outer seam with UVA wavelengths. In one embodiment, including any of the foregoing, the UV-curing comprises radiating the outer seam with UVB wavelengths. In one embodiment, including any of the foregoing, the UV-curing comprises radiating the outer seam with UVC wavelengths.

In one embodiment, including any of the foregoing, the UV-curing comprises radiating the outer seam with UVA wavelengths wherein the UVA intensity is between 950 and 900 mW/cm². In one embodiment, including any of the foregoing, the UV-curing comprises radiating the outer seam with UVB wavelengths wherein the UVB intensity is between 875 and 800 mW/cm². In one embodiment, including any of the foregoing, the UV-curing comprises radiating the outer seam with UVC wavelengths wherein the UVC intensity is between 450 and 375 mW/cm².

In one embodiment, including any of the foregoing, the UV-curing comprises radiating the outer seam with UVA wavelengths wherein the dosage of UVA is between 880 and 800 mJ/cm². In one embodiment, including any of the foregoing, the UV-curing comprises radiating the outer seam with UVB wavelengths wherein the dosage of UVB is between 800 and 750 mJ/cm². In one embodiment, including any of the foregoing, the UV-curing comprises radiating the outer seam with UVC wavelengths wherein the dosage of UVC is about 361 mJ/cm².

In one embodiment, including any of the foregoing, the UV-curing comprises radiating the outer seam with UVA and UVB wavelengths. In one embodiment, including any of the foregoing, the UV-curing comprises radiating the outer seam with UVA and UVC wavelengths. In one embodiment, including any of the foregoing, the UV-curing comprises radiating the outer seam with UVB and UVC wavelengths.

In one embodiment, including any of the foregoing, the UV-curing comprises radiating the outer seam with UVA and UVB wavelengths wherein the UVA intensity is between 950 and 900 mW/cm² and the UVB intensity is between 875 and 800 mW/cm². In one embodiment, including any of the foregoing, the UV-curing comprises radiating the outer seam with UVA and UVC wavelengths wherein the UVA intensity is between 950 and 900 mW/cm² and the UVC intensity is between 450 and 375 mW/cm². In one embodiment, including any of the foregoing, the UV-curing comprises radiating the outer seam with UVB and UVC wavelengths wherein the UVB intensity is between 875 and 800 mW/cm² and the UVC intensity is between 450 and 375 mW/cm².

In one embodiment, including any of the foregoing, the UV-curing comprises radiating the outer seam with UVA and UVB wavelengths wherein the dosage of UVA is between 880 and 800 mJ/cm² and the dosage of UVB is between 800 and 750 mJ/cm². In one embodiment, including any of the foregoing, the UV-curing comprises radiating the outer seam with UVA and UVC wavelengths wherein the dosage of UVA is between 880 and 800 mJ/cm² and the dosage of UVC is about 361 mJ/cm². In one embodiment, including any of the foregoing, the UV-curing comprises radiating the outer seam with UVB and UVC wavelengths wherein the dosage of UVB is between 800 and 750 mJ/cm² and the dosage of UVC is about 361 mJ/cm².

In one embodiment, including any of the foregoing, the UV-curing comprises radiating the outer seam with UVA, UVB, and UVC wavelengths. In one embodiment, including any of the foregoing, the UV-curing comprises radiating the outer seam with UVA, UVB, and UVC wavelengths and the UVA intensity is between 950 and 900 mW/cm²; the UVB intensity is between 875 and 800 mW/cm²; and, the UVC intensity is between 450 and 375 mW/cm². In one embodiment, including any of the foregoing, the UV-curing comprises radiating the outer seam with UVA, UVB, and UVC wavelengths and the UVA intensity is about 922 mW/cm²; the UVB intensity is about 864 mW/cm²; and, the UVC intensity is about 396 mW/cm².

In one embodiment, including any of the foregoing, the UV-curing comprises radiating the outer seam with UVA, UVB, and UVC wavelengths and the dosage of UVA is between 880 and 800 mJ/cm²; the dosage of UVB is between 800 and 750 mJ/cm²; and, the dosage of UVC is between 400 and 300 mJ/cm². In one embodiment, including any of the foregoing, the UV-curing comprises radiating the outer seam with UVA, UVB, and UVC wavelengths and the dosage of UVA is about 840 mJ/cm²; the dosage of UVB is about 773 mJ/cm²; and, the dosage of UVC is about 361 mJ/cm². In one embodiment, including any of the foregoing conditions, the outer seam is UV-cured for about ten seconds.

In one embodiment, including any of the foregoing, the outer seam in (d) is heat-cured. In one embodiment, including any of the foregoing, the seam in (c) is heat-cured. In one embodiment, the heat-curing is for less than about 2 minutes, less than about 90 seconds, less than about 1 minute, less than about 45 seconds, less than about 30 seconds, less than about 20 seconds, less than about 15 seconds, or less than about 10 seconds.

In one embodiment, including any of the foregoing, the heat-curing is for a minimum of about 1 second.

In one embodiment, the heat-curing is for about 2 minutes, about 90 seconds, about 1 minute, about 45 seconds, about 30 seconds, about 20 seconds, about 15 seconds, or about 10 seconds. In one embodiment, the outer seam in (d) is heat-cured for about 10 seconds.

In one embodiment, the heat-curing is at a temperature less than about 65° C., less than about 60° C., less than about 55° C., less than about 50° C., less than about 45° C., less than about 45° C., less than about 30° C., or less than about 35° C. In one embodiment, the heat-curing is at a temperature less than about 50° C. In one embodiment, the heat-curing is at a temperature of about 40° C. In one embodiment, the heat-curing is at a temperature of about 40° C. In one embodiment, the heat-curing is at a temperature of about 60° C.

In one embodiment, the heat-curing is at a temperature between 30° C. and 60° C. In one embodiment, the heat-curing is at a temperature between 30° C. and 50° C. In one embodiment, the heat-curing is at a temperature between 35° C. and 45° C. In one embodiment, the heat-curing is at a temperature between 30° C. and 35° C. In one embodiment, the heat-curing is at a temperature between 40° C. and 45° C. In one embodiment, the heat-curing is at a temperature between 50° C. and 60° C. In one embodiment, the heat-curing is at a temperature between 60° C. and 65° C.

In one embodiment, including any of the foregoing, the outer seal in (d) comprises photo-crosslinked polyisobutylene (PIB). In one embodiment, including any of the foregoing, the outer seal in (d) consists essentially of photo-crosslinked polyisobutylene (PIB).

In one embodiment, including any of the foregoing, the seal in (c) comprises photo-crosslinked polyisobutylene (PIB) and tackifier. In one embodiment, including any of the foregoing, the outer seal in (d) consists essentially of photo-crosslinked polyisobutylene (PIB) and tackifier.

In one embodiment, including any of the foregoing, the at least one inner seal in (c) comprises polyisobutylene (PIB) and the outer seal in (d) is UV-cured. In one embodiment, including any of the foregoing, the at least one inner seal in (c) comprises polyisobutylene (PIB) and the outer seal in (d) is heat-cured.

In one embodiment, including any of the foregoing, the at least one inner seal in (c) consists essentially of polyisobutylene (PIB) and the outer seal in (d) is UV-cured. In one embodiment, including any of the foregoing, the at least one inner seal in (c) consists essentially of polyisobutylene (PIB) and the outer seal in (d) is heat-cured.

In one embodiment, including any of the foregoing, the at least one inner seal in (c) comprises a mixture of polyisobutylene (PIB) and polyisoprene and the outer seal in (d) is UV-cured. In one embodiment, including any of the foregoing, the at least one inner seal in (c) comprises a mixture of polyisobutylene (PIB) and polyisoprene and the outer seal in (d) is heat-cured.

In one embodiment, including any of the foregoing, the at least one inner seal in (c) consists essentially of polyisobutylene (PIB) and the outer seal in (d) comprises photo-crosslinked PIB. In one embodiment, including any of the foregoing, the at least one inner seal in (c) consists essentially of polyisobutylene (PIB) and the outer seal in (d) comprises photo-crosslinked PIB that is photo-crosslinked from a monomer having a structure of Formula (I).

In one embodiment, including any of the foregoing, the at least one inner seal in (c) comprises a mixture of polyisobutylene (PIB) and polyisoprene and the outer seal in (d) comprises photo-crosslinked PIB. In one embodiment, including any of the foregoing, the at least one inner seal in (c) comprises a mixture of polyisobutylene (PIB) and polyisoprene and the outer seal in (d) comprises photo-crosslinked PIB that is photo-crosslinked from a monomer having a structure of Formula (I).

In one embodiment, including any of the foregoing, the at least one inner seal in (c) is one inner seal and consists essentially of polyisobutylene (PIB) and the outer seal in (d) is UV-cured. In one embodiment, including any of the foregoing, the at least one inner seal in (c) is one inner seal and consists essentially of polyisobutylene (PIB) and the outer seal in (d) is heat-cured.

In one embodiment, including any of the foregoing, the at least one inner seal in (c) is one inner seal and comprises a mixture of polyisobutylene (PIB) and polyisoprene and the outer seal in (d) is UV-cured. In one embodiment, including any of the foregoing, the at least one inner seal in (c) is one inner seal and comprises a mixture of polyisobutylene (PIB) and polyisoprene and the outer seal in (d) is heat-cured.

In one embodiment, including any of the foregoing, the at least one inner seal in (c) is one inner seal and consists essentially of polyisobutylene (PIB) and the outer seal in (d) comprises photo-crosslinked PIB that is photo-crosslinked from a monomer having a structure of Formula (I). In one embodiment, including any of the foregoing, the at least one inner seal in (c) is one inner seal and consists essentially of polyisobutylene (PIB) and the outer seal in (d) comprises photo-crosslinked PIB that is photo-crosslinked from a monomer having a structure of Formula (I).

In one embodiment, including any of the foregoing, the at least one inner seal in (c) is one inner seal and comprises a mixture of polyisobutylene (PIB) and polyisoprene and the outer seal in (d) comprises photo-crosslinked PIB. In one embodiment, including any of the foregoing, the at least one inner seal in (c) is one inner seal and comprises a mixture of polyisobutylene (PIB) and polyisoprene and the outer seal in (d) comprises photo-crosslinked PIB that is photo-crosslinked from a monomer having a structure of Formula (I).

In one embodiment, including any of the foregoing, the at least one inner seal in (c) is three inner seals and each consists essentially of polyisobutylene (PIB) and the outer seal in (d) is UV-cured. In one embodiment, including any of the foregoing, the at least one inner seal in (c) is three inner seals and each and consists essentially of polyisobutylene (PIB) and the outer seal in (d) is heat-cured.

In one embodiment, including any of the foregoing, the at least one inner seal in (c) is three inner seals and each comprises a mixture of polyisobutylene (PIB) and polyisoprene and the outer seal in (d) is UV-cured. In one embodiment, including any of the foregoing, the at least one inner seal in (c) is three inner seals and each and comprises a mixture of polyisobutylene (PIB) and polyisoprene and the outer seal in (d) is heat-cured.

In one embodiment, including any of the foregoing, the at least one inner seal in (c) is three inner seals and each consists essentially of polyisobutylene (PIB) and the outer seal in (d) comprises photo-crosslinked PIB. In one embodiment, including any of the foregoing, the at least one inner seal in (c) is three inner seals and each consists essentially of polyisobutylene (PIB) and the outer seal in (d) comprises photo-crosslinked PIB that is photo-crosslinked from a monomer having a structure of Formula (I).

In one embodiment, including any of the foregoing, the at least one inner seal in (c) is three inner seals and each comprises a mixture of polyisobutylene (PIB) and polyisoprene and the outer seal in (d) comprises photo-crosslinked PIB. In one embodiment, including any of the foregoing, the at least one inner seal in (c) is three inner seals and each comprises a mixture of polyisobutylene (PIB) and polyisoprene and the outer seal in (d) comprises photo-crosslinked PIB that is photo-crosslinked from a monomer having a structure of Formula (I).

In one embodiment, including any of the foregoing, the seal in (c) comprises at least about 90% w/w of the photo-crosslinked PIB. In one embodiment, including any of the foregoing, the seal in (c) comprises at least about 95% w/w of the photo-crosslinked PIB. In one embodiment, including any of the foregoing, the seal in (c) comprises at least about 97% w/w of the photo-crosslinked PIB. In one embodiment, including any of the foregoing, the seal in (c) comprises at least 98% w/w of the photo-crosslinked PIB. In one embodiment, including any of the foregoing, the seal in (c) comprises at least about 99% w/w of the photo-crosslinked PIB. In one embodiment, including any of the foregoing, the seal in (c) comprises about 99% w/w of the photo-crosslinked PIB.

In one embodiment, including any of the foregoing, the seal in (c) comprises no more than about 5% w/w of the tackifier. In one embodiment, including any of the foregoing, the seal in (c) comprises no more than about 4% w/w of the tackifier. In one embodiment, including any of the foregoing, the seal in (c) comprises no more than about 3% w/w of the tackifier. In one embodiment, including any of the foregoing, the seal in (c) comprises no more than about 2% w/w of the tackifier. In one embodiment, including any of the foregoing, the seal in (c) comprises no more than about 1% w/w of the tackifier. In one embodiment, including any of the foregoing, the seal in (c) comprises no more than about 0.5% w/w of the tackifier.

In one embodiment, including any of the foregoing, the ratio by weight of photo-crosslinked PIB to tackifier in the seal of (c) is about 95:5, about 95.5:4.5, 96:4, 96.5:3.5, 97:3, 97.5:2.5, 98:2, 98.5:1.5, 99:1, and 99.5:0.5.

In one embodiment, including any of the foregoing, the seal exhibits a peel strength between 22N/25 mm and 50N/25 mm following a 180-degree peel at room temperature as measured by the ASTM D3330 test. In one embodiment, including any of the foregoing, the seal exhibits a peel strength between 22N/25 mm and 45N/25 mm following a 180-degree peel at room temperature. In one embodiment, including any of the foregoing, the seal exhibits a peel strength between 22N/25 mm and 40N/25 mm following a 180-degree peel at room temperature. In one embodiment, including any of the foregoing, the seal exhibits a peel strength between 22N/25 mm and 35N/25 mm following a 180-degree peel at room temperature. In one embodiment, including any of the foregoing, the seal exhibits a peel strength between 25N/25 mm and 35N/25 mm following a 180-degree peel at room temperature. In one embodiment, including any of the foregoing, the seal exhibits a peel strength of about 32N/25 mm, 31N/25 mm, 30N/25 mm, 29N/25 mm, 28N/25 mm, 27N/25 mm, or 26N/25 mm following a 180-degree peel at room temperature. In one embodiment, including any of the foregoing, the seal exhibits a peel strength of about 28N/25 mm following a 180-degree peel at room temperature.

In one embodiment, including any of the foregoing, the distance between the edge of the cathode and the outside edge of the outer seal in (d) is about 2 mm to 10 mm. In one embodiment, including any of the foregoing, the distance between the edge of the cathode and the outside edge of the outer seal in (d) is about 2 mm to 9 mm. In one embodiment, including any of the foregoing, the distance between the edge of the cathode and the outside edge of the outer seal in (d) is about 2 mm to 8 mm. In one embodiment, including any of the foregoing, the distance between the edge of the cathode and the outside edge of the outer seal is about 2 mm to 7 mm. In one embodiment, including any of the foregoing, the distance between the edge of the cathode and the outside edge of the outer seal in (d) is about 2 mm to 6 mm. In one embodiment, including any of the foregoing, the distance between the edge of the cathode and the outside edge of the outer seal in (d) is equal to, or less than, about 5 mm.

In one embodiment, including any of the foregoing, the distance between the edge of the cathode and the outside edge of the outer seal in (d) is about 2 mm to 5 mm. In one embodiment, including any of the foregoing, the distance between the edge of the cathode and the outside edge of the outer seal in (d) is about 2 mm to 4 mm. In one embodiment, including any of the foregoing, the distance between the edge of the cathode and the outside edge of the outer seal in (d) is equal to, or less than, about 3 mm.

In one embodiment, including any of the foregoing, the distance between the edge of the cathode and the outside edge of the outer seal in (d) is about 2 mm to 3 mm. In one embodiment, including any of the foregoing, the distance between the edge of the cathode and the outside edge of the outer seal in (d) is about 2 mm to 2.5 mm. In one embodiment, including any of the foregoing, the distance between the edge of the cathode and the outside edge of the outer seal in (d) is about 2 mm to 2.5 mm. In one embodiment, including any of the foregoing, the distance between the edge of the cathode and the outside edge of the outer seal in (d) is about 2.3 mm. In one embodiment, including any of the foregoing, the distance between the edge of the cathode and the outside edge of the outer seal in (d) is about 2.5 mm.

In one embodiment, including any of the foregoing, the distance between the outside edge of the inner seal of (c) and the inside edge of the outer seal of (d) is about 0.1 mm to 0.3 mm. In one embodiment, including any of the foregoing, the distance between the outside edge of the inner seal of (c) and the inside edge of the outer seal of (d) is about 0.1 mm. In one embodiment, including any of the foregoing, the distance between the outside edge of the inner seal of (c) and the inside edge of the outer seal of (d) is about 0.2 mm. In one embodiment, including any of the foregoing, the distance between the outside edge of the inner seal of (c) and the inside edge of the outer seal of (d) is about 0.3 mm.

In one embodiment, including any of the foregoing, the distance between the inside edge of the inner seal of (c) and the edge of the cathode is about 1 mm to 0.2 mm. In one embodiment, including any of the foregoing, the distance between the inside edge of the inner seal of (c) and the edge of the cathode is about 0.9 mm to 0.1 mm. In one embodiment, including any of the foregoing, the distance between the inside edge of the inner seal of (c) and the edge of the cathode is about 0.8 mm to 0.3 mm. In one embodiment, including any of the foregoing, the distance between the inside edge of the inner seal of (a) and the edge of the cathode is about 0.75 mm to 0.35 mm. In one embodiment, including any of the foregoing, the distance between the inside edge of the inner seal of (c) and the edge of the cathode is about 0.7 mm to 0.4 mm. In one embodiment, including any of the foregoing, the distance between the inside edge of the inner seal of (c) and the edge of the cathode is about 0.8 mm to 0.5 mm. In one embodiment, including any of the foregoing, the distance between the inside edge of the inner seal of (c) and the edge of the cathode is about 0.8 mm to 0.4 mm. In one embodiment, including any of the foregoing, the distance between the inside edge of the inner seal of (c) and the edge of the cathode is about 0.75 mm.

In one embodiment, including any of the foregoing, the distance between the outside edge of the inner seal of (c) and the inside edge of the outer seal of (d) is about 0.1 mm to 0.3 mm and the distance between the inside edge of the inner seal of (c) and the edge of the cathode is about 0.8 mm to 0.3 mm. In one embodiment, including any of the foregoing, the distance between the outside edge of the inner seal of (c) and the inside edge of the outer seal of (d) is about 0.1 mm to 0.3 mm and the distance between the edge of the inside inner seal of (c) and the edge of the cathode is about 0.75 mm to 0.35 mm. In one embodiment, including any of the foregoing, the distance between the outside edge of the inner seal of (c) and the inside edge of the outer seal of (d) is about 0.1 mm to 0.3 mm and the distance between the inside edge of the inner seal of (c) and the edge of the cathode is about 0.8 mm to 0.5 mm. In one embodiment, including any of the foregoing, the distance between the outside edge of the inner seal of (c) and the inside edge of the outer seal of (d) is about 0.3 mm and the distance between the inside edge of the inner seal of (c) and the edge of the cathode is about 0.75 mm.

In one embodiment, including any of the foregoing, the at least one inner seal in (c) and the outer seal in (d) each independently have a width in the range of about 0.6 mm and 1.4 mm. In one embodiment, including any of the foregoing, the at least one inner seal in (c) and the outer seal in (d) each independently have a width in the range of about 0.8 mm and 1.2 mm. In one embodiment, including any of the foregoing, the at least one inner seal in (c) and the outer seal in (d) each independently have a width in the range of about 0.8 mm and 1.0 mm. In one embodiment, including any of the foregoing, the at least one inner seal in (c) and the outer seal in (d) are each about 1 mm in width.

In one embodiment, including any of the foregoing, the inner seal in (c) is one inner seal and the one inner seal and the outer seal in (d) each independently have a width in the range of about 0.6 mm and 1.4 mm. In one embodiment, including any of the foregoing, the inner seal in (c) is one inner seal and the one inner seal and the outer seal in (d) each independently have a width in the range of about 0.8 mm and 1.2 mm. In one embodiment, including any of the foregoing, the inner seal in (c) is one inner seal and the one inner seal and the outer seal in (d) each independently have a width in the range of about 0.8 mm and 1.0 mm. In one embodiment, including any of the foregoing, the inner seal in (c) is one inner seal and the one inner seal and the outer seal in (d) are each about 1 mm in width.

In one embodiment, including any of the foregoing, the inner seal in (c) is three inner seals and each inner seal and the outer seal in (d) independently have a width in the range of about 0.6 mm and 1.4 mm. In one embodiment, including any of the foregoing, the inner seal in (c) is three inner seals and each inner seal and the outer seal in (d) independently have a width in the range of about 0.8 mm and 1.2 mm. In one embodiment, including any of the foregoing, the inner seal in (c) is three inner seals and each inner seal and the outer seal in (d) independently have a width in the range of about 0.8 mm and 1.0 mm. In one embodiment, including any of the foregoing, the inner seal in (c) is three inner seals and each inner seal and the outer seal in (d) are about 1 mm in width.

In one embodiment, including any of the foregoing, the inner seal in (c) and the outer seal in (d) each independently have a height in the range of about 100 μm and 350 μm. In one embodiment, including any of the foregoing, the inner seal in (c) and the outer seal in (d) each independently have a height in the range of about 100 μm and 250 μm. In one embodiment, including any of the foregoing, the inner seal in (c) and the outer seal in (d) each independently have a height in the range of about 100 μm and 200 μm. In one embodiment, including any of the foregoing, the inner seal in (c) and the outer seal in (d) are each about 150 μm. In one embodiment, including any of the foregoing, the inner seal in (c) and the outer seal in (d) each independently have a height in the range of about 200 μm and 350 μm. In one embodiment, including any of the foregoing, the inner seal in (c) and the outer seal in (d) each independently have a height in the range of about 220 μm and 320 μm. In one embodiment, including any of the foregoing, the inner seal in (c) and the outer seal in (d) each independently have a height in the range of about 220 μm and 300 μm. In one embodiment, including any of the foregoing, the inner seal in (c) and the outer seal in (d) each independently have a height in the range of about 230 μm and 300 μm. In one embodiment, including any of the foregoing, the inner seal in (c) and the outer seal in (d) each independently have a height in the range of about 240 μm and 280 μm. In one embodiment, including any of the foregoing, the inner seal in (c) and the outer seal in (d) each independently have a height in the range of about 250 μm and 270 μm. In one embodiment, including any of the foregoing, the inner seal in (c) and the outer seal in (d) are each about 260 μm.

In one embodiment, including any of the foregoing, the inner seal in (c) and the outer seal in (d) each independently have a width in the range of about 0.8 mm and 1.2 mm and independently a height in the range of about 100 μm and 200 μm. In one embodiment, including any of the foregoing, the inner seal in (c) and the outer seal in (d) are each about 1.0 mm in width and about 150 μm in height.

In one embodiment, including any of the foregoing, the inner seal in (c) and the outer seal in (d) each independently have a width in the range of about 0.8 mm and 1.2 mm and independently a height in the range of about 100 μm and 200 μm and the distance between the edge of the cathode and the outside edge of the outer seal in (d) is equal to, or less than, 5 mm. In one embodiment, including any of the foregoing, the inner seal in (c) and the outer seal in (d) are each about 1.0 mm in width and about 150 μm in height and the distance between the edge of the cathode and the outside edge of the outer seal in (d) is equal to, or less than, 5 mm.

In one embodiment, including any of the foregoing, the inner seam in (a) and the outer seal in (d) each independently have a width in the range of about 0.8 mm and 1.2 mm and independently a height in the range of about 100 μm and 200 μm and the distance between the edge of the cathode and the outside edge of the outer seal in (d) is about 2 mm to 2.5 mm. In one embodiment, including any of the foregoing, the inner seal in (c) and the outer seal in (d) are each about 1.0 mm in width and about 150 μm in height and the distance between the edge of the cathode and the outside edge of the outer seal in (d) is about 2 mm to 2.5 mm.

In one embodiment, including any of the foregoing, the inner seal in (c) and the outer seal in (d) each independently have a width in the range of about 0.8 mm and 1.2 mm and independently a height in the range of about 220 μm and 300 μm. In one embodiment, including any of the foregoing, the inner seal in (c) and the outer seal in (d) are each about 1.0 mm in width and about 260 μm in height.

In one embodiment, including any of the foregoing, the inner seal in (c) and the outer seal in (d) each independently have a width in the range of about 0.8 mm and 1.2 mm and independently a height in the range of about 220 μm and 300 μm and the distance between the edge of the cathode and the outside edge of the outer seal in (d) is equal to, or less than, 5 mm. In one embodiment, including any of the foregoing, the inner seal in (c) and the outer seal in (d) are each about 1.0 mm in width and about 260 μm in height and the distance between the edge of the cathode and the outside edge of the outer seal in (d) is equal to, or less than, 5 mm.

In one embodiment, including any of the foregoing, the inner seam in (a) and the outer seal in (d) each independently have a width in the range of about 0.8 mm and 1.2 mm and independently a height in the range of about 220 μm and 300 μm and the distance between the edge of the cathode and the outside edge of the outer seal in (d) is about 2 mm to 2.5 mm. In one embodiment, including any of the foregoing, the inner seal in (c) and the outer seal in (d) are each about 1.0 mm in width and about 260 μm in height and the distance between the edge of the cathode and the outside edge of the outer seal in (d) is about 2 mm to 2.5 mm.

In one embodiment, including any of the foregoing, the inner seal in (c) comprises a mixture of polyisobutylene (PIB) and polyisoprene; the outer seal in (d) comprises photo-crosslinked polyisobutylene (PIB); and the distance between the edge of the cathode and the outside edge of the outer seal in (d) is about 2 mm to 2.5 mm. In one embodiment, including any of the foregoing, the inner seal in (c) consists essentially of polyisobutylene (PIB); the outer seal in (d) comprises photo-crosslinked polyisobutylene (PIB); and the distance between the edge of the cathode and the outside edge of the outer seam in (b) is about 2 mm to 2.5 mm.

In one embodiment, including any of the foregoing, the inner seal in (c) comprises a mixture of polyisobutylene (PIB) and polyisoprene; the outer seal in (d) comprises photo-crosslinked PIB that is photo-crosslinked from a monomer having a structure of Formula (I); and the distance between the edge of the cathode and the outside edge of the outer seal in (d) is about 2 mm to 2.5 mm. In one embodiment, including any of the foregoing, the inner seal in (c) consists essentially of polyisobutylene (PIB); the outer seal in (d) comprises photo-crosslinked PIB that is photo-crosslinked from a monomer having a structure of Formula (I); and the distance between the edge of the cathode and the outside edge of the outer seam in (b) is about 2 mm to 2.5 mm.

In one embodiment, including any of the foregoing, the distance between the edge of the cathode and the outside edge of the seal in (c) is about 2 mm to 10 mm. In one embodiment, including any of the foregoing, the distance between the edge of the cathode and the outside edge of the seal in (c) is about 2 mm to 9 mm. In one embodiment, including any of the foregoing, the distance between the edge of the cathode and the outside edge of the seal in (c) is about 2 mm to 8 mm. In one embodiment, including any of the foregoing, the distance between the edge of the cathode and the outside edge of the seal in (c) is about 2 mm to 7 mm. In one embodiment, including any of the foregoing, the distance between the edge of the cathode and the outside edge of the seal in (c) is about 2 mm to 6 mm. In one embodiment, including any of the foregoing, the distance between the edge of the cathode and the outside edge of the seal in (c) is about 2 mm to 5 mm. In one embodiment, including any of the foregoing, the distance between the edge of the cathode and the outside edge of the seal in (c) is about 2 mm to 4 mm. In one embodiment, including any of the foregoing, the distance between the edge of the cathode and the outside edge of the seal in (c) is about 2 mm to 3 mm. In one embodiment, including any of the foregoing, the distance between the edge of the cathode and the outside edge of the seal in (c) is about 2 mm to 2.5 mm. In one embodiment, including any of the foregoing, the distance between the edge of the cathode and the outside edge of the seal in (c) is about 2 mm to 2.3 mm. In one embodiment, including any of the foregoing, the distance between the edge of the cathode and the outside edge of the seal in (c) is about 2.5 mm. In one embodiment, including any of the foregoing, the distance between the edge of the cathode and the outside edge of the seal in (c) is about 2.3 mm.

In one embodiment, including any of the foregoing, the cathode in any of the process described herein has the dimension of about 57 mm by 72 mm and the solid-state electrolyte separator has the dimension of about 60×75 mm.

In one embodiment, including any of the foregoing, the seal in (c) has a width in the range of about 0.6 mm and 1.4 mm. In one embodiment, including any of the foregoing, the seal in (c) has a width in the range of about 0.8 mm and 1.2 mm. In one embodiment, including any of the foregoing, the seal in (c) has a width in the range of about 0.8 mm and 1.0 mm. In one embodiment, including any of the foregoing, the seal in (c) is about 1 mm in width.

In one embodiment, including any of the foregoing, the seal in (c) has a height in the range of about 100 μm and 350 μm. In one embodiment, including any of the foregoing, the seal in (c) has a height in the range of about 200 μm and 250 μm. In one embodiment, including any of the foregoing, the seal in (c) has a height in the range of about 100 μm and 200 μm. In one embodiment, including any of the foregoing, the seal in (c) is about 150 μm. In one embodiment, including any of the foregoing, the seal in (c) has a height in the range of about 200 μm and 350 μm. In one embodiment, including any of the foregoing, the seal in (c) has a height in the range of about 220 μm and 320 μm. In one embodiment, including any of the foregoing, the seal in (c) has a height in the range of about 220 μm and 300 μm. In one embodiment, including any of the foregoing, the seal in (c) has a height in the range of about 230 μm and 300 μm. In one embodiment, including any of the foregoing, the seal in (c) has a height in the range of about 240 μm and 280 μm. In one embodiment, including any of the foregoing, the seal in (c) has a height in the range of about 250 μm and 270 μm. In one embodiment, including any of the foregoing, the seal in (c) is about 260 μm.

In one embodiment, including any of the foregoing, the seal in (c) has a width in the range of about 0.8 mm and 1.2 mm and a height in the range of about 100 μm and 200 μm. In one embodiment, including any of the foregoing, the seal in (c) is about 1.0 mm in width and about 150 μm in height.

In one embodiment, including any of the foregoing, the seal in (c) has a width in the range of about 0.8 mm and 1.2 mm; a height in the range of about 100 μm and 200 μm; and the distance between the edge of the cathode and the seal is about 2 mm to 5 mm. In one embodiment, including any of the foregoing, the seal in (c) is about 1.0 mm in width; about 150 μm in height; and the distance between the edge of the cathode and the outside edge of the seal is about 2 mm to 5 mm.

In one embodiment, including any of the foregoing, the seal in (c) has a width in the range of about 0.8 mm and 1.2 mm; a height in the range of about 100 μm and 200 μm; and the distance between the edge of the cathode and the outside edge of the seal is about 2 mm to 2.5 mm. In one embodiment, including any of the foregoing, the seal in (c) is about 1.0 mm in width; about 150 μm in height; and the distance between the edge of the cathode and the edge of the seal is about 2 mm to 2.5 mm.

In one embodiment, including any of the foregoing, the seal in (c) has a width in the range of about 0.8 mm and 1.2 mm and a height in the range of about 220 μm and 300 μm. In one embodiment, including any of the foregoing, the seal in (c) is about 1.0 mm in width and about 260 μm in height.

In one embodiment, including any of the foregoing, the seal in (c) has a width in the range of about 0.8 mm and 1.2 mm; a height in the range of about 220 μm and 300 μm; and the distance between the edge of the cathode and the seal is about 2 mm to 5 mm. In one embodiment, including any of the foregoing, the seal in (c) is about 1.0 mm in width; about 260 μm in height; and the distance between the edge of the cathode and the outside edge of the seal is about 2 mm to 5 mm.

In one embodiment, including any of the foregoing, the seal in (c) has a width in the range of about 0.8 mm and 1.2 mm; a height in the range of about 220 μm and 300 μm; and the distance between the edge of the cathode and the outside edge of the seal is about 2 mm to 2.5 mm. In one embodiment, including any of the foregoing, the seal in (c) is about 1.0 mm in width; about 260 μm in height; and the distance between the edge of the cathode and the edge of the seal is about 2 mm to 2.5 mm.

### Non-Limiting Embodiments

The present disclosure provides at least the following non-limiting embodiments:
(a) An electrochemical stack comprising:
   a cathode comprising a catholyte;
   a solid-state electrolyte separator comprising two major surfaces and four minor surfaces; and
   a seal between a first major surface of the separator and the cathode and within 0.1 mm to 2 mm from a perimeter of the first major surface;
   wherein the seal does not contact the perimeter of the first major surface, the second major surface, or the minor surfaces of the separator;
   wherein the cathode geometric surface area is less than the separator geometric surface area; and
   wherein the seal comprises crosslinked polyisobutylene (PIB).
(b) The electrochemical stack of embodiment (a), wherein the seal is a perimeter seal.
(c) The electrochemical stack of embodiment (a) or (b), wherein the seal is dispensed from a liquid reservoir.
(d) The electrochemical stack of any one of embodiments (a)-(c), wherein the seal is ultraviolet (UV)-cured.
(d.1) The electrochemical stack of embodiment (d), wherein the UV-curing comprises radiating the seal with UVA, UVB, UVC wavelengths, or a combination thereof.
(d.2) The electrochemical stack of embodiment (d) or (d.1), wherein the UV-curing comprises radiating the seal with UVA wavelengths.
(d.3) The electrochemical stack of embodiment (d) or (d.1), wherein the UV-curing comprises radiating the seal with UVB wavelengths.
(d.4) The electrochemical stack of embodiment (d) or (d.1), wherein the UV-curing comprises radiating the seal with UVC wavelengths.
(d.5) The electrochemical stack of embodiment (d) or (d.1), wherein the UV-curing comprises radiating the seal with UVA and UVB wavelengths.
(d.6) The electrochemical stack of embodiment (d) or (d.1), wherein the UV-curing comprises radiating the seal with UVA and UVC wavelengths.
(d.7) The electrochemical stack of embodiment (d) or (d.1), wherein the UV-curing comprises radiating the seal with UVB and UVC wavelengths.
(d.8) The electrochemical stack of any one of embodiments (d), (d.1), (d.2), (d.5), and (d.6), wherein the UVA intensity is between 950 and 900 mW/cm².
(d.9) The electrochemical stack of any one of embodiments (d), (d.1), (d.3), (d.5), and (d.7), wherein the UVB intensity is between 875 and 800 mW/cm².
(d.10) The electrochemical stack of any one of embodiments (d), (d.1), (d.4), (d.6) and (d.7), wherein the UVC intensity is between 450 and 375 mW/cm².
(d.11) The electrochemical stack of any one of embodiments (d), (d.1), (d.2), (d.5), (d.6), and (d.8), wherein the dosage of UVA is between 880 and 800 mJ/cm².
(d.12) The electrochemical stack of any one of embodiments (d), (d.1), (d.3), (d.5), (d.7), and (d.9), wherein dosage of UVB is between 800 and 750 mJ/cm².
(d.13) The electrochemical stack of any one of embodiments (d), (d.1), (d.4), (d.6), (d.7), and (d.10), wherein the dosage of UVC is between 400 and 300 mJ/cm².
(d.14) The electrochemical stack of embodiment (d), wherein the UV-curing comprises UVA, UVB, and UVC wavelengths.
(d.15) The electrochemical stack of embodiments (d), (d.1), or (d.14), wherein the UVA intensity is between 950 and 900 mW/cm²; the UVB intensity is between 875 and 800 mW/cm²; and the UVC intensity is between 450 and 375 mW/cm².
(d.16) The electrochemical stack of any one of embodiments (d), (d.1), (d.14), and (d.15), wherein the UVA intensity is about 922 mW/cm²; the UVB intensity is about 864 mW/cm²; and the UVC intensity is about 396 mW/cm².
(d.17) The electrochemical stack of any one of embodiments (d), (d.1), and (d.14)-(d.16), wherein the dosage of UVA is between 880 and 800 mJ/cm²; the dosage of UVB is between 800 and 750 mJ/cm²; and the dosage of UVC is between 400 and 300 mJ/cm².
(d.18) The electrochemical stack of any one of embodiments (d), (d.1), and (d.14)-(d.17), wherein the dosage of UVA is about 840 mJ/cm²; the dosage of UVB is about 773 mJ/cm²; and the dosage of UVC is about 361 mJ/cm².
(d.19) The electrochemical stack of any one of embodiments (d)-(d.18), wherein the seal is UV-cured for about ten seconds.
(e) The electrochemical stack of any one of embodiments (a)-(c), wherein the seal is heat-cured.
(f) The electrochemical stack of any one of embodiments (a)-(e), wherein the photo-crosslinked PIB is photo-crosslinked from a monomer having a structure of Formula (I):

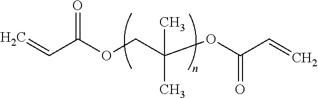

wherein n is an integer from 5 to 50.
(f.1) The electrochemical stack of any one of embodiments (a)-(e), wherein the photo crosslinked PIB is photo-crosslinked from a mixture of monomers having a structure of Formula (I):

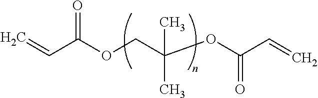

wherein n is an integer from 1 to 100.
(g) The electrochemical stack of any one of embodiments (a)-(f.1), wherein the tackifier comprises polyisobutylene (PIB) with a molecular weight of about 10,000 g/mol to 100,000 g/mol.
(h) The electrochemical stack of any one of embodiments (a)-(g), wherein the tackifier comprises PIB with a molecular weight of about 10,000 g/mol to 40,000 g/mol.
(i) The electrochemical stack of any one of embodiments (a)-(h), wherein the tackifier comprises PIB with a molecular weight of about 25,000 g/mol.
(i.1) The electrochemical stack of any one of embodiments (a)-(g), wherein the tackifier comprises PIB with a molecular weight of about 100 g/mol to 500 g/mol.
(i.2) The electrochemical stack of any one of embodiments (a)-(g), wherein the tackifier comprises PIB with a molecular weight of about 100 g/mol to 300 g/mol.
(i.3) The electrochemical stack of any one of embodiments (a)-(g), wherein the tackifier comprises PIB with a molecular weight of about 250 g/mol to 500 g/mol.
(j) The electrochemical stack of any one of embodiments (a)-(i.3), wherein the seal comprises at least about 90% w/w of the photo-crosslinked PIB.
(k) The electrochemical stack of any one of embodiments (a)-(j), wherein the seal comprises at least about 95% w/w of the photo-crosslinked PIB.
(l) The electrochemical stack of any one of embodiments (a)-(k), wherein the seal comprises at about 99% w/w of the photo-crosslinked PIB.
(m) The electrochemical stack of any one of embodiments (a)-(l), wherein the seal comprises no more than about 5% w/w of the tackifier.
(n) The electrochemical stack of any one of embodiments (a)-(m), wherein the seal comprises no more than about 3% w/w of the tackifier.
(o) The electrochemical stack of any one of embodiments (a)-(n), wherein the distance between the edge of the cathode and the outside edge of the seal is equal to, or less than, 5 mm.
(p) The electrochemical stack of any one of embodiments (a)-(o), wherein the distance between the edge of the cathode and the outside edge of the seal is equal to, or less than, 3 mm.
(q) The electrochemical stack of any one of embodiments (a)-(p), wherein the distance between the edge of the cathode and the outside edge of the seal is about 2 mm to about 2.5 mm.
(r) The electrochemical stack of any one of embodiments (a)-(q), wherein the distance between the edge of the cathode and the outside edge of the outer seal is about 2.5 mm.
(s) The electrochemical stack of any one of embodiments (a)-(q), wherein the distance between the edge of the cathode and the outside edge of the seal is about 2.3 mm.
(s.1) The electrochemical stack of any one of embodiments (a)-(q), wherein the distance between the edge of the cathode and the outside edge of the seal is about 0.1 mm to 1 mm.
(s.2) The electrochemical stack of any one of embodiments (a)-(q), wherein the distance between the edge of the cathode and the outside edge of the seal is about 0.4 mm to 0.8 mm.
(s.3) The electrochemical stack of any one of embodiments (a)-(q), wherein the distance between the edge of the cathode and the outside edge of the seal is about 0.5 mm.
(t) The electrochemical stack of any one of embodiments (a)-(s.3), wherein the seal has a width in the range of about 0.8 mm and about 1.2 mm.
(u) The electrochemical stack of embodiment (t), wherein the seal is about 1 mm in width.
(v) The electrochemical stack of any one of embodiments (a)-(u), wherein the seal has a height in the range of about 100 μm and about 200 μm.
(w) The electrochemical stack of embodiment (v), wherein the seal is about 150 μm in height.
(w.1) The electrochemical stack of any one of embodiments (a)-(w), wherein the seal exhibits a peel strength between 22N/25 mm and 50N/25 mm following a 180-degree peel at room temperature as measured by the ASTM D3330 test.
(w.2) The electrochemical stack of any one of embodiments (a)-(w), wherein the seal exhibits a peel strength between 22N/25 mm and 40N/25 mm following a 180-degree peel at room temperature as measured by the ASTM D3330 test.
(w.3) The electrochemical stack of any one of embodiments (a)-(w), wherein the seal exhibits a peel strength between 25N/25 mm and 35N/25 mm following a 180-degree peel at room temperature as measured by the ASTM D330 test.
(w.4) The electrochemical stack of any one of embodiments (a)-(w), wherein the seal exhibits a peel strength of 28N/25 mm following a 180-degree peel at room temperature as measured by the ASTM D3330 test.
(x) An electrochemical stack comprising:
   a cathode comprising a catholyte; and
   a seal between and contacting a thin film solid-state electrolyte separator and the cathode;
   wherein the cathode geometric surface area is less than the separator geometric surface area; and
   wherein the seal comprises an inner seal and an outer seal.
(x.1) An electrochemical stack comprising:
   a cathode comprising a catholyte;
   a solid-state electrolyte separator comprising two major surfaces and four minor surfaces; and
   a seal between a first major surface of the separator and the cathode and within 0.1 mm to 2 mm from a perimeter of the first major surface;
   wherein the seal does not contact the perimeter of the first major surface, the second major surface, or the minor surfaces of the separator;
   wherein the cathode geometric surface area is less than the separator geometric surface area; and
   wherein the seal comprises an inner seal and an outer seal and wherein the outer seal comprises crosslinked polyisobutylene (PIB).
(y) The electrochemical stack of embodiment (x) or (x.1), wherein the inner seal is a perimeter seal.
(z) The electrochemical stack of embodiment (x), (x.1), or (y), wherein the outer seal is a perimeter seal.
(aa) The electrochemical stack of any one of embodiments (x)-(z), wherein the inner seal comprises a thermoplastic polymer.
(bb) The electrochemical stack of any one of embodiments (x)-(aa), wherein the inner seal comprises polyisobutylene (PIB), polyisoprene, or a mixture thereof.
(cc) The electrochemical stack of embodiment (bb), wherein the inner seal comprises polyisobutylene (PIB).
(dd) The electrochemical stack of any one of embodiments (x)-(aa), wherein the inner seal consists essentially of polyisobutylene (PIB), polyisoprene, or a mixture thereof.
(ee) The electrochemical stack of embodiment (dd), wherein the inner seal consists essentially of polyisobutylene (PIB).
(ff) The electrochemical stack of any one of embodiments (x)-(ee), wherein the seal comprises one inner seal.
(gg) The electrochemical stack of any one of embodiments (x)-(ee), wherein the seal comprises two inner seals.
(hh) The electrochemical stack of any one of embodiments (x)-(gg), wherein the inner seal is dispensed from a liquid reservoir.
(ii) The electrochemical stack of any one of embodiments (x)-(hh), wherein the outer seal is dispensed from a liquid reservoir.
(jj) The electrochemical stack of any one of embodiments (x)-(ii), wherein the outer seal is ultraviolet (UV)-cured.
(jj.1) The electrochemical stack of embodiment (jj), wherein the UV-curing comprises radiating the out seal with UVA, UVB, UVC wavelengths, or a combination thereof.
(jj.2) The electrochemical stack of embodiment (jj) or (jj.1), wherein the UV-curing comprises radiating the out seal with UVA wavelengths.
(jj.3) The electrochemical stack of embodiment (jj) or (jj.1), wherein the UV-curing comprises radiating the out seal with UVB wavelengths.
(jj.4) The electrochemical stack of embodiment (jj) or (jj.1), wherein the UV-curing comprises radiating the out seal with UVC wavelengths.
(jj.5) The electrochemical stack of embodiment (jj) or (jj.1), wherein the UV-curing comprises radiating the out seal with UVA and UVB wavelengths.
(jj.6) The electrochemical stack of embodiment (jj) or (jj.1), wherein the UV-curing comprises radiating the out seal with UVA and UVC wavelengths.
(jj.7) The electrochemical stack of embodiment (jj) or (jj.1), wherein the UV-curing comprises radiating the out seal with UVB and UVC wavelengths.
(jj.8) The electrochemical stack of any one of embodiments (jj), (jj.1), (jj.2), (jj.5), and (jj.6), wherein the UVA intensity is between 950 and 900 mW/cm².
(jj.9) The electrochemical stack of any one of embodiments (jj), (jj.1), (jj.3), (jj.5), and (jj.7), wherein the UVB intensity is between 875 and 800 mW/cm².
(jj.10) The electrochemical stack of any one of embodiments (jj), (jj.1), (jj.4), (jj.6) and (jj.7), wherein the UVC intensity is between 450 and 375 mW/cm².
(jj.11) The electrochemical stack of any one of embodiments (jj), (jj.1), (jj.2), (jj.5), (jj.6), and (jj.8), wherein the dosage of UVA is between 880 and 800 mJ/cm².
(jj.12) The electrochemical stack of any one of embodiments (jj), (jj.1), (jj.3), (jj.5), (jj.7), and (jj.9), wherein dosage of UVB is between 800 and 750 mJ/cm².
(jj.13) The electrochemical stack of any one of embodiments (jj), (jj.1), (jj.4), (jj.6), (jj.7), and (jj.10), wherein the dosage of UVC is between 400 and 300 mJ/cm².
(jj.14) The electrochemical stack of embodiment (jj), wherein the UV-curing comprises radiating the out seal with UVA, UVB, and UVC wavelengths.
(jj.15) The electrochemical stack of embodiments (jj), (jj.1), or (jj.14), wherein the UVA intensity is between 950 and 900 mW/cm²; the UVB intensity is between 875 and 800 mW/cm²; and the UVC intensity is between 450 and 375 mW/cm².
(jj.16) The electrochemical stack of any one of embodiments (jj), (jj.1), (jj.14), and (jj.15), wherein the UVA intensity is about 922 mW/cm²; the UVB intensity is about 864 mW/cm²; and the UVC intensity is about 396 mW/cm².
(jj.17) The electrochemical stack of any one of embodiments (jj), (jj.1), and (jj.14)-(jj.16), wherein the dosage of UVA is between 880 and 800 mJ/cm²; the dosage of UVB is between 800 and 750 mJ/cm²; and the dosage of UVC is between 400 and 300 mJ/cm².
(jj.18) The electrochemical stack of any one of embodiments (jj), (jj.1), and (jj.14)-(jj.17), wherein the dosage of UVA is about 840 mJ/cm²; the dosage of UVB is about 773 mJ/cm²; and the dosage of UVC is about 361 mJ/cm².
(jj.19) The electrochemical stack of any one of embodiments (jj)-(jj.18), wherein the outer seal is UV-cured for about ten seconds.
(kk) The electrochemical stack of any one of embodiments (x)-(ii), wherein the outer seal is heat-cured.
(ll) The electrochemical stack of any one of embodiments (x)-(kk), wherein the outer seal comprises photo-crosslinked PIB that is photo-crosslinked from a monomer having a structure of Formula (I):

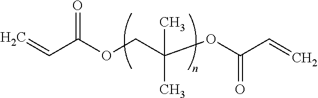

wherein n is an integer from 5 to 50.
(ll.1) The electrochemical stack of any one of embodiments (x)-(kk), wherein the outer seal comprises photo-crosslinked PIB that is photo-crosslinked from a monomer having a structure of Formula (I):

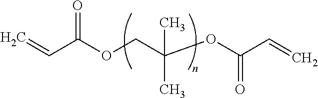

wherein n is an integer from 1 to 100.
(mm) The electrochemical stack of any one of embodiments (x)-(kk), wherein the (mm) outer seal consists essentially of photo-crosslinked PIB that is photo-crosslinked from a monomer having a structure of Formula (I):

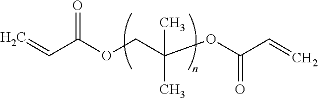

wherein n is an integer from 5 to 50.

(mm.1) The electrochemical stack of any one of embodiments (x)-(kk), wherein the outer seal consists essentially of photo-crosslinked PIB that is photo-crosslinked from a mixture of monomers having a structure of Formula (I):

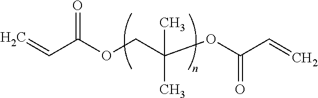

wherein n is an integer from 1 to 100.
(nn) The electrochemical stack of any one of embodiments (x)-(mm.1), wherein the distance between the edge of the cathode and the outside edge of the outer seal is equal to, or less than, 5 mm.
(oo) The electrochemical stack of any one of embodiments (x)-(nn), wherein the distance between the edge of the cathode and the outside edge of the outer seal is equal to, or less than, 3 mm.
(pp) The electrochemical stack of any one of embodiments (x)-(oo), wherein the distance between the edge of the cathode and the outside edge of the outer seal is about 2 mm to about 2.5 mm.
(qq) The electrochemical stack of any one of embodiments (x)-(pp), wherein the distance between the edge of the cathode and the outside edge of the outer seal is about 2.5 mm.
(rr) The electrochemical stack of any one of embodiments (x)-(pp), wherein the distance between the edge of the cathode and the outside edge of the outer seal is about 2.3 mm.
(rr.1) The electrochemical stack of any one of embodiments (x)-(pp), wherein the distance between the edge of the cathode and the outside edge of the outer seal is about 0.1 mm to 1 mm.
(rr.2) The electrochemical stack of any one of embodiments (x)-(pp), wherein the distance between the edge of the cathode and the outside edge of the outer seal is about 0.4 mm to 0.8 mm.
(rr.3) The electrochemical stack of any one of embodiments (x)-(pp), wherein the distance between the edge of the cathode and the outside edge of the outer seal is about 0.5 mm.
(ss) The electrochemical stack of any one of c embodiments (x)-(rr.3), wherein the inner seal and the outer seal each independently have a width in the range of about 0.8 mm and about 1.2 mm.
(tt) The electrochemical stack of embodiment (ss), wherein the inner seal and the outer seal are each about 1 mm in width.
(uu) The electrochemical stack of any embodiments (x)-(tt), wherein the inner seal and the outer seal each independently have a height in the range of about 100 μm and about 200 μm.
(vv) The electrochemical stack of embodiment (uu), wherein the inner seal and the outer seal are each about 150 μm in height.
(vv.1) The electrochemical stack of any one of embodiments (x)-(vv), wherein the outer seal exhibits a peel strength between 22N/25 mm and 50N/25 mm following a 180-degree peel at room temperature.
(vv.2) The electrochemical stack of any one of embodiments (x)-(vv), wherein the outer seal exhibits a peel strength between 22N/25 mm and 40N/25 mm following a 180-degree peel at room temperature.
(vv.3) The electrochemical stack of any one of embodiments (x)-(vv), wherein the outer seal exhibits a peel strength between 25N/25 mm and 35N/25 mm following a 180-degree peel at room temperature.
(ww) (vv.4) The electrochemical stack of any one of embodiments (x)-(vv), wherein the outer seal exhibits a peel strength of about 28N/25 mm following a 180-degree peel at room temperature. The electrochemical stack of any one of embodiments (a)-(vv.4), further comprising an electrolyte between the separator and the cathode wherein the electrolyte comprises a solvent selected from the group consisting of ethylene sulfite, sulfolane, and combinations thereof.
(xx) The electrochemical stack of embodiment (ww), wherein the electrolyte further comprises a lithium salt at concentration of less than about 2 M.
(yy) The electrochemical stack of embodiment (xx), wherein the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiI, LiBr, LiCl, and combinations thereof.
(zz) The electrochemical stack of any one of embodiments (ww)-(yy), wherein the electrolyte does not contact the outer seal.
(zz.1) The electrochemical stack of any one of embodiments (a)-(zz), wherein the cathode in the electrochemical stack has the dimension of about 57 mm by 72 mm and the solid-state electrolyte separator has the dimension of about 60×75 mm.
(aaa) A process for sealing a cathode to a solid-state electrolyte separator, comprising providing a seam between a cathode and a solid-state electrolyte separator wherein the seam comprises an acryloyl group-terminated monomer and a tackifier; and UV-curing, heat-curing, or UV-curing and heat-curing the seam to form a seal that comprises photo-crosslinked polyisobutylene (PIB) and tackifier.
(bbb) The process of embodiment (aaa), wherein the seal is a perimeter seal.
(ccc) The process of embodiment (aaa) or (bbb), comprising dispensing the seam from a liquid reservoir.
(ddd) The process of any one of embodiments (aaa)-(ccc), wherein the seam is ultraviolet (UV)-cured.
(ddd.1) The process of embodiment (ddd), wherein the UV-curing comprises radiating the seam with UVA, UVB, UVC wavelengths, or a combination thereof.
(ddd.2) The process of embodiment (ddd) or (ddd.1), wherein the UV-curing comprises radiating the seam with UVA wavelengths.
(ddd.3) The process of embodiment (ddd) or (ddd.1), wherein the UV-curing comprises radiating the seam with UVB wavelengths.
(ddd.4) The process of embodiment (ddd) or (ddd.1), wherein the UV-curing comprises radiating the seam with UVC wavelengths.
(ddd.5) The process of embodiment (ddd) or (ddd.1), wherein the UV-curing comprises radiating the seam with UVA and UVB wavelengths.
(ddd.6) The process of embodiment (ddd) or (ddd.1), wherein the UV-curing comprises radiating the seam with UVA and UVC wavelengths.
(ddd.7) The process of embodiment (ddd) or (ddd.1), wherein the UV-curing comprises radiating the seam with UVB and UVC wavelengths.
(ddd.8) The process of any one of embodiments (ddd), (ddd.1), (ddd.2), (ddd.5), and (ddd.6), wherein the UVA intensity is between 950 and 900 mW/cm².
(ddd.9) The process of any one of embodiments (ddd), (ddd.1), (ddd.3), (ddd.5), and (ddd.7), wherein the UVB intensity is between 875 and 800 mW/cm².
(ddd.10) The process of any one of embodiments (ddd), (ddd.1), (ddd.4), (ddd.6) and (ddd.7), wherein the UVC intensity is between 450 and 375 mW/cm².
(ddd.11) The process of any one of embodiments (ddd), (ddd.1), (ddd.2), (ddd.5), (ddd.6), and (ddd.8), wherein the dosage of UVA is between 880 and 800 mJ/cm².
(ddd.12) The process of any one of embodiments (ddd), (ddd.1), (ddd.3), (ddd.5), (ddd.7), and (ddd.9), wherein dosage of UVB is between 800 and 750 mJ/cm².
(ddd.13) The process of any one of embodiments (ddd), (ddd.1), (ddd.4), (ddd.6), (ddd.7), and (ddd.10), wherein the dosage of UVC is between 400 and 300 mJ/cm².
(ddd.14) The process of embodiment (ddd) or (ddd.1), wherein the UV-curing comprises radiating the seam with UVA, UVB, and UVC wavelengths.
(ddd.15) The process of embodiments (ddd), (ddd.1), or (ddd.14), wherein the UVA intensity is between 950 and 900 mW/cm²; the UVB intensity is between 875 and 800 mW/cm²; and the UVC intensity is between 450 and 375 mW/cm².
(ddd.16) The process of any one of embodiments (ddd), (ddd.1), (ddd.14), and (ddd.15), wherein the UVA intensity is about 922 mW/cm²; the UVB intensity is about 864 mW/cm²; and the UVC intensity is about 396 mW/cm².
(ddd.17) The process of any one of embodiments (ddd), (ddd.1), and (ddd.14)-(ddd.16), wherein the dosage of UVA is between 880 and 800 mJ/cm²; the dosage of UVB is between 800 and 750 mJ/cm²; and the dosage of UVC is between 400 and 300 mJ/cm².
(ddd.18) The process of any one of embodiments (ddd), (ddd.1), and (ddd.14)-(ddd.17), wherein the dosage of UVA is about 840 mJ/cm²; the dosage of UVB is about 773 mJ/cm²; and the dosage of UVC is about 361 mJ/cm². (ddd.19) The electrochemical stack of any one of embodiments (ddd)-(ddd.18), wherein the seam is UV-cured for about ten seconds.
(eee) The process of any one of embodiments (aaa)-(ccc), wherein the seam is heat-cured.
(fff) The process of any one of embodiments (aaa)-(eee), wherein the seal comprises photo-crosslinked PIB that is photo-crosslinked from a monomer having a structure of Formula (I):

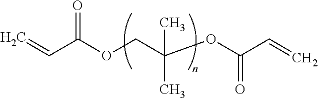

wherein n is an integer from 5 to 50.
(fff.1) The process of any one of embodiments (aaa)-(eee), wherein the seal comprises photo-crosslinked PIB that is photo-crosslinked from a monomer having a structure of Formula (I):

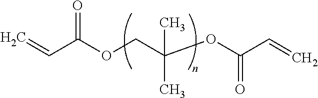

wherein n is an integer from 1 to 100.
(ggg) The process of any one of embodiments (aaa)-(fff.1), wherein the tackifier comprises polyisobutylene (PIB) with a molecular weight of about 10,000 g/mol to 40,000 g/mol.
(hhh) The process of embodiment (ggg) wherein the tackifier comprises PIB with a molecular weight of about 25,000 g/mol.
(hhh.1) The electrochemical stack of any one of embodiments (aaa)-(fff.1), wherein the tackifier comprises PIB with a molecular weight of about 100 g/mol to 500 g/mol.
(hhh.2) The electrochemical stack of any one of embodiments (aaa)-(fff.1), wherein the tackifier comprises PIB with a molecular weight of about 100 g/mol to 300 g/mol.
(hhh.3) The electrochemical stack of any one of embodiments (aaa)-(fff.1), wherein the tackifier comprises PIB with a molecular weight of about 250 g/mol to 500 g/mol.
(iii) The process of any one of embodiments (aaa)-(hhh.3), wherein the seal comprises at least about 95% w/w of the photo-crosslinked PIB.
(jjj) The process of embodiment (iii), wherein the seal comprises about 99% w/w of the photo-crosslinked PIB.
(kkk) The process of any one of embodiments (aaa)-(kkk), wherein the seal comprises no more than about 5% w/w of the tackifier.
(kkk.1) The process of any one of embodiments (aaa)-(kkk), wherein the seal exhibits a peel strength between 22N/25 mm and 50N/25 mm following a 180-degree peel at room temperature as measured by the ASTM D3330 test.
(kkk.2) The process of any one of embodiments (aaa)-(kkk), wherein the seal exhibits a peel strength between 22N/25 mm and 40N/25 mm following a 180-degree peel at room temperature as measured by the ASTM D3330 test.
(kkk.3) The process of any one of embodiments (aaa)-(kkk), wherein the seal exhibits a peel strength between 25N/25 mm and 35N/25 mm following a 180-degree peel at room temperature as measured by the ASTM D3330 test.
(kkk.4) The process of any one of embodiments (aaa)-(kkk.1), wherein the seal exhibits a peel strength of about 28N/25 mm following a 180-degree peel at room temperature as measured by the ASTM D3330 test.
(kkk.5) The process of any one of embodiments (aaa)-(kkk.4), wherein the cathode has the dimension of about 57 mm by 72 mm and the solid-state electrolyte separator has the dimension of about 60×75 mm.
(lll) A process for sealing a cathode to a solid-state electrolyte separator, comprising providing a seam between a cathode and a solid-state electrolyte separator wherein the seam comprises an inner seam and an outer seam; vacuum sealing the inner seam to form an inner seal; and UV-curing, heat-curing, or UV-curing and heat-curing the outer seam to form an outer seal.
(mmm) The process of embodiment (lll), wherein the inner seal is a perimeter seal.
(nnn) The process of embodiment (lll) or (mmm), wherein the outer seal is a perimeter seal.
(ooo) The process of any one of embodiments (lll)-(nnn), wherein the inner seal comprises a thermoplastic polymer.
(ppp) The process of any one of embodiments (lll)-(ooo), wherein the inner seal comprises polyisobutylene (PIB), polyisoprene, or a mixture thereof.
(qqq) The process of embodiment (ppp), wherein the inner seal comprises polyisobutylene (PIB).
(rrr) The process of any one of embodiments (lll)-(ooo), wherein the inner seal consists essentially of polyisobutylene (PIB), polyisoprene, or a mixture thereof.
(sss) The process of embodiment (rrr), wherein the inner seal consists essentially of polyisobutylene (PIB).
(ttt) The process of any one of embodiments (lll)-(sss), wherein the seal comprises one inner seal.
(uuu) The process of any one of embodiments (lll)-(sss), wherein the seal comprises two inner seals.
(vvV) The process of any one of embodiments (lll)-(uuu), comprising dispensing the inner seam from a liquid reservoir.
(www) The process of any one of embodiments (lll)-(vvv), comprising dispensing the outer seam from a liquid reservoir.
(xxx) The process of any one of embodiments (lll)-(www), wherein the outer seam is ultraviolet (UV)-cured.
(xxx.1) The process of embodiment (xxx), wherein the UV-curing comprises radiating the outer seam with UVA, UVB, UVC wavelengths, or a combination thereof.
(xxx.2) The process of embodiment (xxx) or (xxx.1), wherein the UV-curing comprises radiating the outer seam with UVA wavelengths.
(xxx.3) The process of embodiment (xxx) or (xxx.1), wherein the UV-curing comprises radiating the outer seam with UVB wavelengths.
(xxx.4) The process of embodiment (xxx) or (xxx.1), wherein the UV-curing comprises radiating the outer seam with UVC wavelengths.
(xxx.5) The process of embodiment (xxx) or (xxx.1), wherein the UV-curing comprises radiating the outer seam with UVA and UVB wavelengths.
(xxx.6) The process of embodiment (xxx) or (xxx.1), wherein the UV-curing comprises radiating the outer seam with UVA and UVC wavelengths.
(xxx.7) The process of embodiment (xxx) or (xxx.1), wherein the UV-curing comprises radiating the outer seam with UVB and UVC wavelengths.
(xxx.8) The process of any one of embodiments (xxx), (xxx.1), (xxx.2), (xxx.5), and (xxx.6), wherein the UVA intensity is between 950 and 900 mW/cm².
(xxx.9) The process of any one of embodiments (xxx), (xxx.1), (xxx.3), (xxx.5), and (xxx.7), wherein the UVB intensity is between 875 and 800 mW/cm².
(xxx.10) The process of any one of embodiments (xxx), (xxx.1), (xxx.4), (xxx.6) and (xxx.7), wherein the UVC intensity is between 450 and 375 mW/cm².
(xxx.11) The process of any one of embodiments (xxx), (xxx.1), (xxx.2), (xxx.5), (xxx.6), and (xxx.8), wherein the dosage of UVA is between 880 and 800 mJ/cm².
(xxx.12) The process of any one of embodiments (xxx), (xxx.1), (xxx.3), (xxx.5), (xxx.7), and (xxx.9), wherein dosage of UVB is between 800 and 750 mJ/cm².
(xxx.13) The process of any one of embodiments (xxx), (xxx.1), (xxx.4), (xxx.6), (xxx.7), and (xxx.10), wherein the dosage of UVC is between 400 and 300 mJ/cm².
(xxx.14) The process of embodiment (xxx) or (xxx.1), wherein the UV-curing comprises radiating the outer seam with UVA, UVB, and UVC wavelengths.
(xxx.15) The process of embodiments (xxx), (xxx.1), or (xxx.14), wherein the UVA intensity is between 950 and 900 mW/cm²; the UVB intensity is between 875 and 800 mW/cm²; and the UVC intensity is between 450 and 375 mW/cm².
(xxx.16) The process of any one of embodiments (xxx), (xxx.1), (xxx.14), and (xxx.15), wherein the UVA intensity is about 922 mW/cm²; the UVB intensity is about 864 mW/cm²; and the UVC intensity is about 396 mW/cm².
(xxx.17) The process of any one of embodiments (xxx), (xxx.1), and (xxx.14)-(xxx.16), wherein the dosage of UVA is between 880 and 800 mJ/cm²; the dosage of UVB is between 800 and 750 mJ/cm²; and the dosage of UVC is between 400 and 300 mJ/cm².
(xxx.18) The process of any one of embodiments (xxx), (xxx.1), and (xxx.14)-(xxx.17), wherein the dosage of UVA is about 840 mJ/cm²; the dosage of UVB is about 773 mJ/cm²; and the dosage of UVC is about 361 mJ/cm². (xxx.19) The electrochemical stack of any one of embodiments (xxx)-(xxx.18), wherein the seam is UV-cured for about ten seconds.
(yyy) The process of any one of embodiments (lll)-(www), wherein the outer seam is heat-cured.
(zzz) The process of any one of embodiments (lll)-(yyy), wherein the photo-crosslinked PIB is photo-crosslinked from a monomer having a structure of Formula (I):

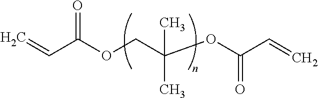

wherein n is an integer from 5 to 50.
(zzz.1) The process of any one of embodiments (lll)-(yyy), wherein the photo-crosslinked PIB is photo-crosslinked from a mixture of monomers having a structure of Formula (I):

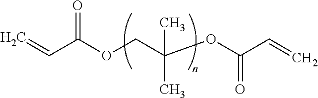

wherein n is an integer from 1 to 100.
(zzz.1) The process of any one of embodiments (lll)-(zzz), wherein the outer seal exhibits a peel strength between 22N/25 mm and 50N/25 mm following a 180 degree peel at room temperature as measured by the ASTM D3330 test.
(zzz.2) The process of any one of embodiments (lll)-(zzz), wherein the outer seal exhibits a peel strength between 22N/25 mm and 40N/25 mm following a 180 degree peel at room temperature as measured by the ASTM D3330 test.
(zzz.3) The process of any one of embodiments (lll)-(zzz), wherein the outer seal exhibits a peel strength between 25N/25 mm and 35N/25 mm following a 180 degree peel at room temperature as measured by the ASTM D3330 test.
(zzz.4) The process of any one of embodiments (lll)-(zzz.1), wherein the outer seal exhibits a peel strength of about 28N/25 mm following a 180 degree peel at room temperature as measured by the ASTM D3330 test.
(zzz.5) The process of any one of embodiments (lll)-(zzz.4), wherein the cathode has the dimension of about 57 mm by 72 mm and the solid-state electrolyte separator has the dimension of about 60×75 mm.
(aaaa) A process of making an electrochemical stack comprising:
   a. dispensing a UV-curable or heat-curable seam on the solid-state electrolyte separator wherein the seam comprises an acryloyl group-terminated monomer, a tackifier, an anti-oxidant, and at least one photo initiator;
   b. joining together a cathode comprising a catholyte and the solid-state electrolyte separator wherein the UV-curable or heat-curable seam are in contact with the cathode; and
   c. UV-curing, heat-curing, or UV-curing and heat-curing the seam to form a UV- and/or heat-cured seal comprising photo-crosslinked polyisobutylene (PIB) and tackifier between the cathode and the separator.
(bbbb) The process of embodiment (aaaa), wherein the seam is a perimeter seal.
(cccc) The process of embodiment (aaaa) or (bbbb), wherein the acryloyl group-terminated monomer is of Formula (I):

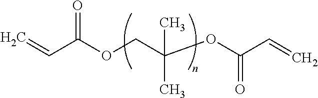

wherein n is an integer from 5 to 50.
(cccc.1) The process of embodiment (aaaa) or (bbbb), wherein the acryloyl group-terminated monomer is of Formula (I):

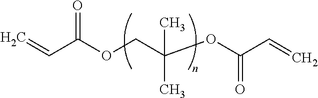

wherein n is an integer from 1 to 100.
(dddd) The process of any one of embodiments (aaaa)-(cccc.1), wherein the tackifier comprises polyisobutylene (PIB) with a molecular weight of about 10,000 g/mol to 40,000 g/mol.
(eeee) The process of embodiment (dddd), wherein the tackifier comprises PIB with a molecular weight of about 25,000 g/mol.
(eeee.1) The process of any one of embodiments (aaaa)-(cccc.1), wherein the tackifier comprises polyisobutylene (PIB) with a molecular weight of about 100 g/mol to 500 g/mol.
(ffff) The process of any one of embodiments (aaaa)-(eeee.1), wherein the seal comprises at least about 95% w/w of the photo-crosslinked PIB.
(gggg) The process of embodiment (ffff), wherein the seal comprises about 99% w/w of the photo-crosslinked PIB.
(hhhh) The process of any one of embodiments (aaaa)-(gggg), wherein the seal comprises no more than about 5% w/w of the tackifier.
(iiii) The process of any one of embodiments (aaaa)-(hhhh), wherein prior to (b), electrolyte is added to the surface of the film with the seam.
(jjjj) The process of any one of embodiments (aaaa)-(iiii), wherein the seal has a width in the range of about 0.8 mm and 1.2 mm.
(kkkk) The process of embodiment (jjjj), wherein the seal is about 1 mm in width.
(llll) The process of any one of embodiments (aaaa)-(kkkk), wherein the seal has a height in the range of about 100 μm and 200 μm.
(mmmm) The process of embodiment (llll), wherein the seal is about 150 μm in height.
(mmmm.1) The process of any one of embodiments (aaaa)-(mmmm), wherein the seam is ultraviolet (UV)-cured.
(mmmm.2) The process of embodiment (mmmm.1), wherein the UV-curing comprises radiating the seam with UVA, UVB, UVC wavelengths, or a combination thereof.
(mmmm.3) The process of embodiment (mmmm.1) or (mmmm.2), wherein the UV-curing comprises radiating the seam with UVA wavelengths.
(mmmm.4) The process of embodiment (mmmm.1) or (mmmm.2), wherein the UV-curing comprises radiating the seam with UVB wavelengths.
(mmmm.5) The process of embodiment (mmmm.1) or (mmmm.2), wherein the UV-curing comprises radiating the seam with UVC wavelengths.
(mmmm.6) The process of embodiment (mmmm.1) or (mmmm.2), wherein the UV-curing comprises radiating the seam with UVA and UVB wavelengths.
(mmmm.7) The process of embodiment (mmmm.1) or (mmmm.2), wherein the UV-curing comprises radiating the seam with UVA and UVC wavelengths.
(mmmm.8) The process of embodiment (mmmm.1) or (mmmm.2), wherein the UV-curing comprises radiating the seam with UVB and UVC wavelengths.
(mmmm.9) The process of any one of embodiments (mmmm.1), (mmmm.2), (mmmm.3), (mmmm.6), and (mmmm.7), wherein the UVA intensity is between 950 and 900 mW/cm².
(mmmm.10) The process of any one of embodiments (mmmm.1), (mmmm.2), (mmmm.4), (mmmm.6), and (mmmm.8), wherein the UVB intensity is between 875 and 800 mW/cm².
(mmmm.11) The process of any one of embodiments (mmmm.1), (mmmm.2), (mmmm.5), (mmmm.7) and (mmmm.8), wherein the UVC intensity is between 450 and 375 mW/cm².
(mmmm.12) The process of any one of embodiments (mmmm.1), (mmmm.2), (mmmm.3), (mmmm.6), (mmmm.7), and (mmmm.9), wherein the dosage of UVA is between 880 and 800 mJ/cm².
(mmmm.13) The process of any one of embodiments (mmmm.1), (mmmm.2), (mmmm.4), (mmmm.6), (mmmm.8), and (mmmm.10), wherein dosage of UVB is between 800 and 750 mJ/cm².
(mmmm.14) The process of any one of embodiments (mmmm.1), (mmmm.2), (mmmm.5), (mmmm.7), (mmmm.8) and (mmmm.11), wherein the dosage of UVC is between 400 and 300 mJ/cm².
(mmmm.15) The process of embodiment (mmmm.1) or (mmmm.2), wherein the UV-curing comprises radiating the seam with UVA, UVB, and UVC wavelengths.
(mmmm.16) The process of embodiments (mmmm.1), (mmmm.2), or (mmmm.15), wherein the UVA intensity is between 950 and 900 mW/cm²; the UVB intensity is between 875 and 800 mW/cm²; and the UVC intensity is between 450 and 375 mW/cm².
(mmmm.17) The process of any one of embodiments (mmmm.1), (mmmm.2), (mmmm.15), and (mmmm.16), wherein the UVA intensity is about 922 mW/cm²; the UVB intensity is about 864 mW/cm²; and the UVC intensity is about 396 mW/cm².
(mmmm.18) The process of any one of embodiments (mmmm.1), (mmmm.2), and (mmmm.15)-(mmmm.17), wherein the dosage of UVA is between 880 and 800 mJ/cm²; the dosage of UVB is between 800 and 750 mJ/cm²; and the dosage of UVC is between 400 and 300 mJ/cm².
(mmmm.19) The process of any one of embodiments (mmmm.1), (mmmm.2), and (mmmm.15)-(mmmm.18), wherein the dosage of UVA is about 840 mJ/cm²; the dosage of UVB is about 773 mJ/cm²; and the dosage of UVC is about 361 mJ/cm².
(mmmm.20) The electrochemical stack of any one of embodiments (mmmm.1)-(mmmm.19), wherein the seam is UV-cured for about ten seconds.
(mmmm.21) The process of any one of embodiments (aaaa)-(mmmm.20), wherein the seal exhibits a peel strength between 22N/25 mm and 50N/25 mm following a 180-degree peel at room temperature as measured by the ASTM D3330 test.
(mmmm.22) The process of any one of embodiments (aaaa)-(mmmm.21), wherein the seal exhibits a peel strength between 22N/25 mm and 40N/25 mm following a 180-degree peel at room temperature as measured by the ASTM D3330 test.
(mmmm.23) The process of any one of embodiments (aaaa)-(mmmm.22), wherein the seal exhibits a peel strength between 25N/25 mm and 35N/25 mm following a 180-degree peel at room temperature as measured by the ASTM D3330 test.
(mmmm.24) The process of any one of embodiments (aaaa)-(mmmm.23), wherein the seal exhibits a peel strength of about 28N/25 mm following a 180-degree peel at room temperature as measured by the ASTM D3330 test.
(mmmm.25) The process of any one of embodiments (aaaa)-(mmmm.24), wherein the cathode has the dimension of about 57 mm by 72 mm and the solid-state electrolyte separator has the dimension of about 60×75 mm.
(nnnn) A process of making an electrochemical stack comprising:
   a. dispensing at least one inner seam comprising a thermoplastic polymer onto a thin film solid-state electrolyte separator;
   b. dispensing an outer UV-curable or heat-curable seam on the solid-state electrolyte separator wherein the seam comprises an acryloyl group-terminated monomer, a (meth)acrylic monomer, an anti-oxidant, and at least one photo initiator;
   c. joining together a cathode comprising a catholyte and the solid-state electrolyte separator wherein the at least one inner thermoplastic polymer seam and the outer UV-curable or heat-curable seam are in contact with the cathode and wherein the at least one inner seam forms a seal comprising the thermoplastic polymer with the cathode; and
   d. UV-curing, heat-curing, or UV- and heat-curing the outer seam to form an outer UV-cured and/or heat-cured outer seal comprising photo-crosslinked polyisobutylene (PIB) between the cathode and the separator.
(oooo) The process of embodiment (nnnn), wherein the inner seam is a perimeter seal.
(pppp) The process of embodiment (nnnn) or (oooo), wherein the outer seam is a perimeter seal.
(qqqq) The process of any one of embodiments (nnnn)-(pppp), wherein the cathode and the separator are joined together in (c) under vacuum.
(rrrr) The process of any one of embodiments (nnnn)-(qqqq), wherein the outer UV-curable seam comprises:
   a monomer having a structure of Formula (I):

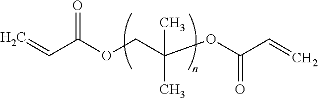

wherein n is an integer from 5 to 50;
(meth)acrylic monomer of Formula (II):

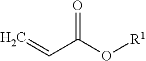

wherein R¹ is C₁₋₃₀alkyl or C₃₋₁₀cycloalkyl;
an anti-oxidant, and at least one photo initiator.
(rrrr.1) The process of any one of embodiments (nnnn)-(qqqq), wherein the outer UV-curable seam comprises:
   a mixture of monomers having a structure of Formula (I):

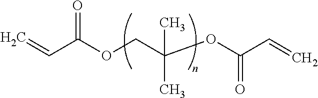

wherein n is an integer from 1 to 100;
(meth)acrylic monomer of Formula (II):

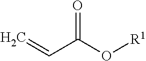

wherein R¹ is C₁₋₃₀alkyl or C₃₋₁₀cycloalkyl;
an anti-oxidant, and at least one photo initiator.
(ssss) The process of embodiment (rrrr) or (rrrr.1), wherein the (meth)acrylic monomer of Formula (II) is lauryl acrylate.
(tttt) The process of any one of embodiments (nnnn)-(ssss), wherein prior to (c), electrolyte is added to the surface of the film with the inner seam and the outer UV-curable or heat-curable seam and wherein the electrolyte does not contact the outer seam.
(uuuu) The process of any one of embodiments (nnnn)-(tttt), wherein the inner seal and the UV-cured or heat-cured seal each independently have a width in the range of about 0.8 mm and 1.2 mm.
(vvvv) The process of embodiment (uuuu), wherein the inner seal and the UV-cured or heat-cured seal are each about 1 mm in width.
(wwww) The process of any one of embodiments (nnnn)-(vvvv), wherein the inner seal and the UV-cured or heat-cured seal each independently have a height in the range of about 100 μm and 200 μm.
(xxxx) The process of embodiment (wwww), wherein the inner seal and the UV-cured or heat-cured seal are each about 150 μm in height.
(yyyy) The process of any one of embodiments (aaaa)-(xxxx), wherein the UV-curing is conducted using 365 nm UV wavelength.
(zzzz) The process of embodiment (yyyy), wherein the curing time is less than 1 minute.
(aaaaa) The process of embodiment (yyyy), wherein the curing time is less than 30 seconds.
(bbbbb) The process of embodiment (yyyy), wherein the curing time is about 10 seconds.
(ccccc) The process of any one of embodiments (aaaa)-(xxxx), wherein the heat curing is conducted between 35° C. and 45° C.
(ddddd) The process of embodiment (ccccc), wherein the heat curing is conducted at about 40° C.
(eeeee) The process of embodiment (ccccc), wherein the heat curing is conducted at about 60° C.
(fffff) The process of any one of embodiments (aaaa)-(eeeee), wherein the distance between the edge of the cathode and the outside edge of the UV-cured and/or heat-cured seal is equal to, or less than, about 5 mm.
(ggggg) The process of any one of embodiments (aaaa)-(eeeee), wherein the distance between the edge of the cathode and the outside edge of the UV-cured and/or heat-cured seal is equal to, or less than, about 3 mm.
(hhhhh) The process of any one of embodiments (aaaa)-(eeeee), wherein the distance between the edge of the cathode and the outside edge of the UV-cured and/or heat-cured seal is about 2.5 mm.
(hhhhh.1) The process of any one of embodiments (aaaa)-(bbbb) and (fffff)-(hhhhh), wherein the UV-curing comprises radiating the outer seam with UVA, UVB, UVC wavelengths, or a combination thereof.
(hhhhh.2) The process of any one of embodiments (aaaa)-(bbbb) and (fffff)-(hhhhh), wherein the UV-curing comprises radiating the outer seam with UVA wavelengths.
(hhhhh.3) The process of any one of embodiments (aaaa)-(bbbb) and (fffff)-(hhhhh), wherein the UV-curing comprises radiating the outer seam with UVB wavelengths.
(hhhhh.4) The process of any one of embodiments (aaaa)-(bbbb) and (fffff)-(hhhhh), wherein the UV-curing comprises radiating the outer seam with UVC wavelengths.
(hhhhh.5) The process of any one of embodiments (aaaa)-(bbbb) and (fffff)-(hhhhh), wherein the UV-curing comprises radiating the outer seam with UVA and UVB wavelengths.
(hhhhh.6) The process of any one of embodiments (aaaa)-(bbbb) and (fffff)-(hhhhh), wherein the UV-curing comprises radiating the outer seam with UVA and UVC wavelengths.
(hhhhh.7) The process of any one of embodiments (aaaa)-(bbbb) and (fffff)-(hhhhh), wherein the UV-curing comprises radiating the outer seam with UVB and UVC wavelengths.
(hhhhh.8) The process of any one of embodiments (aaaa)-(bbbb), (fffff)-(hhhhh.1), (hhhhh.2), (hhhhh.5), and (hhhhh.6), wherein the UVA intensity is between 950 and 900 mW/cm².
(hhhhh.9) The process of any one of embodiments (aaaa)-(bbbb), (fffff)-(hhhhh.1), (hhhhh.3), (hhhhh.5), and (hhhhh.7), wherein the UVB intensity is between 875 and 800 mW/cm².
(hhhhh.10) The process of any one of embodiments (aaaa)-(bbbb), (fffff)-(hhhhh.1) (hhhhh.4), (hhhhh.6) and (hhhhh.7), wherein the UVC intensity is between 450 and 375 mW/cm².
(hhhhh.11) The process of any one of embodiments (aaaa)-(bbbb), (fffff)-(hhhhh.1) (hhhhh.2), (hhhhh.5), (hhhhh.6), and (hhhhh.8), wherein the dosage of UVA is between 880 and 800 mJ/cm².
(hhhhh.12) The process of any one of embodiments (aaaa)-(bbbb), (fffff)-(hhhhh.1) (hhhhh.3), (hhhhh.5), (hhhhh.7), and (hhhhh.9), wherein dosage of UVB is between 800 and 750 mJ/cm².
(hhhhh.13) The process of any one of embodiments (aaaa)-(bbbb), (fffff)-(hhhhh.1) (hhhhh.4), (hhhhh.6), (hhhhh.7), and (hhhhh.10), wherein the dosage of UVC is between 400 and 300 mJ/cm².
(hhhhh.14) The process of embodiment (aaaa)-(bbbb) and (fffff)-(hhhhh.1), wherein the UV-curing comprises radiating the outer seam with UVA, UVB, and UVC wavelengths.
(hhhhh.15) The process of embodiments (aaaa)-(bbbb), (fffff)-(hhhhh.1), and (hhhhh.14), wherein the UVA intensity is between 950 and 900 mW/cm²; the UVB intensity is between 875 and 800 mW/cm²; and the UVC intensity is between 450 and 375 mW/cm².
(hhhhh.16) The process of any one of embodiments (aaaa)-(bbbb), (fffff)-(hhhhh.1), (hhhhh.14), and (hhhhh.15), wherein the UVA intensity is about 922 mW/cm²; the UVB intensity is about 864 mW/cm²; and the UVC intensity is about 396 mW/cm².
(hhhhh.17) The process of any one of embodiments (aaaa)-(bbbb), (fffff)-(hhhhh.1), and (hhhhh.14)-(hhhhh.16), wherein the dosage of UVA is between 880 and 800 mJ/cm²; the dosage of UVB is between 800 and 750 mJ/cm²; and the dosage of UVC is between 400 and 300 mJ/cm².
(hhhhh.18) The process of any one of embodiments (aaaa)-(bbbb), (fffff)-(hhhhh.1), and (hhhhh.14)-(hhhhh.16), wherein the dosage of UVA is about 840 mJ/cm²; the dosage of UVB is about 773 mJ/cm²; and the dosage of UVC is about 361 mJ/cm².
(hhhhh.19) The electrochemical stack of any one of embodiments (hhhhh.1)-(hhhhh.18), wherein the seam is UV-cured for about ten seconds.
(hhhhh.20) The process of any one of embodiments (aaaaa)-(hhhhh.19), wherein the seal exhibits a peel strength between 22N/25 mm and 50N/25 mm following a 180-degree peel at room temperature as measured by the ASTM D3330 test.
(hhhhh.21) The process of any one of embodiments (aaaaa)-(hhhhh.20), wherein the seal exhibits a peel strength between 22N/25 mm and 40N/25 mm following a 180-degree peel at room temperature as measured by the ASTM D3330 test.
(hhhhh.22) The process of any one of embodiments (aaaaa)-(hhhhh.21), wherein the seal exhibits a peel strength between 25N/25 mm and 35N/25 mm following a 180-degree peel at room temperature as measured by the ASTM D3330 test.
(hhhhh.23) The process of any one of embodiments (aaaaa)-(hhhhh.22), wherein the seal exhibits a peel strength of about 28N/25 mm following a 180-degree peel at room temperature as measured by the ASTM D3330 test.
(hhhhh.24) The process of any one of embodiments (aaaaa)-(hhhhh.23), wherein the cathode has the dimension of about 57 mm by 72 mm and the solid-state electrolyte separator has the dimension of about 60×75 mm.
(iiiii) An electrochemical stack made by the process of any one of embodiments (aaaa)-(hhhhh.24).

### EXAMPLES

Reagents, chemicals, and materials disclosed herein were commercially purchased unless stated otherwise.

Unless specified otherwise, lithium-stuffed garnet films were prepared as follows. A slurry of lithium-stuffed garnet precursor materials were deposited by the doctor-blade method on aluminum-based setters and sintered at 1000° C. to 1300° C. to prepare thin-films of lithium-stuffed garnet that were about 50 microns (μm) in thickness.

Unless specified otherwise, co-sintered films (CSC films) were prepared as follows. A slurry of lithium-stuffed garnet precursor materials were casted onto mylar. A second slurry comprising nickel particles and additional lithium-stuffed garnet precursor materials was deposited (either method of screen-printed or casting) on top of the slurry of lithium-stuffed garnet materials. The resulting CSC bilayer was sintered on aluminum-based setters at 1000° C. to 1300° C. to prepare CSC films that were about 50 microns in thickness.

Unless specified otherwise, bilayer (film on metal foil) were prepared as follows. A slurry of lithium-stuffed garnet precursor materials was cast onto a metal foil and dried to form a green tape. The green tape cast on metal foil (bilayer before sintering) was unrolled and cut to the appropriate dimensions for sintering. This was done using a laser cutter. It is contemplated that a blade blanking tool could also be used. Discrete green sheets were then stacked between setter components and placed on support furniture used with the sintering apparatus. In this case, setter components refer to a dense Al₂O₃ plate onto which the green sheet was placed with the green tape side up, followed by a ceramic or metal frame component, followed by a metal sheet onto which a LiAlO₂ coating has been applied, followed by another dense Al₂O₃ plate.

### Example 1: Seal Process for a Seal Comprising an Inner and Outer Seal

An anode current collector was applied to a lithium-stuffed garnet film with the dimensions of 60 mm×75 mm. Next, an inner seam was dispensed on the lithium-stuffed garnet film and an outer seam was dispensed on the film. Excess liquid electrolyte was added onto the lithium-stuffed garnet film and a cathode with the dimensions of 57 mm×72 mm was placed on the side with the seams.

An inner seam and outer seam were next dispensed on a second lithium-stuffed garnet film. The second lithium-stuffed garnet film was placed on the cathode with the seams making contact with the cathode. The stack was joined under vacuum to seal the inner seams. Lastly, the stack was UV-cured to seal the outer seams.

### Example 2: Seal Process for a Seal Comprising One Seal

An anode current collector was applied to a lithium-stuffed garnet film with the dimensions of 60 mm×75 mm. Next, a seam was dispensed on the film. Excess liquid electrolyte was added onto the lithium-stuffed garnet film and a cathode with the dimensions of 57 mm×72 mm was placed on the side with the seams.

A seam was next dispensed on a second lithium-stuffed garnet film. The second film was placed on the cathode with the seam making contact with the cathode. The stack was UV-cured to seal the seam.

### Example 3: Method 1—Seal Process for a Seal Comprising One Seal

An anode current collector was applied to a first lithium-stuffed garnet film with the dimensions of 60 mm×75 mm. Next a seam mixture comprising an acryloyl group-terminated isobutene monomer, a hydrocarbon resin tackifier, a phenolic antioxidant, and a benzoyl photoinitiator is heated to a temperature of 90° C. in a liquid reservoir. The seam mixture was then dispensed as a ring seam along the perimeter of one of the major surfaces of the lithium-stuffed garnet film at a pressure of 1.5 bar and a dispense speed of 30 mm/s. The dispensed seam had a width of 950 μm and a height of 150 μm. The distance between the outside edge of the seam and the edge of the lithium-stuffed garnet film was 0.15 mm. The distance between the inside edge of the seal and the cathode is 0.5 mm. The seam material was UV cured for about 10s at broad band emitting UV lamp (mercury lamp, with UV intensity measured about 0.95 W/cm²). Excess liquid electrolyte was added onto the lithium-stuffed garnet film and a cathode with the dimensions of 57 mm×72 mm was placed on the side with the seam. A seam was next dispensed on a second lithium-stuffed garnet film similarly to the seam on the first lithium-stuffed garnet film. The second film was placed on the cathode with the film surfaces containing the seams facing each other.

### Example 4: Method 2—Seal Process for a Seal Comprising One Seal

The seal was applied to an electrochemical stack as in Method 1, but UV-cured for 20s.

### Example 5: Method 3—Seal Process for a Seal Comprising One Seal

The seal was applied to an electrochemical stack as in Method 1, but UV-cured for about 30s.

### Example 6: Seal Process for a Seal Comprising an Inner Seal and Outer Seal

An anode current collector was applied to a first lithium-stuffed garnet film with the dimensions of 60 mm×75 mm. Next a seam mixture comprising an acryloyl group-terminated isobutene monomer, a hydrocarbon resin tackifier, a phenolic antioxidant, and a benzoyl photoinitiator is heated to a temperature of 90° C. in a liquid reservoir. The seam mixture was then separately dispensed as two ring seams, an inner seam ring, and an outer seam ring, along the perimeter of the major surface of the lithium-stuffed garnet film. Each ring seam was dispensed at a pressure of 1.8 bar and a dispense speed of 25 mm/s. The inner dispense seam had a width of 900 μm and a height of 150 μm, and the outer dispense seam had a width of 900 μm and a height of 150 μm. The distance between the outside edge of the inner dispense seam and the inside edge of the outer dispense seam was 0.15 mm, and the distance between the outside edge of the outer dispense seam and the edge of the lithium-stuffed garnet film was 0.2 mm. The distance between the inside edge of the inner seal and the cathode is 0.5 mm. The seam material was UV cured for about 10s at broad band emitting UV lamp (mercury lamp, with UV intensity measured about 0.95 W/cm²). Excess liquid electrolyte was added onto the lithium-stuffed garnet film and a cathode with the dimensions of 57 mm×72 mm was placed on the side with the two seams. Two ring seams were dispensed on a second lithium-stuffed garnet film similarly to the seams on the first lithium-stuffed garnet film. The second film was placed on the cathode with the film surfaces containing the seams facing each other.

### Example 7: Performance of Cell Comprising UV-Cured Cathode Seam in a Battery Life Test

A 22-layer cell was assembled using a UV-cured perimeter seal described herein. A battery life test was test was performed and the details of the cell and experiment are provided in table 1 below.

TABLE 1

| Pressure | 0.7 atm (0.07 MPa) | |
|---|---|---|
| Areal Capacity | 6.2 | mAh/cm² |
| Anode | Anode-free Li metal | |
| Depth of Discharge | 100% | |
| Voltage | 3.0-4.25 | V |
| Area | 60 × 75-70 × 85 | mm |

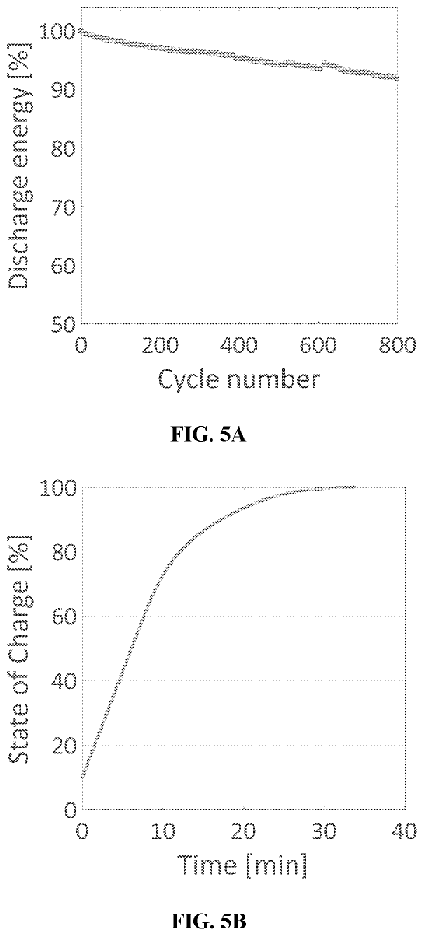

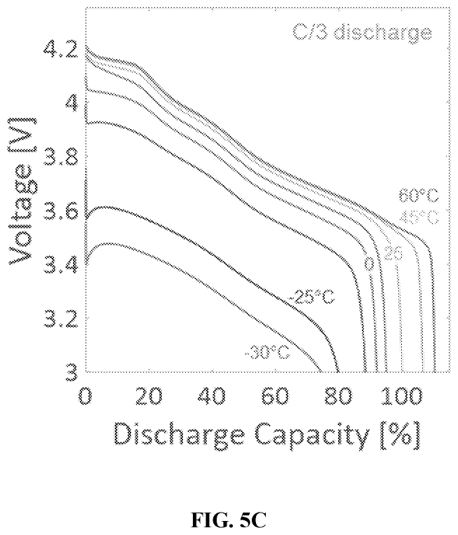

The cell exhibited approximately 95% energy retention through 800 cycles as shown in FIG. 5A.

### Example 8: Performance of Cell Comprising UV-Cured Cathode Seam in a Power Test

A 22-layer cell was assembled using a UV-cured perimeter seal described herein. A power test was performed and the details of the cell and experiment are provided in table 1 from Example 7. The cell exhibited 10C continuous discharge and a 15-minute quick charge as shown in FIG. 5B.

### Example 9: Performance of Cell Comprising Uv-Cured Cathode Seam in a Temperature Skew Test

A 22-layer cell was assembled using a UV-cured perimeter seal described herein. A temperature skew test was performed and the details of the cell and experiment are provided in table 1 from Example 7. The cell showed capacity utilization from 60° C. to −30° C. as shown in FIG. 5C.

### Example 10: Adhesive Stength of UV-Cured Seal

Adhesive strength of a separator and a cathode seal UV-cured as described herein was measuring using the standard ASTM D3330 test. The UV-cured seal exhibited adhesion with a peel strength of 28N/25 mm following a 180-degree peel at room temperature

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. An electrochemical stack comprising:
a cathode comprising a catholyte;
a solid-state electrolyte separator comprising two major surfaces and four minor surfaces; and
a seal between a first major surface of the separator and the cathode and within 0.1 mm to 2 mm from a perimeter of the first major surface;
wherein the seal does not contact the perimeter of the first major surface, the second major surface, or the minor surfaces of the separator;
wherein the cathode geometric surface area is less than the separator geometric surface area; and
wherein the seal comprises ultraviolet (UV)-cured crosslinked polyisobutylene (PIB).

2-8. (canceled)

9. The electrochemical stack of claim 1, wherein the seal further comprises a tackifier.

10. The electrochemical stack of claim 9, wherein the tackifier comprises a polymer selected from the group consisting of a polyisobutylene polymer, a polyethylene polymer, an acrylate polymer, an acrylamide polymer, or combinations thereof.

11. The electrochemical stack of claim 1, wherein the crosslinked PIB is crosslinked from a monomer having the structure of Formula (I): 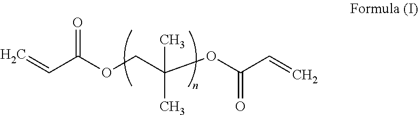
wherein n is an integer from 5 to 50.

12. The electrochemical stack of claim 1, wherein the crosslinked PIB is crosslinked from a mixture of monomers having the structure of Formula (I): 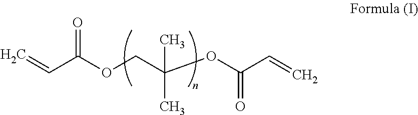
wherein n is an integer from 1 to 100.

13. The electrochemical stack of claim 1, wherein the seal comprises at least 95% w/w of the crosslinked PIB.

14. (canceled)

15. The electrochemical stack of claim 1, wherein a distance between an edge of the cathode and an outside edge of the seal is equal to, or less than, 5 mm.

16-21. (canceled)

22. The electrochemical stack of claim 1, wherein the seal has a width in the range of 0.8 mm and 1.2 mm.

23. (canceled)

24. The electrochemical stack of claim 1, wherein the seal has a height in the range of 100 μm and 200 μm.

25. (canceled)

26. The electrochemical stack of claim 1, wherein the cathode contacts the solid-state electrolyte separator.

27. The electrochemical stack of claim 1, further comprising a liquid electrolyte between the separator and the cathode wherein the liquid electrolyte comprises a solvent selected from the group consisting of ethylene sulfite, sulfolane, and combinations thereof.

28. The electrochemical stack of claim 27, wherein the liquid electrolyte further comprises a lithium salt at concentration of less than 2 M.

29-34. (canceled)

35. A process for sealing a cathode to a solid-state electrolyte separator, comprising providing a seam between a cathode and a solid-state electrolyte separator wherein the seam comprises an acryloyl group-terminated monomer; and UV-curing or UV-curing and heat-curing the seam to form a seal that comprises crosslinked polyisobutylene (PIB).

36. The process of claim 35, wherein the seam is ultraviolet (UV)-cured.

37. The process of claim 35, wherein the UV-curing comprises radiating the seam with UVA, UVB, UVC wavelengths, or a combination thereof.

38. The process of claim 37, wherein the UVA intensity is between 950 and 900 mW/cm²; the UVB intensity is between 875 and 800 mW/cm²; and the UVC intensity is between 450 and 375 mW/cm².

39. (canceled)

40. The process of claim 37, wherein the dosage of UVA is between 880 and 800 mJ/cm²; the dosage of UVB is between 800 and 750 mJ/cm²; and the dosage of UVC is between 400 and 300 mJ/cm².

41-48. (canceled)

49. A process of making an electrochemical stack comprising:
a. dispensing a UV-curable or heat-curable seam on a solid-state electrolyte separator wherein the seam comprises an acryloyl group-terminated monomer, a tackifier, and an anti-oxidant;
b. joining together a cathode comprising a catholyte and the solid-state electrolyte separator wherein the UV-curable or heat-curable seam are in contact with the cathode; and
c. UV-curing or UV-curing and heat-curing the seam to form a UV- and/or heat-cured seal comprising crosslinked polyisobutylene (PIB) and tackifier between the cathode and the separator.

50-53. (canceled)

54. The process of claim 49, wherein the UV-curing is conducted using 365 nm UV wavelength.

55. The process of claim 54, wherein the curing time is less than 1 minute.

56-63. (canceled)
